(19) United States
(12) Patent Application Publication
(10) Pub. No.: US 2006/0276143 A1
(43) Pub. Date: Dec. 7, 2006

(54) Digital radio system

(76) Inventor: Richard L. Anglin, JR., Del Mar, CA (US)

Correspondence Address: Thomas N. Giaccherini, Post Office Box 1146, Carmel Valley, CA, 93924, US

(21) Appl. No.: 11/338,534

(22) Filed: Jan. 23, 2006

Related U.S. Application Data
(63) Continuation-in-part of application No. 10/909,110, filed on Jul. 29, 2004, now abandoned.
(63) Continuation-in-part of application No. 08/943,987, filed on Oct. 3, 1997, now abandoned.

(51) Int. Cl. H04B 1/46

(52) U.S. Cl. 455/81; 455/269; 455/205

(57) ABSTRACT

Methods and apparatus for digital communications are disclosed. In one embodiment of the invention, chirp waveforms (10) are used to convey meanings of “one” and “zero.” The present invention includes a wireless network for conveying chirp waveforms (10).

### CROSS-REFERENCE TO RELATED PATENT APPLICATIONS & CLAIMS FOR PRIORITY

The Present Invention is a Continuation-in-Part Application, and is related to the following Parent Patent Applications:

U.S. Ser. No. 10/909,110, filed on 29 Jul. 2004, entitled Interactive Digital Data Broadcasting System; and

U.S. Ser. No. 08/943,987, filed on 3 Oct. 1997, entitled Interactive Digital Data Broadcasting System.

In accordance with the provisions of Sections 119 & 120 of Title 35 of the United States Code, the Applicant claims the benefit of priority for any subject matter which is commonly disclosed in the Present Application, and in the two Parent Applications identified above.

### FIELD OF THE INVENTION

The present invention pertains to methods and apparatus for radio communications. More particularly, one preferred embodiment of the invention uses digital chirps for high-speed, two-way mobile communications.

### FEDERALLY SPONSORED RESEARCH OR DEVELOPMENT

None.

### BACKGROUND OF THE INVENTION

I. Radio Communications

The father of modern wireless communications was Guglielmo Marconi, born at Bologna, Italy, on Apr. 25, 1874. On a historic day in December 1901 he transmitted the first wireless signals across the Atlantic between Poldhu, Cornwall, United Kingdom, and St. John's, Newfoundland, a distance of 2,100 miles. Marconi's feat was accomplished with a spark gap transmitter. A typical high-power spark gap was a rotating commutator with six to twelve contacts per wheel, nine inches to a foot wide, driven by about 2,000 volts of direct current (DC). As the gaps made and broke contact, the radio wave was audible as a tone in a crystal set.

The basics of a spark gap can be easily replicated today as shown in FIG. 1. Taking a quarter V and rubbing it across the contacts of a nine volt battery B produces static S that is audible via the speaker Z of an inexpensive amplitude modulated (AM) radio R.

Creating static proved that the concept of wireless communications worked, but it was not very useful. In the wired world, telegraphy was in regular use. Wires were strung along railroad lines to enable communications between stations. A telegraph operator O used a telegraph key K to make and break battery B pulses that were sent along the wires W as shown in FIG. 2. Messages were sent via Morse Code, a method for transmitting information using standardized sequences of short and long marks or pulses, commonly known as “dots and dashes,” for the letters, numerals and special characters of a message. See FIG. 3.

Marconi used a telegraph key K to directly make and brake the 2,000 volt supply to generate Morse Code. One side of the spark gap G was directly connected to the antenna A as shown in FIG. 4. Making and breaking the power supply P enabled Marconi to create the dots DOT and dashes DASH for Morse Code.

The famous “dot” and “dash” message transmitted by the ocean liner Titanic after she hit an iceberg was “S” “O” “S”, an abbreviation for “save our ship,” is shown in FIG. 5.

Although these simple bursts of “on” and “off” static may be employed to transmit signals in code, this way of communicating only works when one transmitter is being used at any one time. FIG. 6 offers a simple example that illustrates this problem. Two transmitters Aa, Ab send different messages at the same time. At transmitter Aa, the operator Oa sends the message “NEW YORK TRAIN ON TIME” which is dispatched as a radio signal. At transmitter Ab operator Ob sends the message “BOSTON TRAIN LATE” which is also conveyed as a radio signal. A receiver at a distant location Ac receives both signals at the same time, resulting in the message “NEW YORK TRAIN BOSTON ON TIME LATE”. The operator Oc at the receiver is unable to decipher this mixed message.

The problem with the two messages that arrive at the receiver at the same time is caused by the fact that both radio transmissions use the same part of the “radio spectrum.” When light is viewed as it passes through a prism Y, the light is split into the colors of a rainbow, which extend from red to orange, yellow, green, blue and violet as shown in FIG. 7. The different colors appear because each color has a different frequency that is refracted differently by the prism. Refraction is caused by the change in speed experienced by a wave of light when it changes the medium through which it travels. An ocean with waves that are ten meters apart, their wavelength, crash on the shore five times per minute are classified as having a frequency of five, whereas an ocean of waves ten meters apart that crash on the shore ten times per minute are classed as having a frequency of ten. The more frequent the waves, the higher the frequency. Waves in the ocean travel at approximately the same speed. Therefore, waves that are more widely spaced, their wavelength, would crash on the beach less frequently while those that are more narrowly spaced would crash on the beach more frequently.

It is this difference in frequencies that causes the different colors of light to separate and become visible when passing through a prism. Radio waves act the same way. They have different frequencies and wavelengths, and a receiver that is capable of filtering out all but a particular frequency or wavelength can isolate a particular signal that exists at a particular frequency or wavelength to the exclusion of all others. The radio spectrum comprises a wide range of different radio waves, beginning with waves of very low frequency (VLF) at one end and progressing to waves of extremely high frequency (EHF) at the other end of the spectrum as shown in FIG. 8. Wavelength and frequency are inversely related.

FIG. 9 shows a sine wave. The period Ta is the time it takes the wave to make one complete oscillation, that is, starting from zero and rising to a maximum then descending back through zero to a minimum and then back to zero. The instant sine wave has a frequency Fa. FIG. 10 shows two complete oscillations. In FIG. 10, the period of each oscillation Th is one half of period Ta, therefore, the frequency Fb is twice the frequency Fa. Similarly, FIG. 11 shows four complete oscillations. In FIG. 11, the period of each oscillation Td is one quarter of period Ta, therefore, the frequency Fc is four times the frequency Fa.

A wave with constant height, amplitude, and frequency carries no information. However, information can be superimposed on a given wave by varying either amplitude or frequency or both. Varying a wave in this manner is called “modulation,” and recovering the information encoded in this manner is called “demodulation.”

When a singer sings his pitch is obtained by varying frequency and his loudness, or vibrato, is obtained by varying his volume. FIG. 12 shows a singer I singing into a microphone M. The music tones D are shown on an oscilloscope J. Examination of the wave Q on the oscilloscope reveals that the wave oscillations have are of varying “height” reflecting the volume of the singer's song. When the singer sings into the microphone the wave he produces is used to vary the height, the amplitude, of the constant frequency carrier produced by the transmitter. This phenomenon is called an “amplitude modulated wave” Q, a more detailed view of which is presented in FIG. 13. Note the symmetrical envelope UU of the amplitude modulated wave in FIG. 13.

The amplitude modulated wave Q is comprised of two waves, a carrier wave C with a period Tc and a modulating wave U as shown in FIG. 14. The peaks of the modulated wave Q follow the contour of the original, modulating wave U. The waveform envelope UU in FIG. 13 is the modulating wave U. The process of superimposing a modulating wave U, the music tones D, on a carrier wave C is called “modulation” and the device for so doing is called a “modulator,” in the instant case “amplitude modulation” because the signal strength varies in proportion to the strength of the modulating wave U.

FIG. 15 shows a block diagram of an AM transmitter. The music tones D are converted to a low-level modulating wave U by the microphone M and amplified by preamplifier X. Amplifier X produces an electrical signal of sufficient strength to be fed into a modulator R where it modulates, that is, changes the characteristics of, the carrier wave C generated by a local oscillator LO. The modulated wave Q is fed to into power amplifier E and then to the antenna A.

A radio signal that is received in a typical passenger car on an AM radio is an amplitude modulated wave Q, as shown in FIG. 16. The program heard by the listener is the music D. Therefore, the music tones D must be extracted from the amplitude modulated wave Q. This is accomplished by subtracting the carrier wave C from the amplitude modulated wave Q, leaving only the modulating wave U that gives us the music tones D as shown in FIG. 17. The process of extracting a carrier wave C and a modulating wave U from an amplitude modulated wave Q is called “demodulation,” and the device for doing so is called a “demodulator” L.

Each communications service requires a certain amount of radio frequency spectrum to deliver the service at an appropriate level. “Appropriateness” depends upon the application. For voice services, “appropriate” means the spoken word is intelligible. For music, “appropriate” means being able to hear the music at a level of fidelity. The minimum amount of radio frequency spectrum, that required to deliver the service, comprises a “channel.”

A car radio offers a variety of stations offering different kinds of audio programming. When the radio dial is turned, with a knob or digitally, different stations are selected. Each station operates on a different channel, as shown in FIG. 18. Antenna Ad in San Diego, Calif., broadcasts radio station KSON on 1240 kHz Fd. Antenna Ae in Los Angeles, Calif., broadcasts radio station KOGO on 600 kHz Fe. Antenna Af, also in Los Angeles, broadcasts radio station KNX on 1070 kHz. When the radio is tuned by turning the dial, the center frequency of the channel is chosen, as shown in FIG. 19.

The previous text describes a communication method called Amplitude Modulation (AM), a technique evolved from Marconi's spark gap transmissions. Frequency Modulation (FM) is a form of modulation which represents information as variations in the instantaneous frequency of a carrier wave C. Contrast this with AM, in which the amplitude of the carrier is varied while its frequency remains constant as has been shown above. In analog applications, the carrier wave C is varied in direct proportion to changes in the amplitude of an input signal, the modulating wave U. Taking the same carrier wave C and modulating wave U from FIG. 14, we can “mix” or “modulate” them to create a “frequency modulated wave” N as shown in FIG. 20. Note that the amplitude is constant but the period T varies with time.

Frequency modulation requires a wider bandwidth channel than amplitude modulation for a given modulating signal, but this also makes the signal more robust against interference. Frequency modulation is also more robust against simple signal amplitude fading phenomena. As a result, FM was chosen as the modulation standard for high frequency, high fidelity radio transmission: hence the term “FM radio.”

FIG. 15, a block diagram of an AM transmitter, becomes FIG. 21, a block diagram of an FM transmitter. The modulator R in FIG. 15 is replaced by a mixer AA in FIG. 21. A “mixer” is a device that varies the frequency of a carrier C according to the signal input from preamplifier X that is filtered and amplified to a power level needed for transmission by amplifier E. The transmitted wave N is a frequency modulated wave. Similarly, FIG. 17, a block diagram of an AM receiver, becomes FIG. 22, a block diagram of an FM receiver. The AM demodulator L in FIG. 17 is replaced by an FM demodulator AB in FIG. 22.

In addition to AM and FM described above, a third method for modulating is known as Phase Modulation (PM). Here the amplitude and frequency of the wave is unchanged; the modulator varies the phase angle of the wave. The phase angle of a given sine wave is the offset or delay with respect to a reference sine wave, as shown in FIG. 23. FIG. 23 shows reference sine wave Al, a phase offset of ninety degrees AJ, and a phase offset of one hundred eighty degrees AK.

Phase offset can be changed over time as shown in FIG. 24. The cycle AL starts upward from zero, peaks, falls back through zero, peaks in the negative direction and then returns to zero. This sequence AL is treated as the reference or zero phase offset. The cycle AM has the opposite progression; it starts in the negative direction, reaches a minimum, rises through zero to a maximum and then returns to zero. This sequence AM is referred to as the “opposite phase.” Note that the two cycles AL and AM have the same frequency and the same amplitude, they only differ in the sequence of negative, positive and zero values.

Signals may be encoded on a carrier wave by modulating the amplitude AM, frequency FM, phase PM or combinations thereof. The amplitude modulated wave Q, the frequency modulated wave N and a phase modulated wave are all termed “waveforms.”

Digital data, that is, information that shifts between ones and zeros at discrete points in time, can be represented by shifting the amplitude among a discrete set of values, amplitude shift keying (ASK), shifting the carrier frequency C among a set of discrete frequency values, frequency-shift keying (FSK), or shifting among a discrete set of phase values, phase shift keying (PSK). In FSK the instantaneous frequency is shifted between two discrete values termed the “mark” frequency and the “space” frequency as shown in FIG. 25. This technique may be used to represent the digital binary states of “0s” and “1s. ” FIG. 26 shows a comparable representation of digital data as shifts in phase. Phase Modulation has proven particularly effective for encoding digital data and is presently the most commonly used means.

For all of the benefits they deliver, modern wireless communications systems comprise inherent limitations. Traditional duplex communications systems, that is, systems that enable simultaneous communications between two terminals AC typically use two independent communications channels ADa,ADb as shown in FIG. 27. Communications transmitted from a first terminal ACa to a second terminal ACb use a first channel ADa while communications transmitted from a second terminal ACb to a first terminal ACa use a second channel ADb.

The independent channels ADa and ADb are typically separated within a frequency band AE to prevent communications in a first channel ADa from interfering with communications in a second channel ADb. The channel separation AF is termed “frequency offset,” and is shown in FIG. 28. Furthermore, in traditional communications systems the duplex channel widths are equal, that is, a first channel ADa is the same width as a second channel ADb.

In traditional communications systems that do not use some form of multiple access technologies both channels ADa,ADb are completely dedicated to the communications session for the duration of the session. Thus, in a cellular telephone system a first channel ADa is solely dedicated to communications from a base station AG to a mobile terminal AC, a cell phone, and a second channel ADb is solely dedicated to communications from a mobile terminal AC, a cell phone, to a base station AG, as shown in FIG. 29. Thus, even when no one is talking, the channels ADa,ADb remain completely dedicated to the communications session between AG and AC. Similarly, in a data communications session, even if the data communications do not utilize the full bandwidth available in a channel, the channel remains fully dedicated to the communications session for its full duration, an inefficient utilization of scarce spectrum resources.

Wireless communications systems like the early push-to-talk (PTT) simplex dispatch systems, often used to dispatch taxis, cellular, personal communications system (PCS) and even satellite systems like Iridium® were designed for voice communications, a narrowband application. “Narrowband” in this context means that the channels ADa,ADb are only wide enough to enable voice communications at some level of quality as well as to provide a buffer between adjacent channels, a “guard band.” The economics of communications systems is to maximize the number of available channels within an allocated frequency band. Therefore the objective is to minimize the channel width while maintaining acceptable voice quality. With the increase of data communications requirements spawned by the Internet and other factors, voice-based channelization has become a major constraint to the delivery of applications with bandwidth requirements higher than voice via wireless communications systems.

Traditional wireless communications systems are deployed in a variety of frequency bands, as shown in FIG. 30.

When the Federal Communications Commission (FCC) first established cellular service rules, cellular spectrum was allocated into forty megahertz of spectrum: a twenty megahertz block, 825 to 845 MHZ, was designated for transmissions ADb made by mobile units AC, and a separate twenty megahertz block, from 870 to 890 MHZ, was allocated for base station AG transmissions ADa. The forty megahertz allocation accommodated 666 channel pairs, a channel pair consisting of a mobile frequency ADb and a corresponding base frequency ADa. Due to the growth in demand for cellular service, the FCC reevaluated the cellular band plan in 1986 and allocated an additional ten megahertz of spectrum to each cellular system, increasing the spectrum designated for cellular telephone systems to fifty megahertz. The additional spectrum increased the number of channel pairs to 832 channel pairs. The frequency allocation for mobile transmissions now ranges from 824 to 849 MHZ, and from 869 to 894 MHZ for base station transmissions. Cellular and Broadband PCS channels are typically thirty kilohertz wide.

Broadband PCS operates in the 1850-1910 MHZ and 1930-1990 MHZ bands. The one hundred twenty megahertz of spectrum was divided into six frequency blocks A through F. Blocks A, B, and C are thirty megahertz each and blocks D, E, and F are ten megahertz each.

Two distinct sets of frequencies are available for Specialized Mobile Radio (SMR) operation: 800 MHZ and 900 MHZ. A total of approximately nineteen megahertz of spectrum is available for use by SMR carriers, fourteen megahertz in the 800 MHZ band and five megahertz in the 900 MHZ band. The 800 MHZ SMR systems operate on two twenty-five kilohertz channels paired, while the 900 MHZ systems operate on two 12.5 kHz channels paired.

Cellular, PCS and SMR are all licensed services, that is, a carrier wishing to provide services in those bands must obtain a license from the FCC. There are also allocations for unlicensed wireless communications in the Industrial, Scientific and Medical Bands (ISM) at 902-928 MHZ and 2400-2483.5 MHZ, in the Unlicensed-National Information Infrastructure (U-NII) Band, and the 3650-3700 MHZ band.

Within the licensed bands there is usually a band plan that defines and assigns channels within each band. An example of a band plan is shown in FIG. 31 for cellular telephone systems. Channels within the 824 to 849 MHZ band are used for communications from mobile terminals AC to a base station AG, and in the 869 to 894 MHZ band for communications from a base station AG to a mobile terminal AC. Each channel in both directions is thirty kilohertz wide.

Transmissions in different portions of the radio frequency (RF) spectrum have different propagation characteristics. Some frequency bands are more desirable for long distance communications; others for short distances. Some frequency bands require clear line-of-sight; others go through trees. Traditional wireless communications systems are typically implemented within a single frequency band. They therefore experience the propagation characteristics associated with that frequency band, which may affect the integrity and reliability of the communications.

Propagation effects are manifest in the dreaded dropped call phenomenon. Cellular systems are implemented in a honeycomb configurations as shown in FIG. 32. Base station AGa supports communications throughout its coverage area AHa, AGb throughout AHb, and so forth. The radius of the coverage area AH is determined by the propagation characteristics of the deployed frequency band. As a general rule the lower the frequency the longer the propagation distance.

Cellular systems are designed so that as a mobile terminal AC reaches the edge of coverage of a first coverage area AHa, control of the communications is automatically and seamlessly transferred from base station AGa to base station AGb. The wireless user should not experience any interruption in service in transiting from AHa to AHb, and so forth. Economics dictate that wireless system operators deploy the fewest number of base stations possible to provide acceptable communications coverage. Systems are engineered based on the nominal propagation characteristics of the particular frequency band deployed. Variation in propagation often leads to a dropped call, that is, there is no seamless transfer of communications from one coverage area to another.

The waveforms used by the cellular telephone networks, Advanced Mobile Phone Service (AMPS), Time Division Multiple Access (TDMA) and its derivative Global System for Mobile (GSM), Code Division Multiple Access (CDMA) are not efficient in terms of bandwidth. They require significant guard bands between channels and a 20 MHZ unused “buffer zone,” the frequency offset AF between the block of frequencies used for the forward channels (also known as downlink channels) ADa, base station AG to cell phone AC, and the block of channels used for the reverse channels (also known as uplink channels) ADb, cell phone AC to base station AG.

The cellular telephone waveforms are not particularly good in urban mobile environments. In particular, they are significantly negatively impacted by multipath.

The world is inexorably moving towards using the Internet Protocol (IP) for virtually all applications, from voice to high definition television (HDTV). Consumers want their desired applications delivered to them anytime and anywhere, preferably wirelessly. Designing such a wireless communications system would tremendously advance the state of the art in communications and consumer convenience. The starting point for such a design effort is a statement of the requirements the systems must meet, that is, the functionalities embedded in the desired wireless communications system.

Accommodating high bandwidth applications like television (TV) requires the availability of multimegabit communications capability. Some fixed wireless communications systems can today provide such capability. However, no traditional mobile communications system has such high bandwidth capability. Additionally, while system developers and operators envision the availability of such high bandwidth capabilities in the future, it is unclear whether even the envisioned future capabilities can support mobile television at the same quality as available today from broadcast, satellite and cable television systems.

Applications like television or downloading of images are highly directional. For example, a user request to view a movie or television program comprises a short message from a terminal AC to a base station AG. The channel ADb from the terminal AC to the base station AG can be very small. Once the movie begins, however, the channel ADa from the base station AG to the terminal AC must be quite large to support a broadband signal. Conversely for example, a salesman uploading a color brochure needs a broadband channel ADb to quickly complete the upload. All traditional communications systems use fixed width duplex channels; none enable asymmetrical communications. Because applications vary widely in bandwidth requirements, asymmetrical channels are highly desirable, especially if bandwidth capacity is made available on demand.

In traditional wireless communications system, if all available channels are in use the next prospective user is denied access, he or she gets a busy signal. The user must reinitiate his or her request for services. In times of high system utilization a user may have to make multiple attempts to secure communications services. A system that can accommodate the next user without terminating services to a current user is highly desirable. In a system with bandwidth on demand (BOD), each current user gives up a small portion of his or her bandwidth that is made available to accommodate the next prospective user. There are, of course, limits to how many next users may be accommodated.

A wireless communications system that combines asymmetrical channels with BOD would be highly spectrum efficient because each application would utilize only the bandwidth that it needs for the duration of its need. For example, an Unmanned Aerial Vehicle (UAV) transmitting high bandwidth sensor data to the ground would use a multimegabit channel, or combination of channels, for the time it takes to transmit the data to the ground, which could be a significant continuous period. Instructions to the UAV would be uplinked via a narrowband channel, messages that are short and periodic.

Dropped calls are annoying to consumers. A dropped call, or interrupted data communications session, in certain circumstances can have grievous consequences, for example, transmitting medical data from an ambulance to a hospital. A system that simultaneously uses a plurality of frequency bands takes advantage of differences in propagation characteristics to ensure the integrity and reliability of the communications.

Finally, it is desirable to spread the energy from radio signals uniformly over a range of frequencies, that is, to have no sharp peaks at any particular frequency in the band, so that the overall signal power can be maximized without violating legal or regulatory restrictions.

To recap, a modern wireless communications system that delivers the following capabilities and comprises the following functionalities would tremendously advance the state of the art of wireless communications and provide substantial benefits to consumers and users:

High bandwidth

Internet Protocol

Asymmetrical channels

Bandwidth on demand

Simultaneous utilization of multiple frequencies

Mobility

Two distinct elements are required to meet the above requirements: an appropriate radio frequency waveform and an appropriate network architecture.

The development of a telecommunication system waveform that surpasses the limited performance of conventional cellular telephone and other wireless communications networks would constitute a major technological advance, and would satisfy long felt needs and aspirations in the telecommunications and electronics industries.

### SUMMARY OF THE INVENTION

The Digital Radio System comprises methods and apparatus for a telecommunications system that utilizes “chirp” waveforms for high-speed, wireless communications. In the most basic embodiment of the invention, chirp waveforms comprising line segments are used to convey a digital message of “one” or “zero.” The invention also encompasses more complex combinations of chirps, as well as more complex types of pairs of chirps. The present invention also includes methods and apparatus for providing a wireless communications network that conveys these chirp waveforms.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIGS. 1 through 32 depict the prior art.

FIG. 1 shows a how to create a spark gap with a battery and a quarter (prior art).

FIG. 2 shows a telegraph operator sending Morse Code over wires (prior art).

FIG. 3 shows Morse Code (prior art).

FIG. 4 shows sending Morse Code wirelessly using a spark gap transmitter (prior art).

FIG. 5 shows the S.S. Titanic sending an “SOS” signal (prior art).

FIG. 6 shows the interference from two transmitters being received at the same time (prior art).

FIG. 7 shows sunlight being refracted through a prism (prior art).

FIG. 8 shows a portion of the radio frequency spectrum (prior art).

FIG. 9 shows a single oscillation sine wave (prior art).

FIG. 10 shows two sine wave oscillations (prior art).

FIG. 11 shows four sine wave oscillations (prior art).

FIG. 12 shows music tones displayed on an oscilloscope (prior art).

FIG. 13 shows an amplitude modulated wave (prior art).

FIG. 14 shows a demodulated wave comprising a carrier wave and a modulating wave (prior art).

FIG. 15 shows a block diagram of an amplitude modulation radio transmitter (prior art).

FIG. 16 shows listening to music in a car with an amplitude modulated signal (prior art).

FIG. 17 shows a block diagram of an amplitude modulation radio receiver (prior art).

FIG. 18 shows tuning radios to different radio stations operating on different frequencies (prior art).

FIG. 19 shows tuning to the center frequency of a channel (prior art).

FIG. 20 shows a frequency modulated wave (prior art).

FIG. 21 shows a block diagram of a frequency modulation radio transmitter (prior art).

FIG. 22 shows a block diagram of a frequency modulation radio receiver (prior art).

FIG. 23 shows Phase Modulation (prior art).

FIG. 24 shows changes in phase with time (prior art).

FIG. 25 shows frequency shift keying (prior art).

FIG. 26 shows phase shift keying (prior art).

FIG. 27 shows a traditional duplex communications system (prior art).

FIG. 28 shows the channel separation in a traditional duplex communications system (prior art).

FIG. 29 shows a traditional duplex wireless communications system (prior art).

FIG. 30 shows frequency bands in which traditional wireless duplex communications systems are deployed (prior art).

FIG. 31 shows a cellular telephone system band plan (prior art).

FIG. 32 shows a cellular telephone system honeycomb deployment architecture (prior art).

FIG. 33 provides a view of a basic chirp waveform. “Modulation Variable” refers to the particular characteristic of a wave being varied during the chirp, amplitude, frequency, etc.

FIG. 34 reveals alternative waveforms that may be used to implement the invention.

FIGS. 35 through 44 depict two-dimensional chirp waveforms mapped in amplitude versus time for meanings “one” and “zero” for five different families of chirps. FIGS. 35 and 36 are formed from linear line segments. FIGS. 37 and 38 are formed from mononomial line segments. FIGS. 39 and 40 are formed from polynomial line segments. FIGS. 41 and 42 are formed from sinusoidal line segments. FIGS. 43 and 44 are formed from exponential line segments. FIGS. 35, 37, 39, 41 and 43 have meanings of “one.” FIGS. 36, 38, 40, 42 and 44 have meanings of “zero.”

FIGS. 45 through 54 depict two-dimensional chirp waveforms mapped in frequency versus time for meanings “one” and “zero” for five different families of chirps. FIGS. 45 and 46 are formed from linear line segments. FIGS. 47 and 48 are formed from mononomial line segments. FIGS. 49 and 50 are formed from polynomial line segments. FIGS. 51 and 52 are formed from sinusoidal line segments. FIGS. 53 and 54 are formed from exponential line segments. FIGS. 45, 47, 49, 51 and 53 have meanings of “one.” FIGS. 46, 48, 50, 52 and 54 have meanings of “zero.”

FIGS. 55 through 64 depict two-dimensional chirp waveforms mapped in amplitude versus frequency for meanings “one” and “zero” for five different families of chirps. FIGS. 55 and 56 are formed from linear line segments. FIGS. 57 and 58 are formed from mononomial line segments. FIGS. 59 and 60 are formed from polynomial line segments. FIGS. 61 and 62 are formed from sinusoidal line segments. FIGS. 63 and 64 are formed from exponential line segments. FIGS. 55, 57, 59, 61 and 63 have meanings of “one.” FIGS. 56, 58, 60, 62 and 64 have meanings of “zero.”

FIGS. 65 through 74 depict two-dimensional chirp waveforms mapped in frequency versus amplitude for meanings “one” and “zero” for five different families of chirps. FIGS. 65 and 66 are formed from linear line segments. FIGS. 67 and 68 are formed from mononomial line segments. FIGS. 69 and 70 are formed from polynomial line segments. FIGS. 71 and 72 are formed from sinusoidal line segments. FIGS. 73 and 74 are formed from exponential line segments. FIGS. 65, 67, 69, 71 and 73 have meanings of “one.” FIGS. 66, 68, 70, 72 and 74 have meanings of “zero.”

FIGS. 75 through 124 exhibit three dimensional chirp waveforms, which are mapped in amplitude, frequency and time. FIG. 75 utilizes linear line segments and has a meaning of “one.” FIG. 76 utilizes linear line segments and has a meaning of “zero.” FIG. 77 utilizes linear and mononomial line segments and has a meaning of “one.” FIG. 78 utilizes linear and mononomial line segments and has a meaning of “zero.”

FIGS. 79 and 80 utilize polynomial and linear line segments. FIG. 79 shows a waveform that has a meaning of “one,” while FIG. 80 shows a waveform that has a meaning of “zero.”

FIGS. 81 and 82 utilize sinusoidal and linear line segments. FIG. 81 shows a waveform that has a meaning of “one,” while FIG. 82 shows a waveform that has a meaning of “zero.”

FIGS. 83 and 84 utilize exponential and linear line segments. FIG. 83 shows a waveform that has a meaning of “one,” while FIG. 84 shows a waveform that has a meaning of “zero.”

FIGS. 85 and 86 utilize linear and mononomial line segments. FIG. 85 shows a waveform that has a meaning of “one,” while FIG. 86 shows a waveform that has a meaning of “zero.”

FIGS. 87 and 88 utilize mononomial and mononomial line segments. FIG. 87 shows a waveform that has a meaning of “one,” while FIG. 88 shows a waveform that has a meaning of “zero.”

FIGS. 89 and 90 utilize polynomial and mononomial line segments. FIG. 89 shows a waveform that has a meaning of “one,” while FIG. 90 shows a waveform that has a meaning of “zero.”

FIGS. 91 and 92 utilize sinusoidal and mononomial line segments. FIG. 91 shows a waveform that has a meaning of “one,” while FIG. 92 shows a waveform that has a meaning of “zero.”

FIGS. 93 and 94 utilize exponential and mononomial line segments. FIG. 93 shows a waveform that has a meaning of “one,” while FIG. 94 shows a waveform that has a meaning of “zero.”

FIGS. 95 and 96 utilize linear and polynomial line segments. FIG. 95 shows a waveform that has a meaning of “one,” while FIG. 96 shows a waveform that has a meaning of “zero.”

FIGS. 97 and 98 utilize mononomial and polynomial line segments. FIG. 97 shows a waveform that has a meaning of “one,” while FIG. 98 shows a waveform that has a meaning of “zero.”

FIGS. 99 and 100 utilize polynomial and polynomial line segments. FIG. 97 shows a waveform that has a meaning of “one,” while FIG. 98 shows a waveform that has a meaning of “zero.”

FIGS. 101 and 102 utilize sinusoidal and polynomial line segments. FIG. 101 shows a waveform that has a meaning of “one,” while FIG. 102 shows a waveform that has a meaning of “zero.”

FIGS. 103 and 104 utilize exponential and polynomial line segments. FIG. 103 shows a waveform that has a meaning of “one,” while FIG. 104 shows a waveform that has a meaning of “zero.”

FIGS. 105 and 106 utilize linear and sinusoidal line segments. FIG. 105 shows a waveform that has a meaning of “one,” while FIG. 106 shows a waveform that has a meaning of “zero.”

FIGS. 107 and 108 utilize mononomial and sinusoidal line segments. FIG. 107 shows a waveform that has a meaning of “one,” while FIG. 108 shows a waveform that has a meaning of “zero.”

FIGS. 109 and 110 utilize polynomial and sinusoidal line segments. FIG. 109 shows a waveform that has a meaning of “one,” while FIG. 110 shows a waveform that has a meaning of “zero.”

FIGS. 111 and 112 utilize sinusoidal and sinusoidal line segments. FIG. 111 shows a waveform that has a meaning of “one,” while FIG. 112 shows a waveform that has a meaning of “zero.”

FIGS. 113 and 114 utilize exponential and sinusoidal line segments. FIG. 113 shows a waveform that has a meaning of “one,” while FIG. 114 shows a waveform that has a meaning of “zero.”

FIGS. 115 and 116 utilize linear and exponential line segments. FIG. 115 shows a waveform that has a meaning of “one,” while FIG. 116 shows a waveform that has a meaning of “zero.”

FIGS. 117 and 118 utilize mononomial and exponential line segments. FIG. 117 shows a waveform that has a meaning of “one,” while FIG. 118 shows a waveform that has a meaning of “zero.”

FIGS. 119 and 120 utilize polynomial and exponential line segments. FIG. 119 shows a waveform that has a meaning of “one,” while FIG. 120 shows a waveform that has a meaning of “zero.”

FIGS. 121 and 122 utilize sinusoidal and exponential line segments. FIG. 121 shows a waveform that has a meaning of “one,” while FIG. 122 shows a waveform that has a meaning of “zero.”

FIGS. 123 and 124 utilize exponential and exponential line segments. FIG. 123 shows a waveform that has a meaning of “one,” while FIG. 124 shows a waveform that has a meaning of “zero.”

FIGS. 125 and 126 show multiple line segments mapped in amplitude versus time space. FIG. 125 shows two waveforms that both have a meaning of “one,” while FIG. 126 shows two waveforms that both have a meaning of “zero.”

FIGS. 127 and 128 show multiple line segments mapped in frequency versus time space. FIG. 127 shows two waveforms that both have a meaning of “one,” while FIG. 128 shows two waveforms that both have a meaning of “zero.”

FIGS. 129 and 130 show “stacked” line segments mapped in amplitude versus time space. FIG. 129 shows two waveforms that both have a meaning of “one,” while FIG. 130 shows two waveforms that both have a meaning of “zero.”

FIGS. 131 and 132 show stacked line segments mapped in frequency versus time space. FIG. 131 shows two waveforms that both have a meaning of “one,” while FIG. 132 shows two waveforms that both have a meaning of “zero.”

FIGS. 133 through 136 show a chirp waveform vector mapped in polar coordinate space (r,φ). FIGS. 133 and 136 show a chirp waveform vector having the meaning of “one,” while FIGS. 134 and 135 show vectors having the meaning of “zero.”

FIG. 137 shows two chirp waveform vectors mapped in polar coordinate space (r,φ) having the same φ but with r₁ having the meaning of “one” and r₂ having the meaning of “zero.”

FIG. 138 shows two chirp waveform vectors mapped in polar coordinate space (r,φ) having the same r but with φ₁ having the meaning of “one” and φ₂ having the meaning of “zero.”

FIGS. 139 and 140 exhibit three dimensional chirp waveforms, which are mapped in spherical polar coordinates. FIG. 139 shows a waveform having a meaning of “one,” and FIG. 140 shows a waveform having a meaning of “zero.”

FIGS. 141 and 142 exhibit three dimensional chirp waveforms, which are mapped in cylindrical polar coordinates. FIG. 141 shows a waveform having a meaning of “one,” and FIG. 142 shows a waveform having a meaning of “zero.”

FIG. 143 exhibits multiple three dimensional chirp waveforms, which are mapped in spherical polar coordinate space.

FIG. 144 shows a screen shot of a linear frequency chirp waveform on a spectrum analyzer.

FIG. 145 shows a progression of linear frequency chirp waveforms, a chirp train.

FIG. 146 shows the field strength of a chirp train.

FIG. 147 shows transmitted up-chirps and down-chirps.

FIG. 148 shows redefined linear frequency chirp waveforms for continuity.

FIG. 149 shows successive linear frequency chirp waveforms.

FIG. 150 shows a modified continuous linear frequency chirp waveform.

FIG. 151 shows multiple bits encoded on the same linear frequency chirp waveform.

FIG. 152 shows a redefined chirp period for a linear frequency chirp waveform, also known as the symbol period.

FIG. 153 shows alternative frequency deviations for a linear frequency chirp waveform.

FIG. 154 shows multiple chirp trains within a particular frequency band.

FIG. 155 shows altering data rates by varying chirp trains.

FIG. 156 shows duplex communications using chirp trains.

FIG. 157 shows three chirp trains combined to provide high bandwidth downlink to a user.

FIG. 158 shows taking data rate from multiple users to accommodate the next user.

FIG. 159 shows linear frequency chirp waveform frequency multiplexing.

FIG. 160 shows linear frequency chirp waveform phase multiplexing.

FIG. 161 shows linear frequency chirp waveform slope multiplexing.

FIG. 162 shows a base station simultaneously transmitting linear frequency chirp waveform trains on three frequencies.

FIG. 163 shows three overlapping coverage areas from three different transmitted frequencies.

FIG. 164 shows the relationship between three tiered or stacked frequency coverage areas.

FIG. 165 shows how three tiered or stacked frequency coverage areas can be used to provide coverage throughout an extended area.

FIG. 166 shows a user on a road through an extended coverage area communicates by changing coverage areas associated with a particular frequency band.

FIG. 167 shows how three frequencies are shifted from coverage area to coverage area to assure continuity of communications and eliminate dropped calls.

FIG. 168 shows how two frequencies are shifted from coverage area to coverage area to assure continuity of communications and eliminate dropped calls.

FIG. 169 shows how three frequencies are shifted both down and up from coverage area to coverage area to assure continuity of communications and eliminate dropped calls.

FIG. 170 shows how a downlink to a user can be in a different frequency band and coverage area from an uplink to a base station.

FIG. 171 shows the coverage area of sectorized antennas.

FIG. 172 shows a block diagram of a preferred embodiment of the disclosed invention.

FIG. 173 shows a transmitter system.

FIG. 174 shows a receiver system.

FIG. 175 shows a hardware and software interface.

FIG. 176 shows a multi-frequency transmitter system.

FIG. 177 shows a multi-frequency receiver system.

FIG. 178 depicts network management software, which also resides in a network management center that manages the overall network.

FIGS. 179 through 185 show a number of alternative embodiments of user terminals and systems.

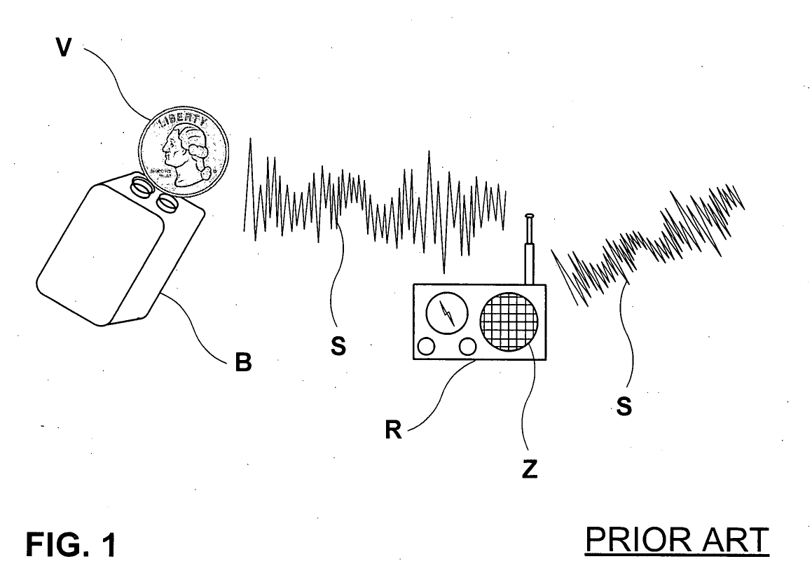

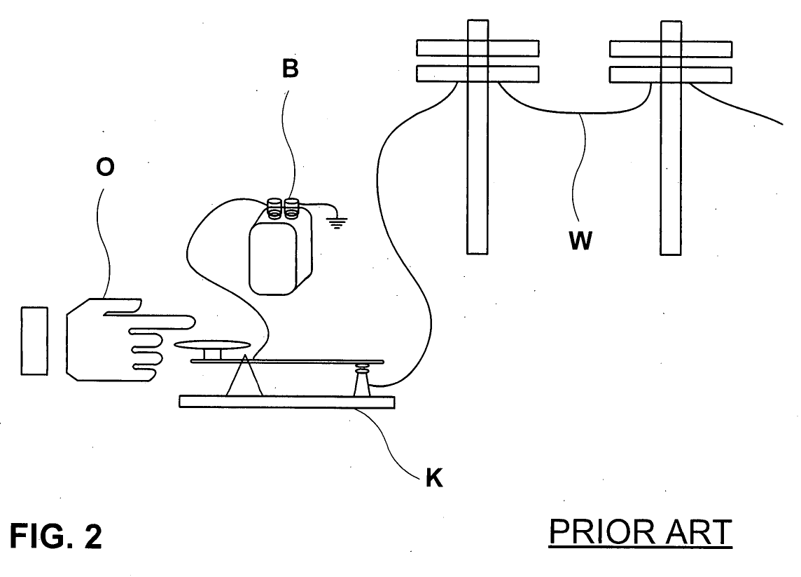

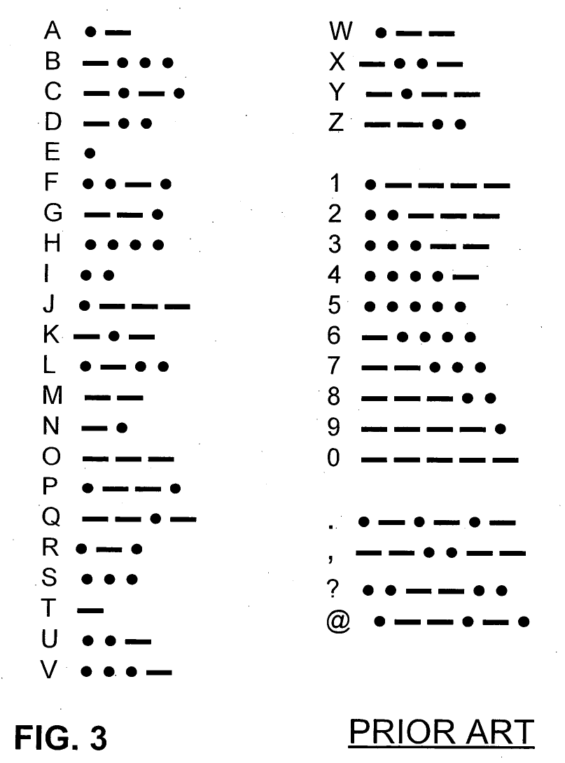

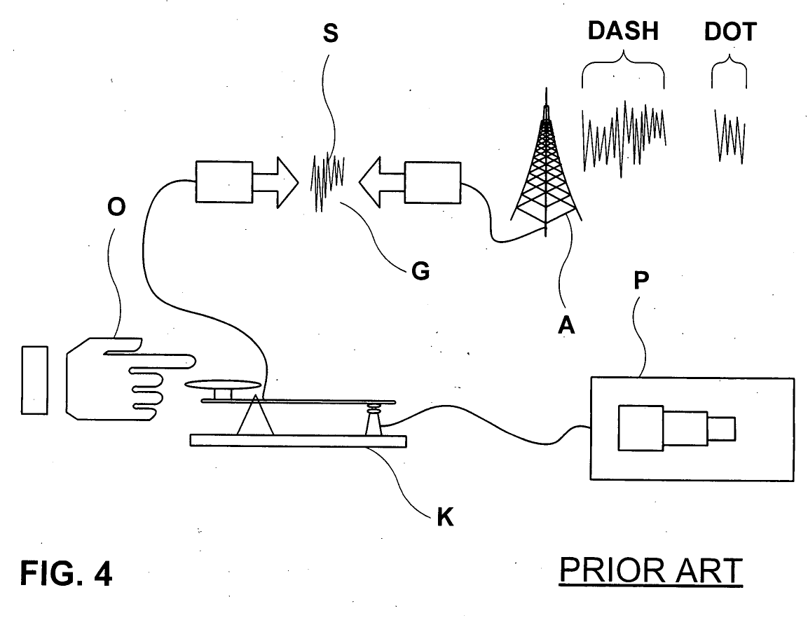

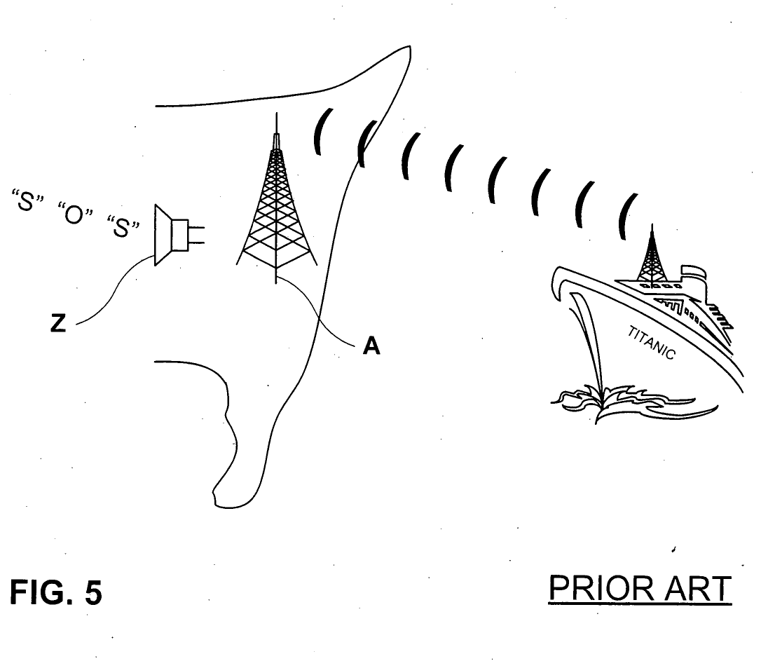

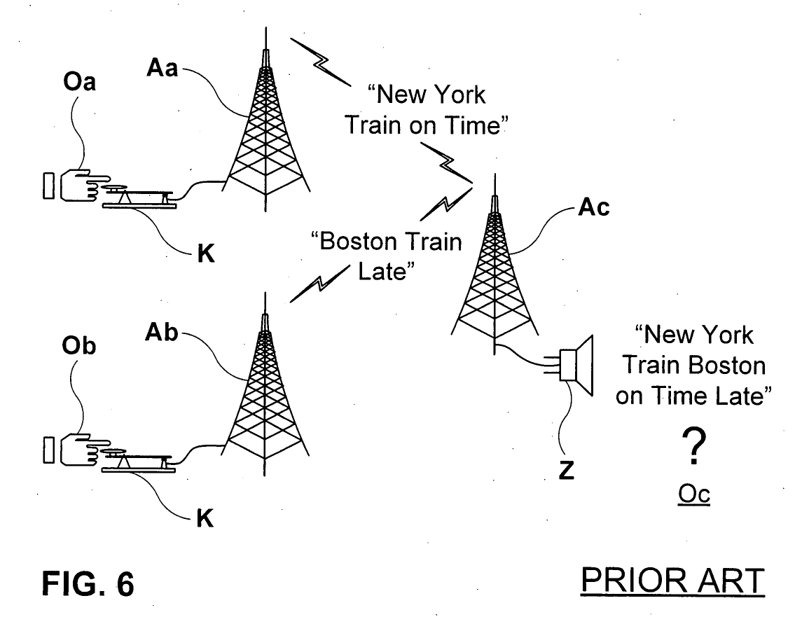

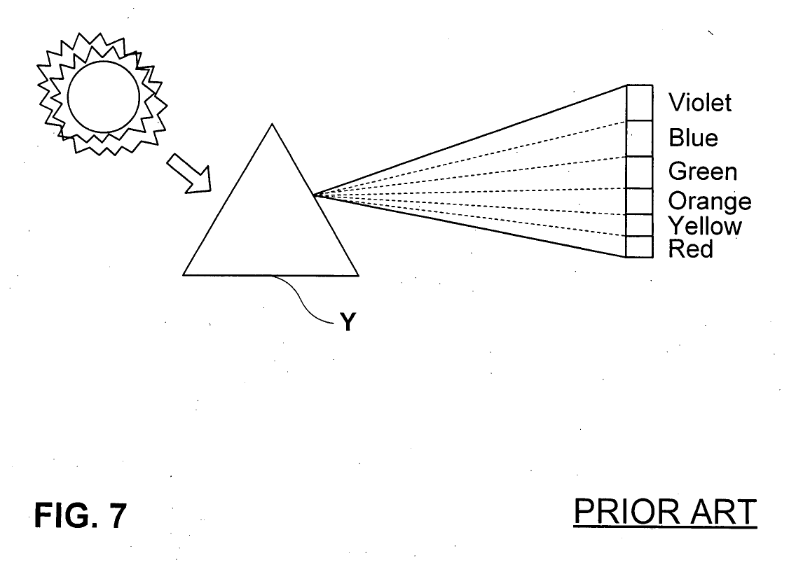

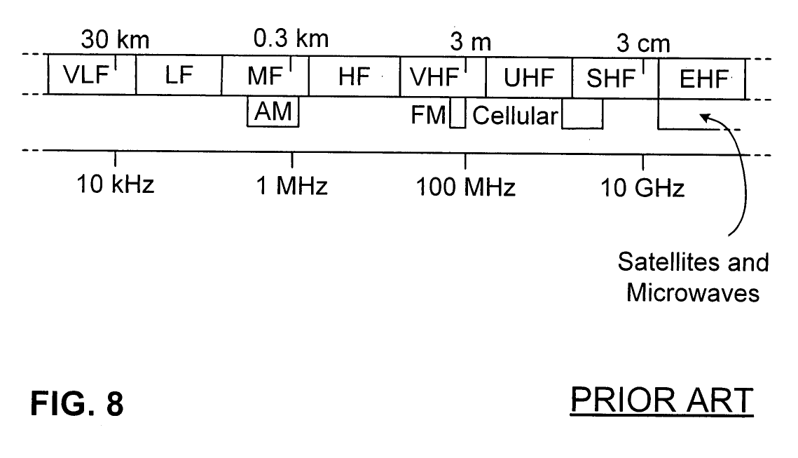

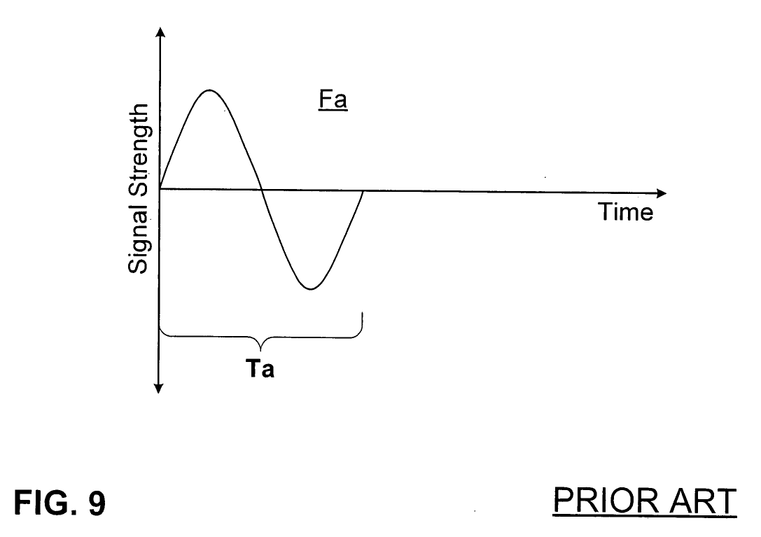

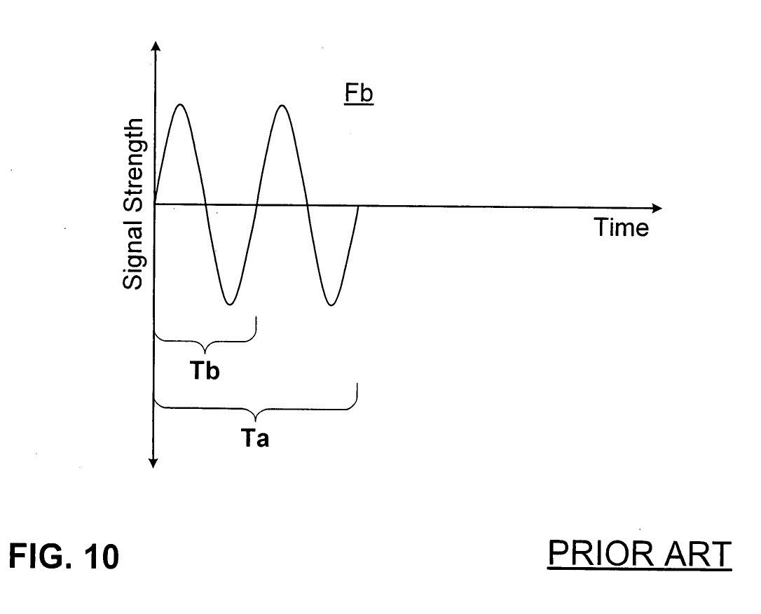

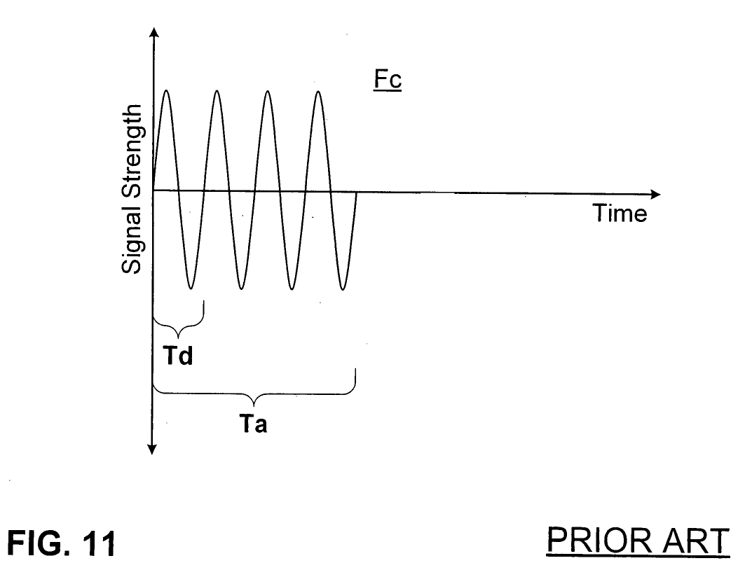

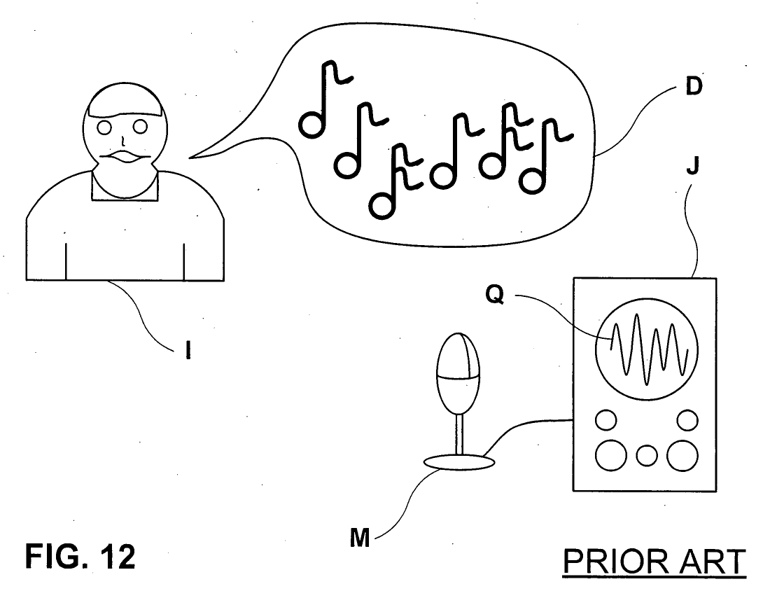

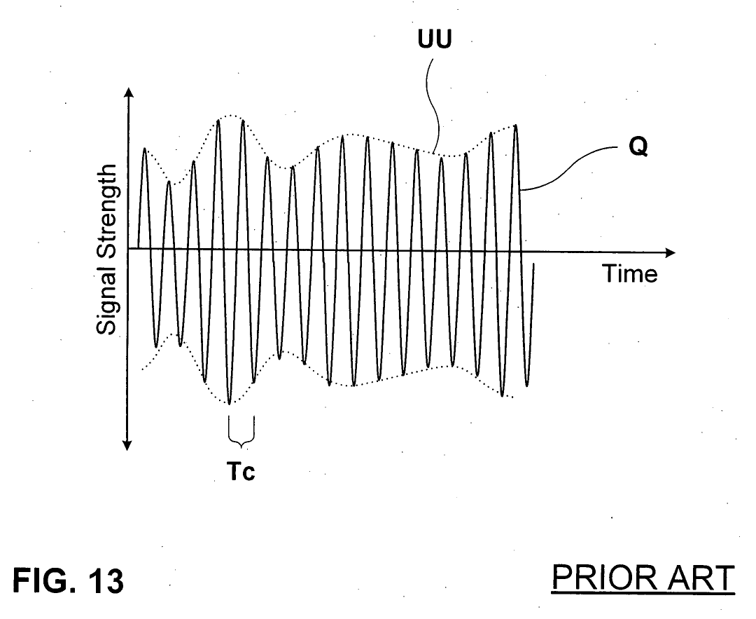

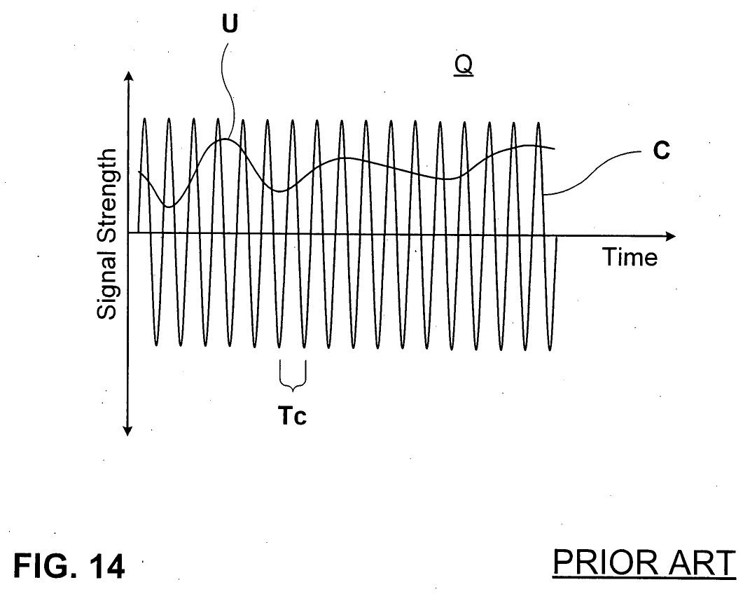

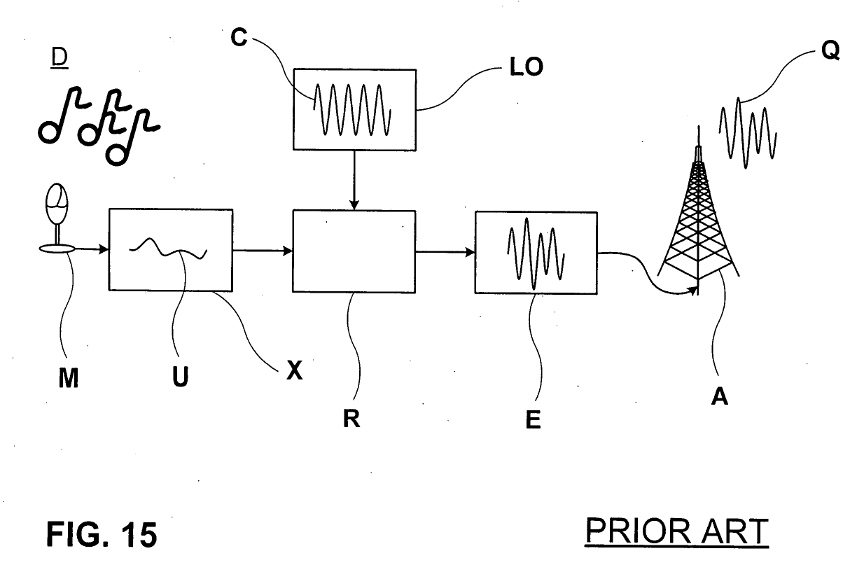

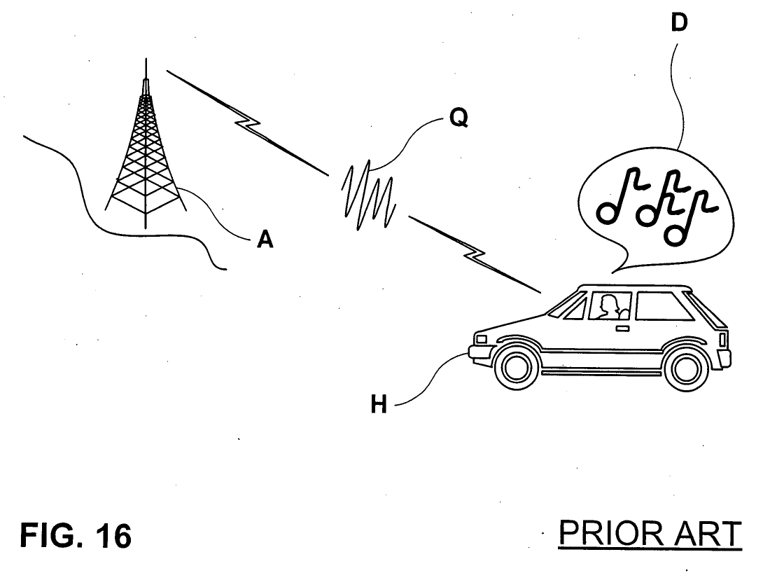

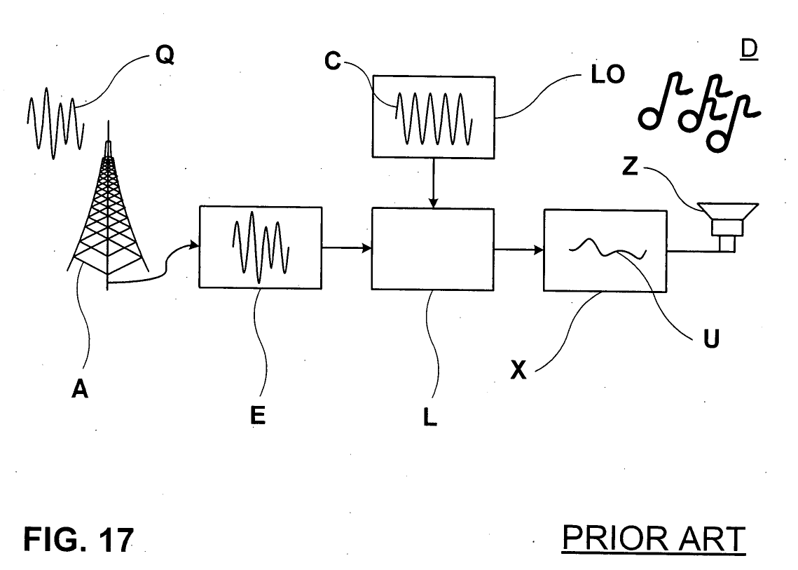

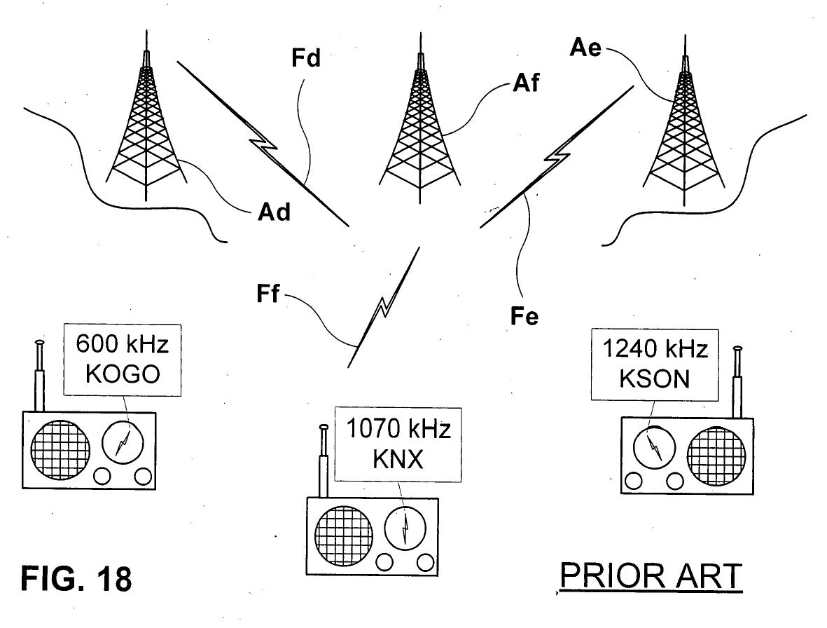

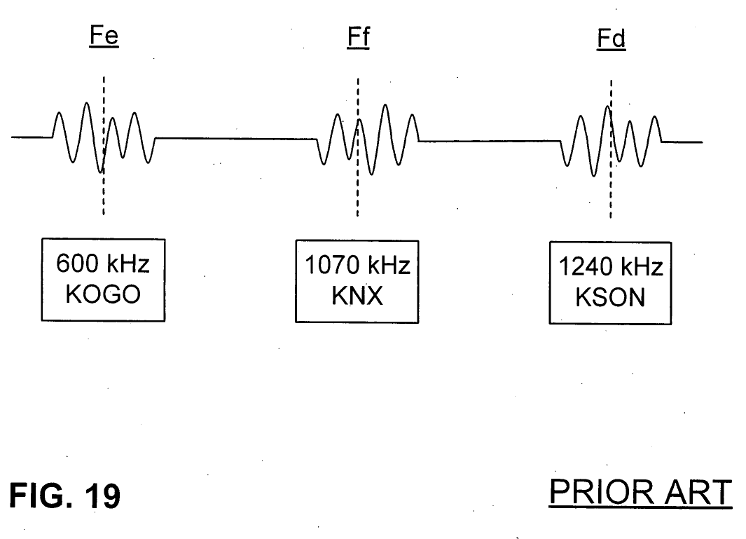

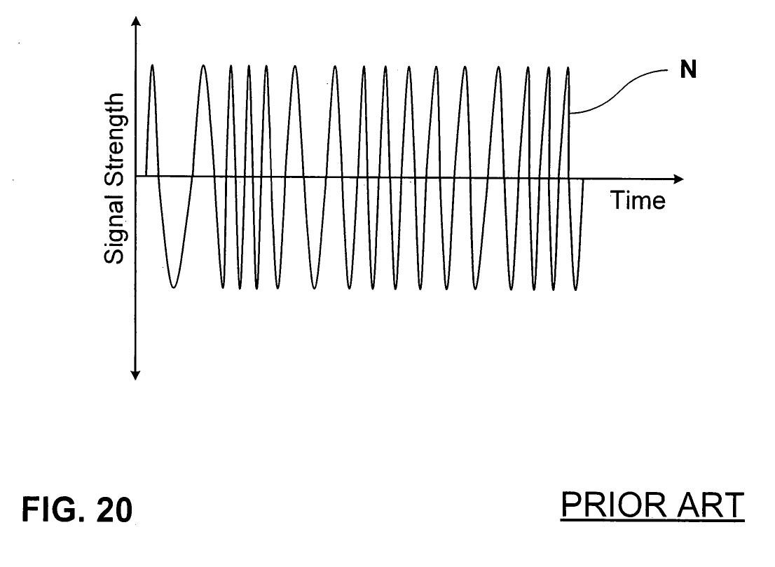

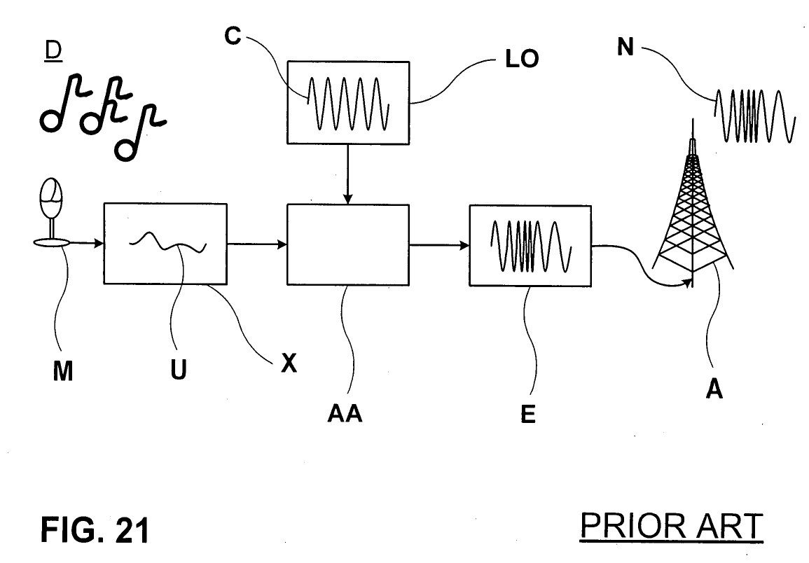

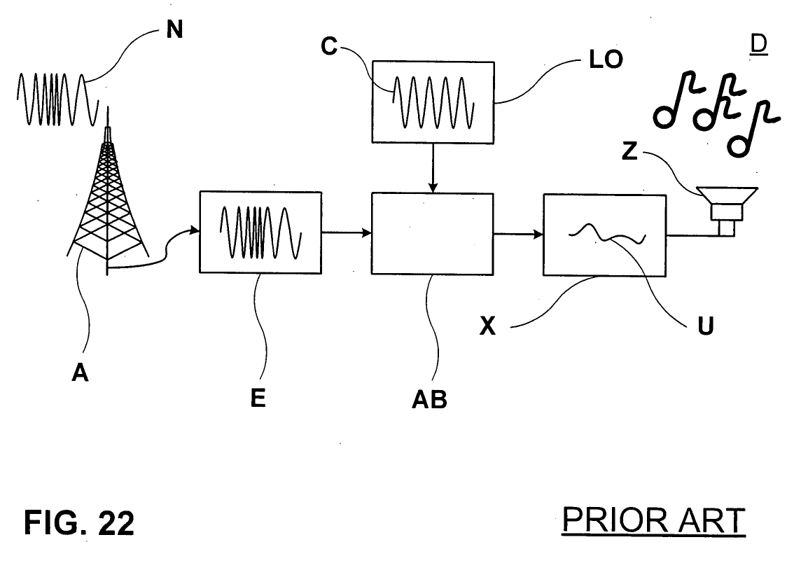

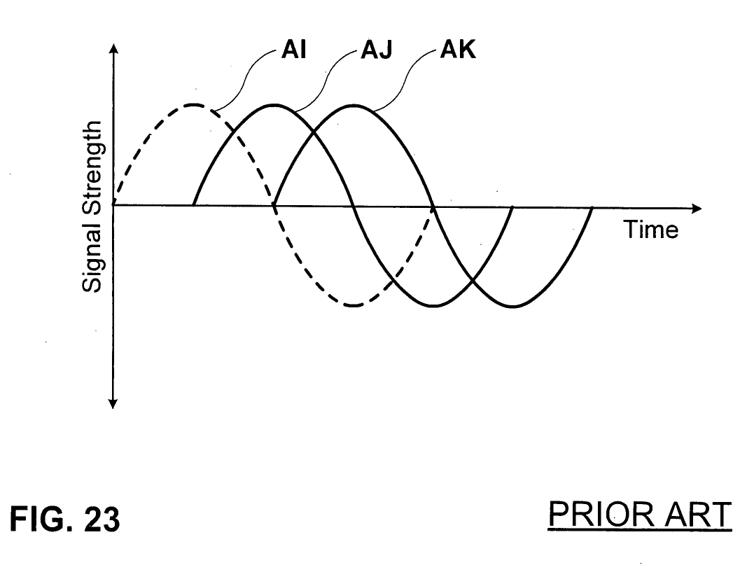

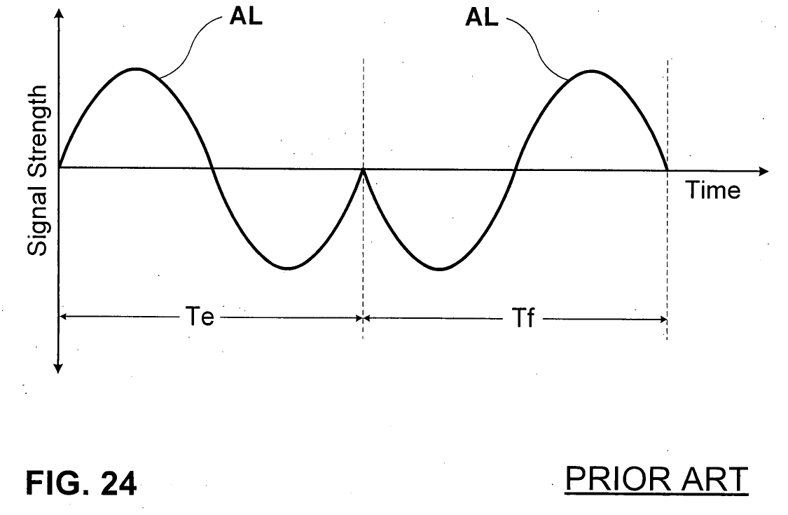

### DETAILED DESCRIPTION OF PREFERRED & ALTERNATIVE EMBODIMENTS

I. Basic Chirp Waveforms.

The Digital Radio System uses “chirp” waveforms to provide high-speed, wireless communications that meet the requirements stated above. The use of the term “chirp” is intended only as a distinctive or descriptive term, and is not intended to limit the scope or description of the present invention. In the most basic embodiment of the invention, chirp waveforms 10 are used to convey a digital message of “one” or “zero.” In general, a chirp waveform 10 may be described as having the following qualities:
Dimensions
Continuity
Boundaries
Family
Duration
Slope
Meaning
Multiplicity
   Dimension

A dimension is the space into which a chirp is mapped. Dimensions may be represented graphically by a set of Cartesian Coordinate Axes, x and y. The minimum number of dimensions for a chirp is always two. More advanced embodiments of the invention may utilize chirps having three or more dimensions.

Continuity

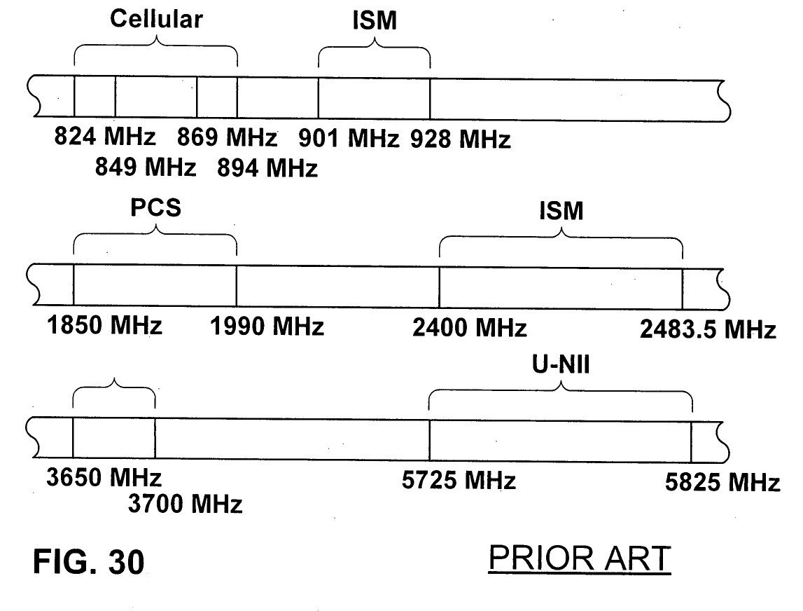

The basic embodiment of a chirp waveform 10 utilizes generally continuous line segments, as shown in FIG. 30. In this Specification and in the Claims that follow, the term “continuous” refers to a function which describes a line that extends between a start point 12S and end point 12E that is smooth and gradual without any breaks or sharp changes in direction. If a line segment can be drawn from a start point 12S to an end point 12E without lifting the pencil from the paper, that segment is generally continuous. A more technical explanation defines “continuous” as a function for which an arbitrarily small change in x causes an arbitrarily small change in y. A rigorous, mathematical definition for continuous follows:

A function is continuous at a point c in its domain D if:
Given any ε>0 there exists a δ>0 such that: if x ε D and |x−c|<δ then |f(x)−f(c)|<ε.

A function is continuous in its domain D if it is continuous at every point of its domain.

See: http://web01.shu.edu/projects/reals/cont/contin.html

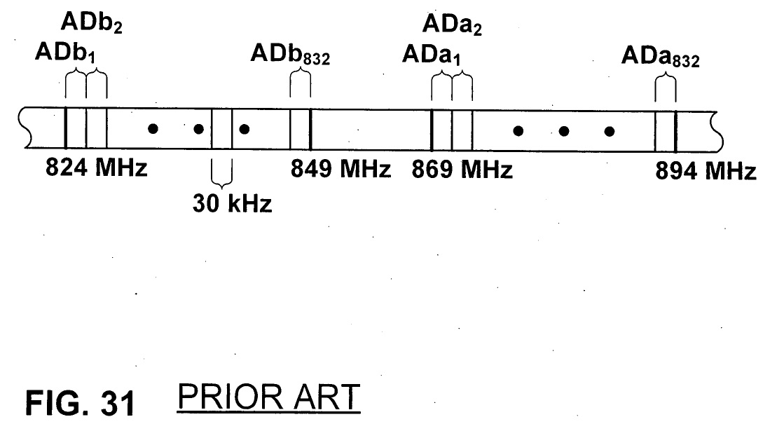

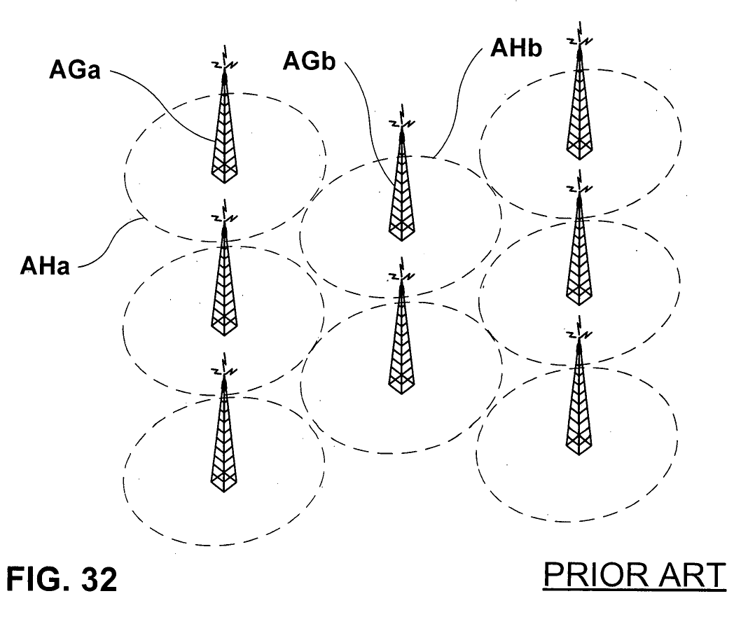

In an alternative embodiment, discontinuous waveforms 10A may be employed to implement the present invention, as shown in FIG. 31.

Boundaries

As shown best in FIG. 30, a boundary 12 is an end point of a single chirp. A start point 12S and an end point 12E are the two boundaries of the most basic form of chirp 10. When boundaries are measured in the time dimension, the end point 12E is always later in time that the start point 12S. For this kind of simple chirp 10, no other boundaries are recognized.

Family

A family is the description of the group to which a particular chirp belongs. The family concerns the type of line segment that is used to form a chirp. The most basic type of chirp is constructed from a linear line segment, and may be described by the equation y=mx+b. In more advanced chirps, the line segment which is employed to build a chirp may be defined by an equation that uses a mononomial expression, a polynomial expression, a trigonometric expression, an exponential expression or any other algebraic expression that defines a generally continuous line segment that extends between a start point and an end point. In this Specification and in the Claims that follow, the term “mononomial” means an expression comprising only one term. The term “polynomial” means an expression comprising of two or more terms. The term “sinusoidal” means an expression comprising one or more terms of the form:
f(x)=a sin(x)+b cos(x)
The term “exponential” pertains to a mathematical function that includes a variable in an exponent, and which is characterized by the following form:
f(x)=a^{x}
where x is a variable, and a is a constant, called the base of the function. The most commonly encountered exponential-function base is the transcendental number e, which is equal to approximately 2.71828. Thus, the above expression becomes:
f(x)=e^{x}
Duration & Slope

For the chirp waveform 10 depicted in FIG. 30, the duration of the chirp is the time T that elapses between the end point 12S and the end point 12E:
Duration=Time at End Point−Time at Start Point
Similarly, the slope of the chirp waveform 10 shown in FIG. 30 is the quotient of the end point 12E and the start point 12S:
Slope=(End Point Amplitude−Start Point Amplitude)/Duration
Meaning

In one embodiment of the invention, a meaning is the digital value that is represented by a chirp. In the most basic embodiment, there are only two meanings for a chirp, “one” and “zero.” No other meanings or values are permitted. In more advanced embodiments, more than two meanings are permitted.

For a two dimensional chirp, one method of determining the meaning of a chirp waveform compares maximum and minimum chirp values. Using this method, a chirp waveform has a value of “one” if the value of the end point 12E as measured along the y-axis is greater than the value of the start point 12S as measured along the y-axis, also known as an “up-chirp.” For a two dimensional chirp, a chirp waveform has a value of “zero” if the value of the end point 12E as measured along the y-axis is less than the value of the start point 12S as measured along the y-axis, also known as a “down-chirp.”

In an alternative embodiment, a chirp waveform has a value of “one” if the slope of the line segment at any point on the line segment between the start point and the end point is positive. Conversely, a chirp waveform has a value of “zero” if the slope of the line segment at any point on the line segment between the start point and the end point is negative.

Methods for determining the values of three or higher dimensional chirp waveforms are discussed in Section III.

The term “meaning” generally refers to the message, value, condition or state which is propagated by a source, and which then may be detected, decoded or interpreted by a receiver, whether wired or wireless.

Multiplicity

The multiplicity of a chirp refers to the number of waveforms that are propagated or present in a given time interval or over a particular time duration. The waveform 10 shown in FIG. 30 is alone in the duration that spans start point 12S and end point 12E, so the waveform in FIG. 30 has a multiplicity of one. Higher multiplicity chirps are discussed in Section IV of this Specification.

II. Alternative Embodiments of Two Dimensional Chirp Waveforms

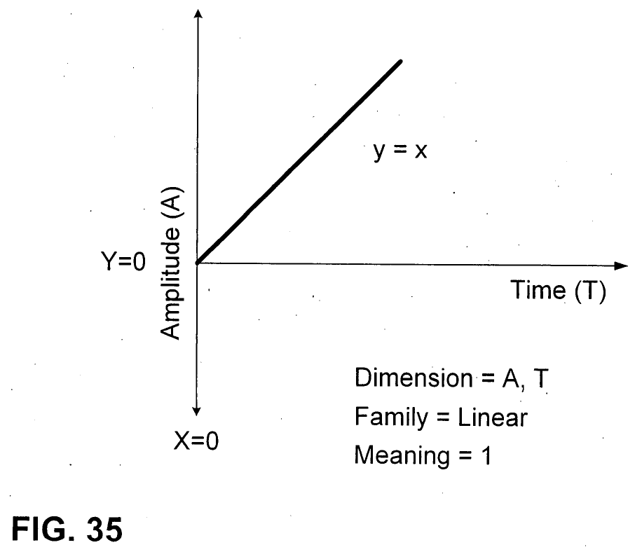

The chirp shown in FIG. 30 may be varied by altering the kind of line segment which is used to span the distance between the start point 12S and the end point 12E. These variations provide a virtually limitless number of alternative embodiments. Some of these alternative embodiments for two dimensional chirps are depicted in FIGS. 35 through 74. These figures are provided as examples and illustrations, and are not intended to exclude many other possible two-dimensional waveforms.

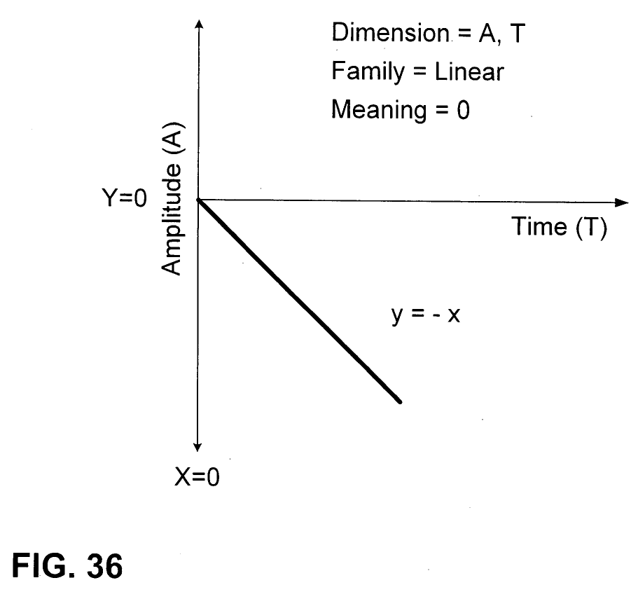

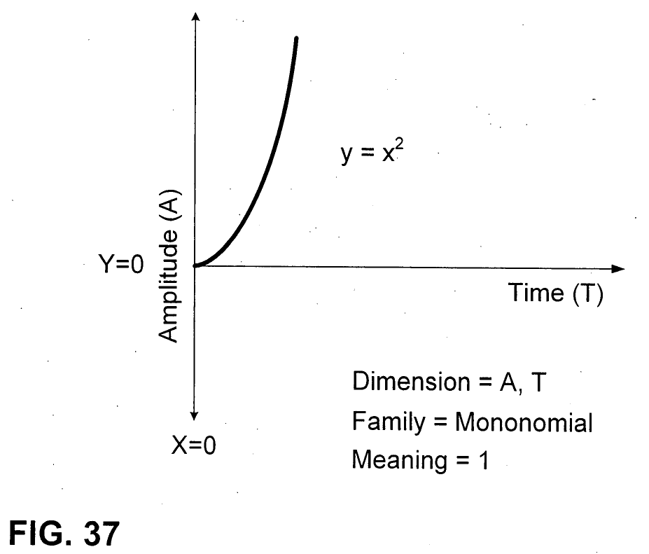

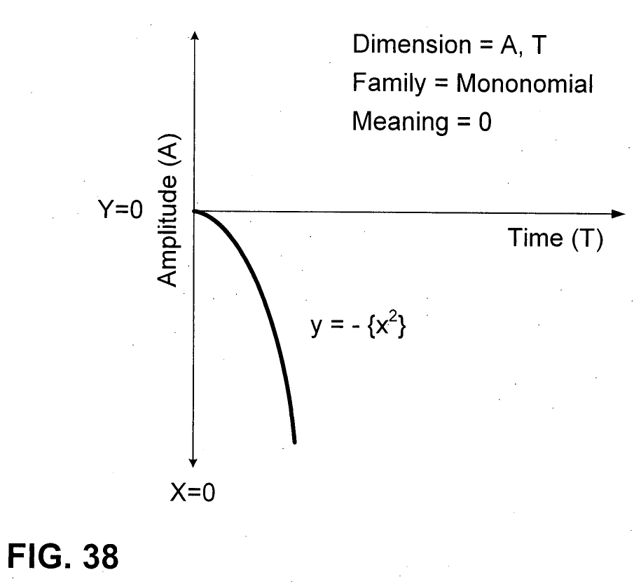

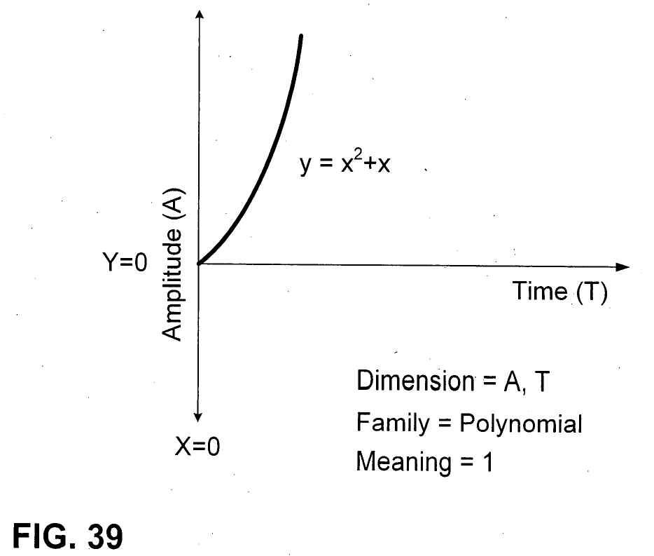

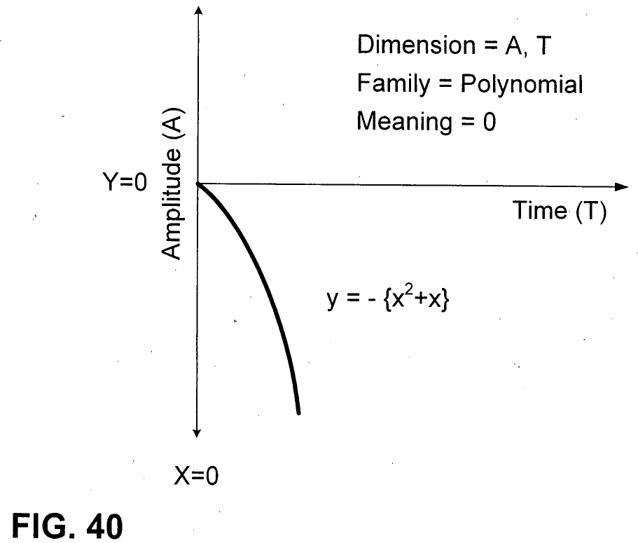

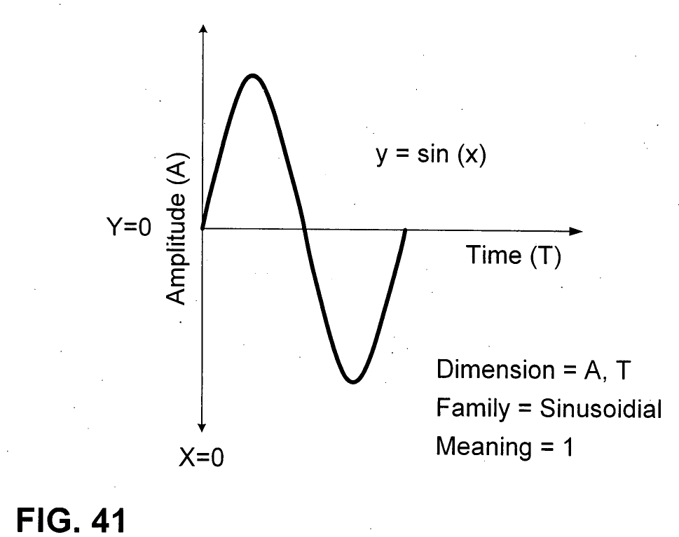

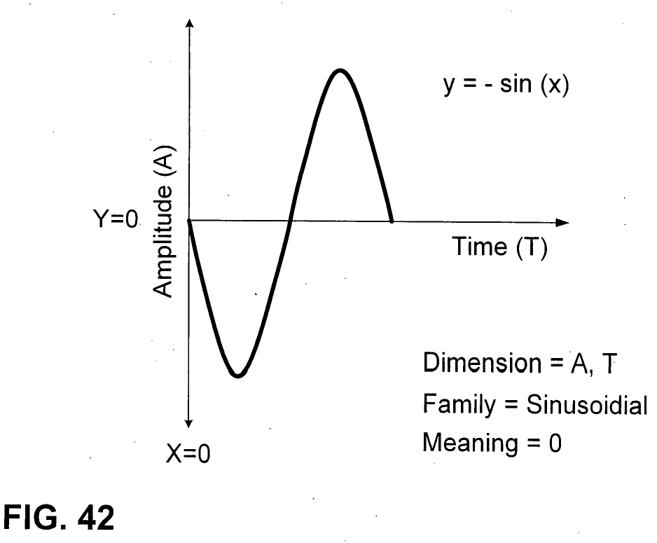

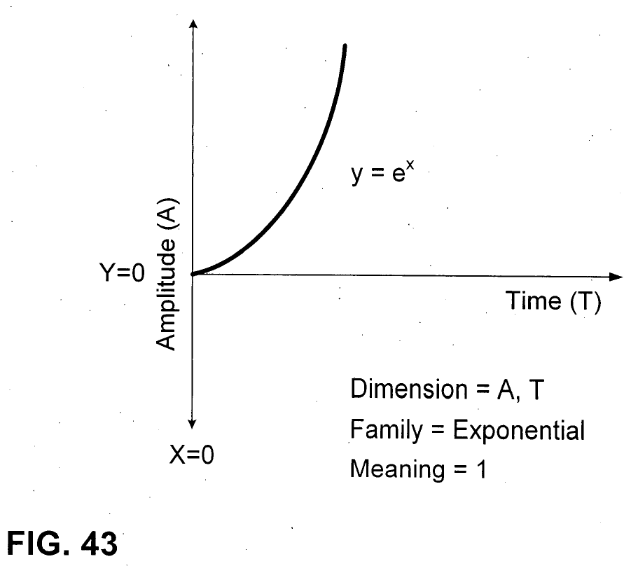

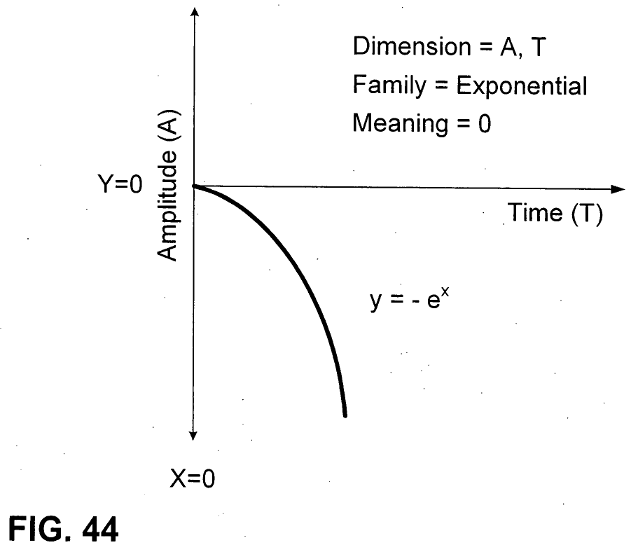

FIGS. 35 and 36 are formed from linear line segments. FIGS. 37 and 38 are formed from mononomial line segments. FIGS. 39 and 40 are formed from polynomial line segments. FIGS. 41 and 42 are formed from sinusoidal line segments. FIGS. 43 and 44 are formed from exponential line segments. FIGS. 35, 37, 39, 41 and 43 have meanings of “one” in amplitude versus time space. FIGS. 36, 38, 40, 42 and 44 have meanings of “zero” in amplitude versus time space.

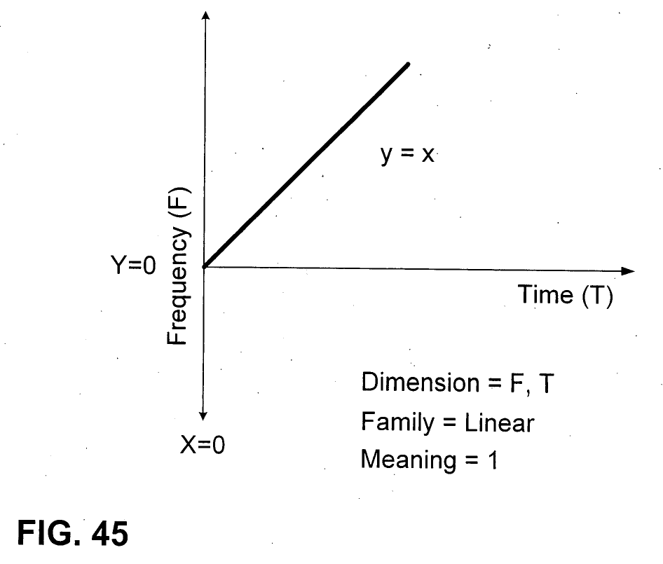

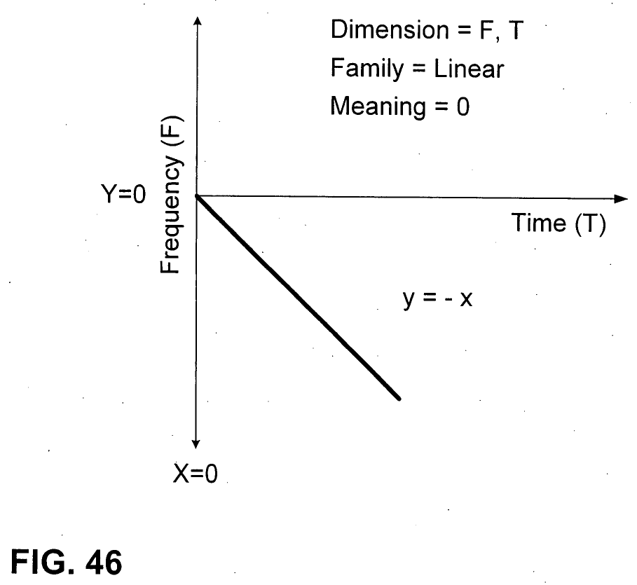

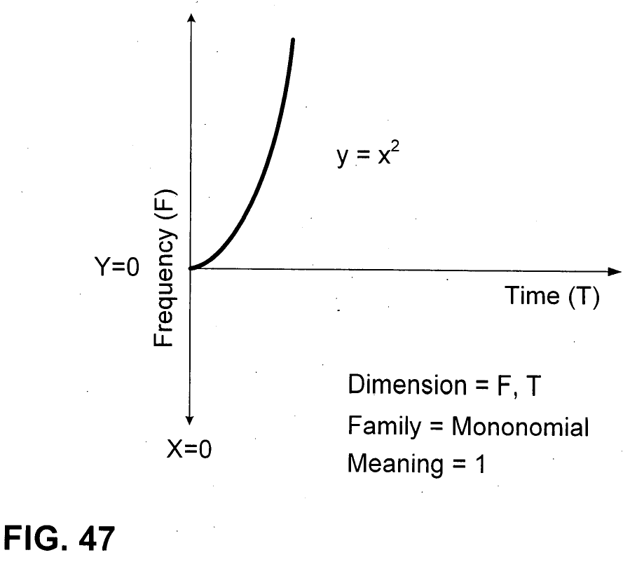

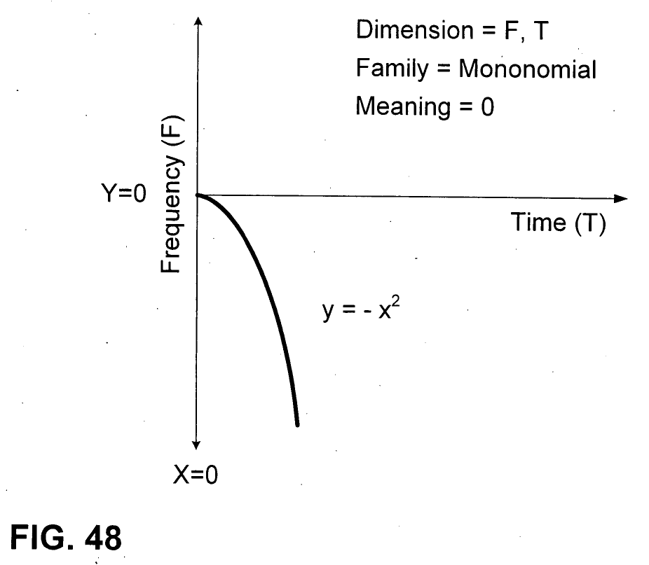

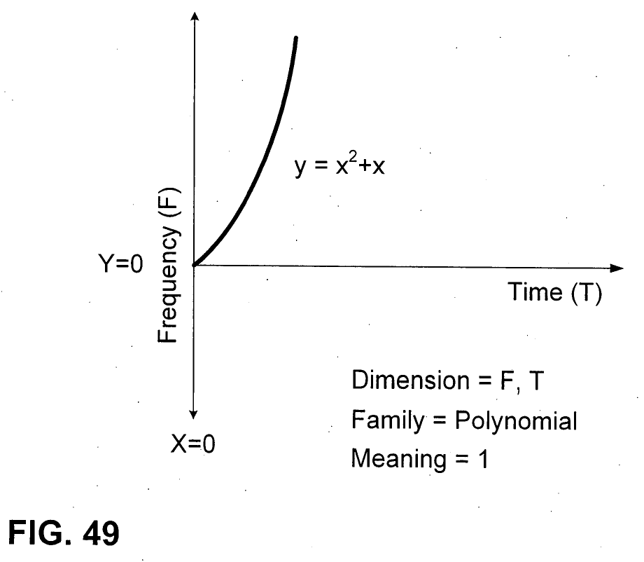

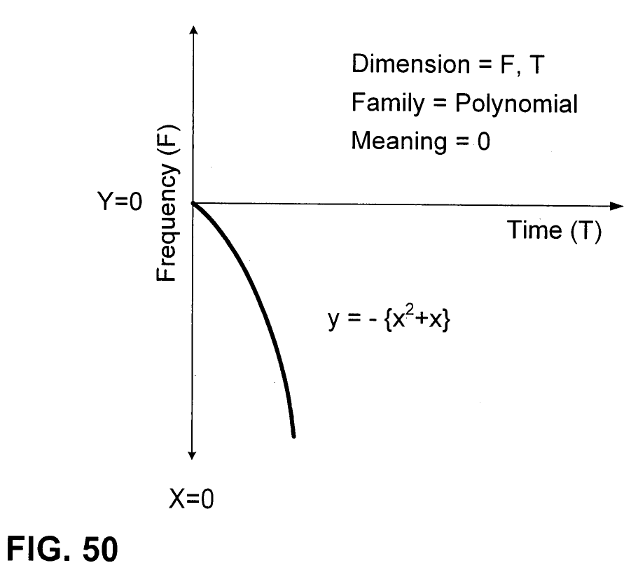

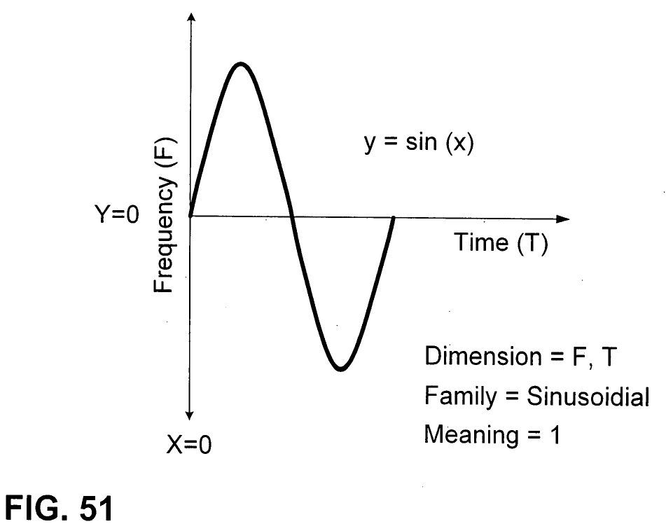

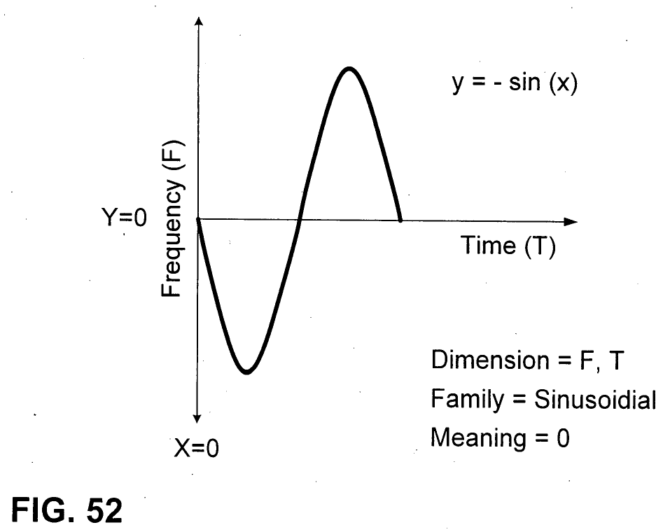

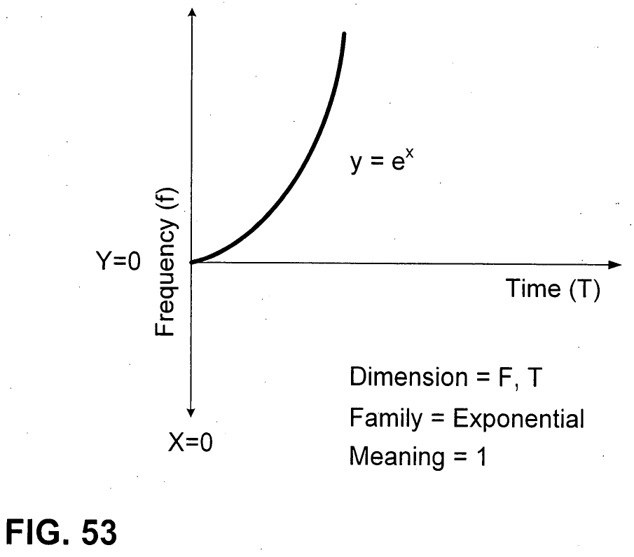

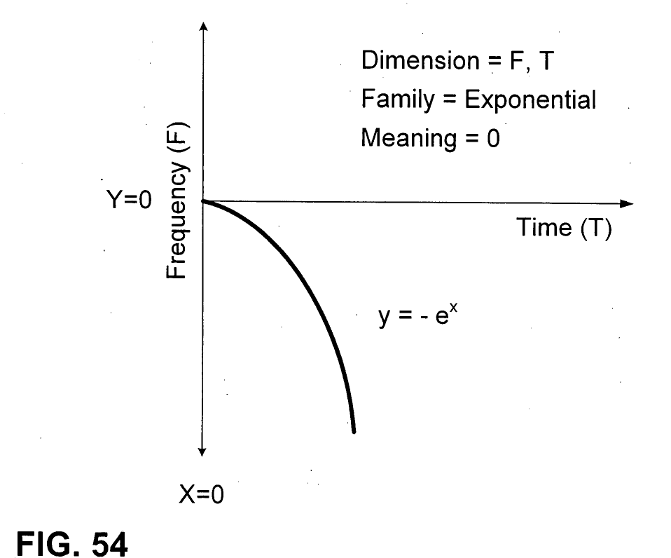

FIGS. 45 through 54 depict two-dimensional chirp waveforms mapped in frequency versus time space for meanings “one” and “zero” for five different families of chirps. FIGS. 45 and 46 are formed from linear line segments. FIGS. 47 and 48 are formed from mononomial line segments. FIGS. 49 and 50 are formed from polynomial line segments. FIGS. 51 and 52 are formed from sinusoidal line segments. FIGS. 53 and 54 are formed from exponential line segments. FIGS. 45, 47, 49, 51 and 53 have meanings of “one.” FIGS. 46, 48, 50, 52 and 54 have meanings of “zero.”

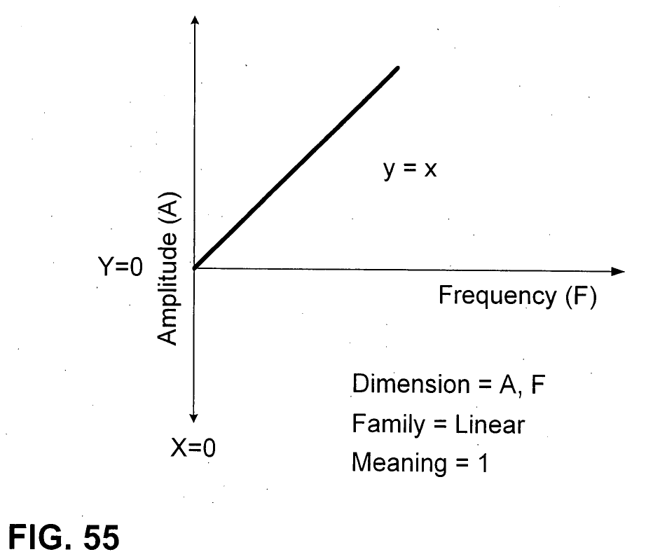

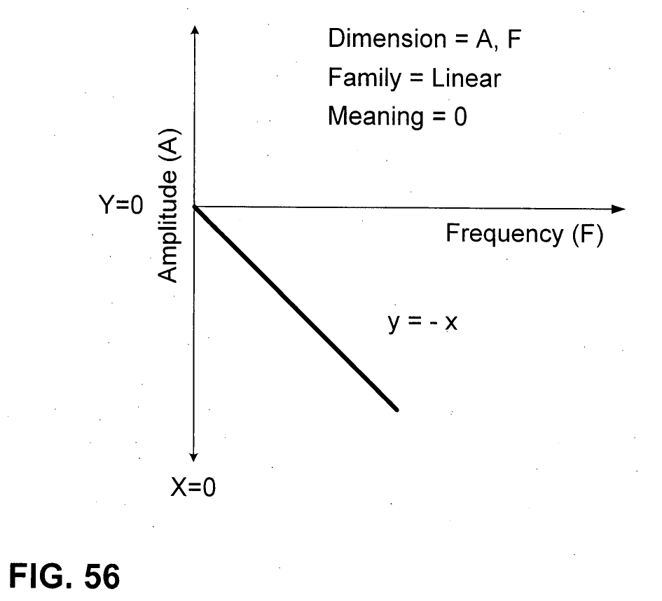

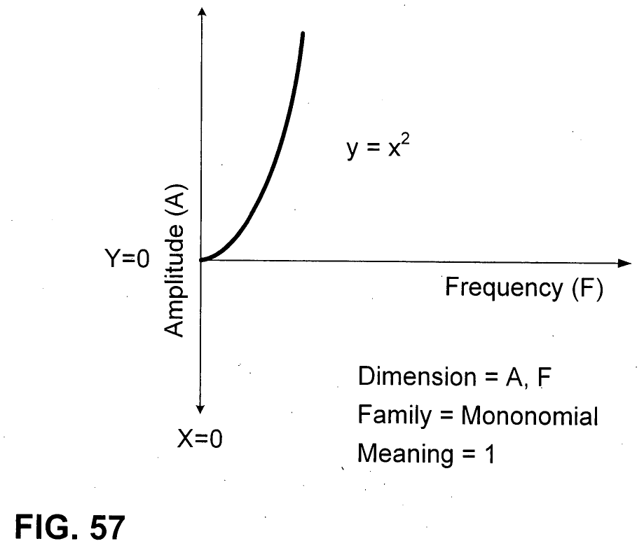

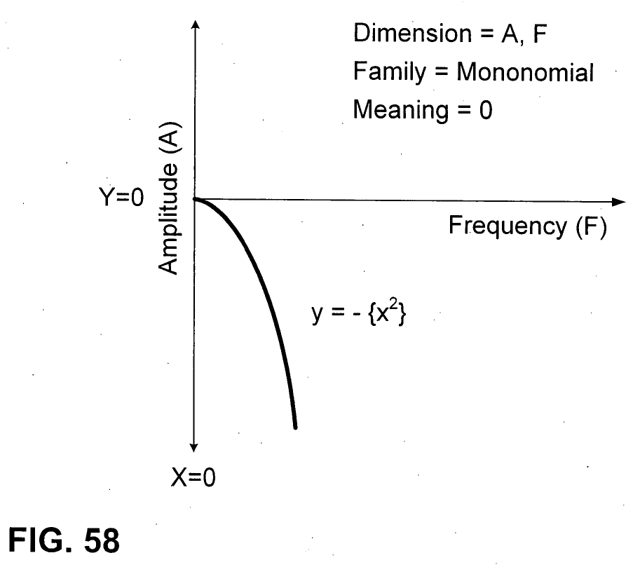

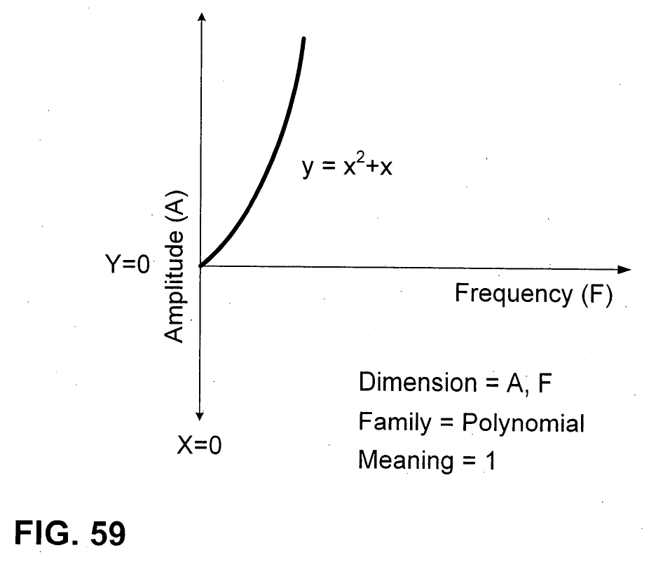

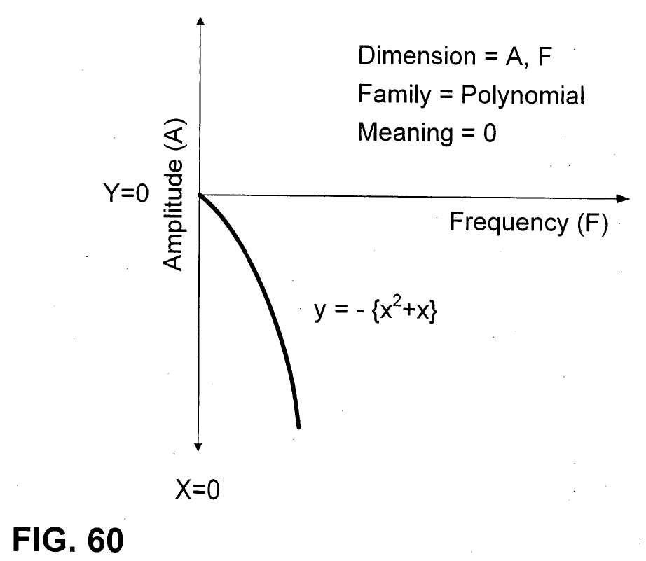

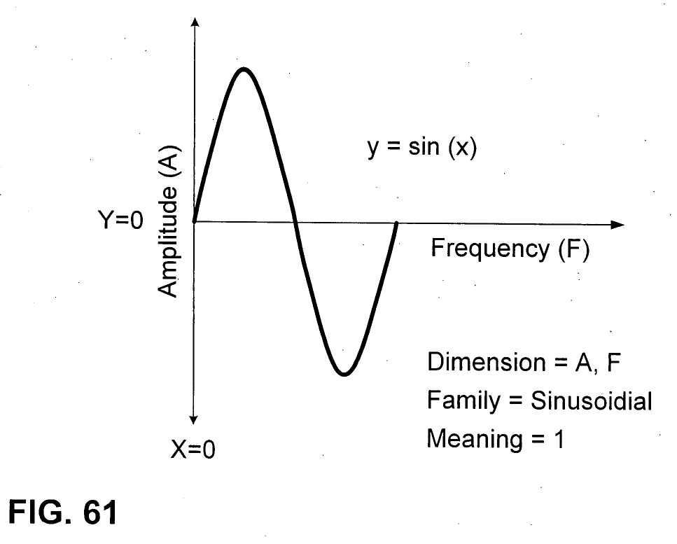

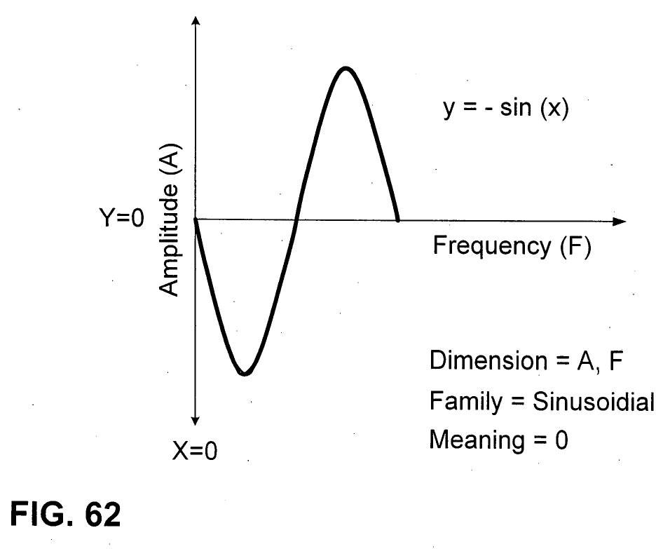

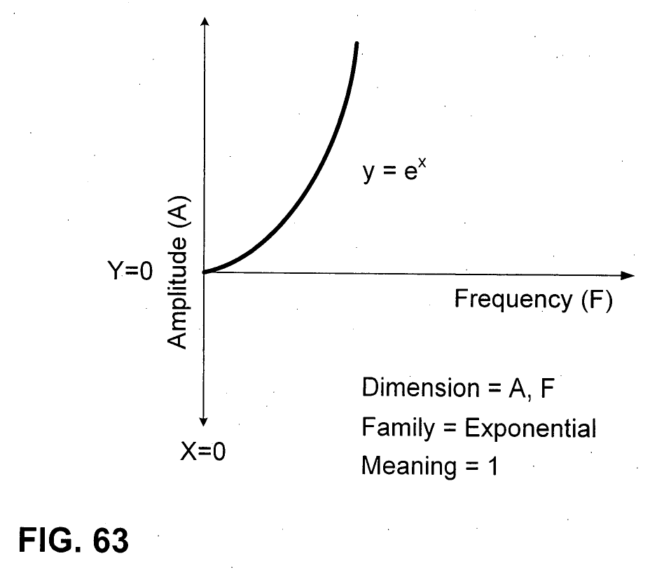

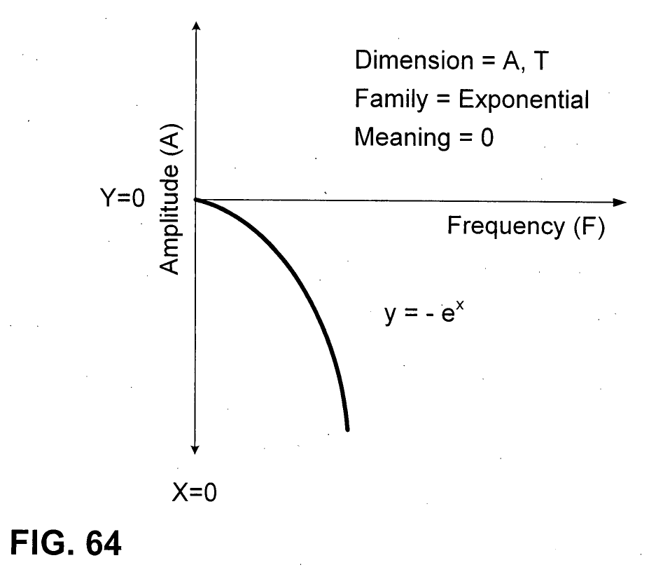

FIGS. 55 through 64 depict two-dimensional chirp waveforms mapped in amplitude versus frequency space for meanings “one” and “zero” for five different families of chirps. FIGS. 55 and 56 are formed from linear line segments. FIGS. 57 and 58 are formed from mononomial line segments. FIGS. 59 and 60 are formed from polynomial line segments. FIGS. 61 and 62 are formed from sinusoidal line segments. FIGS. 63 and 64 are formed from exponential line segments. FIGS. 55, 57, 59, 61 and 63 have meanings of “one.” FIGS. 56, 58, 60, 62 and 64 have meanings of “zero.”

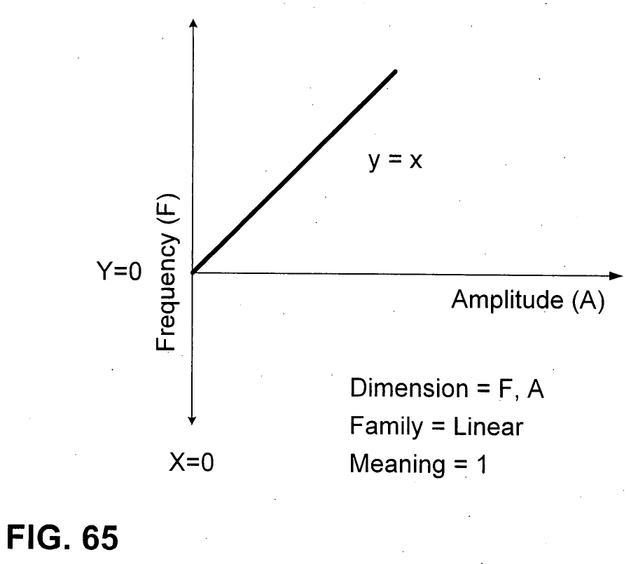

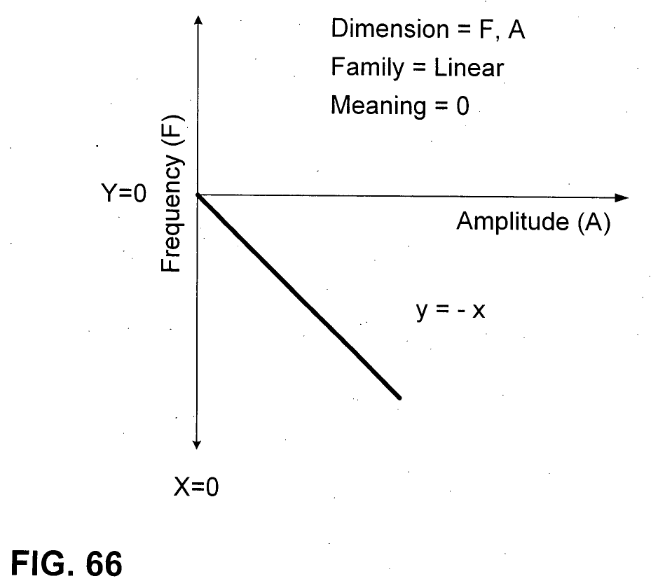

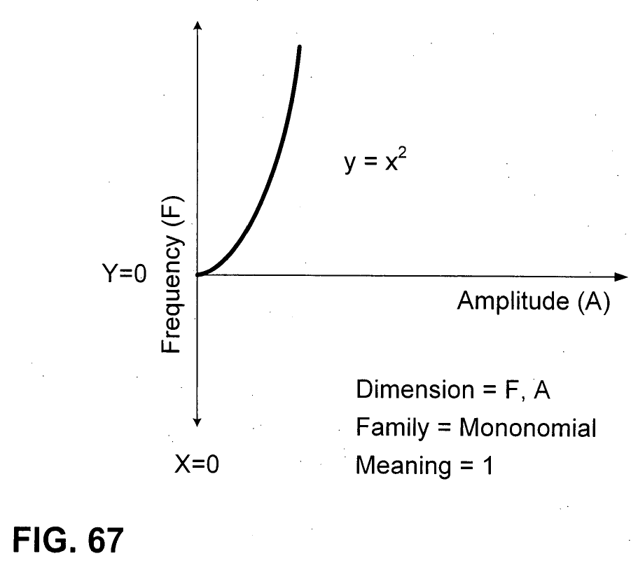

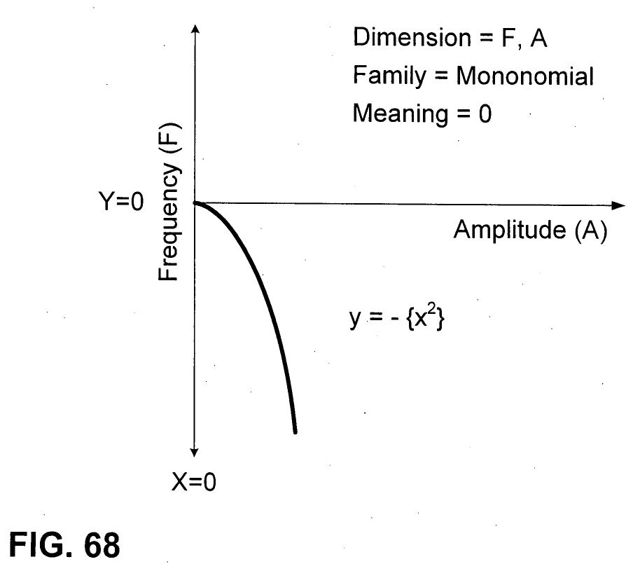

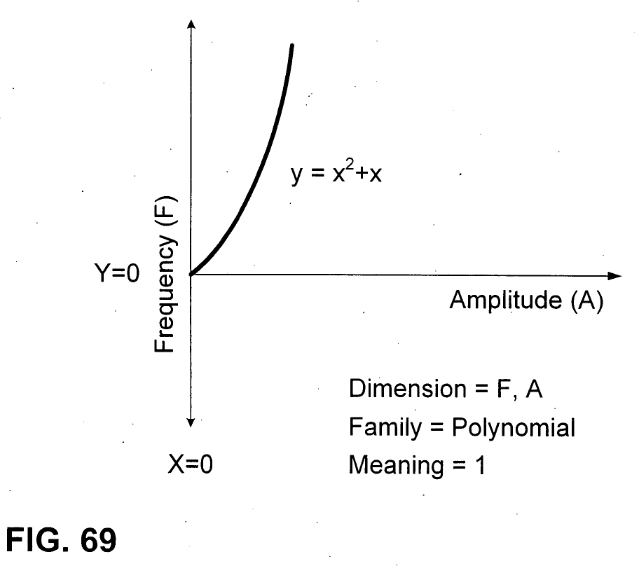

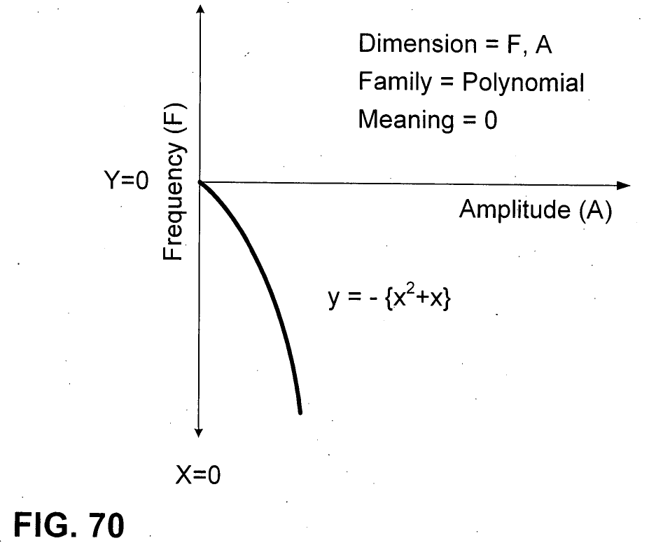

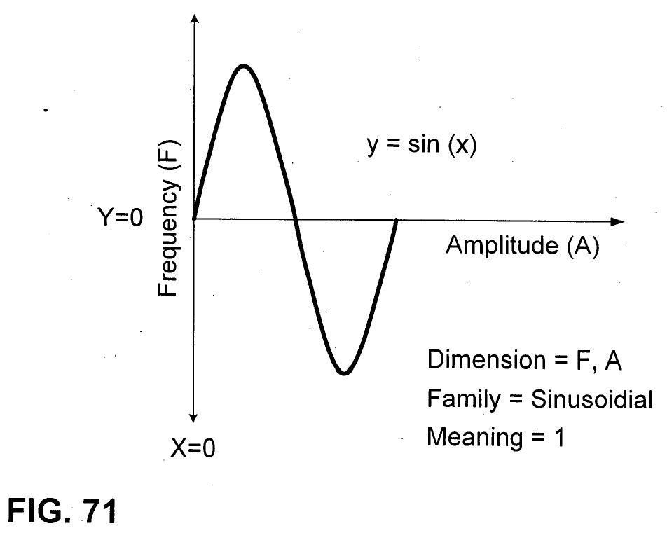

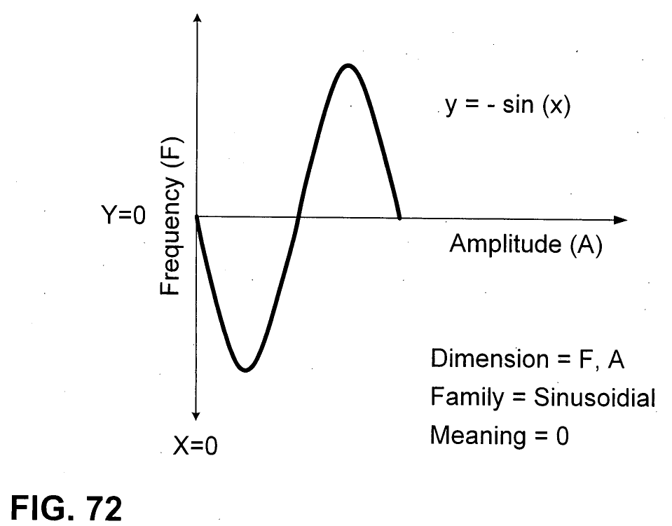

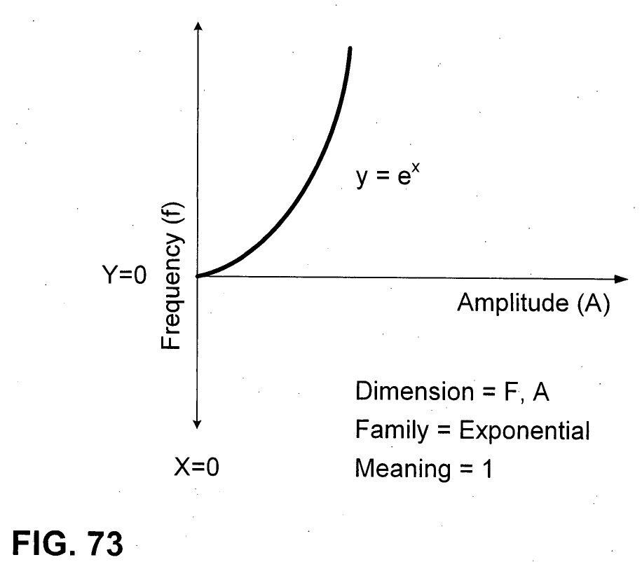

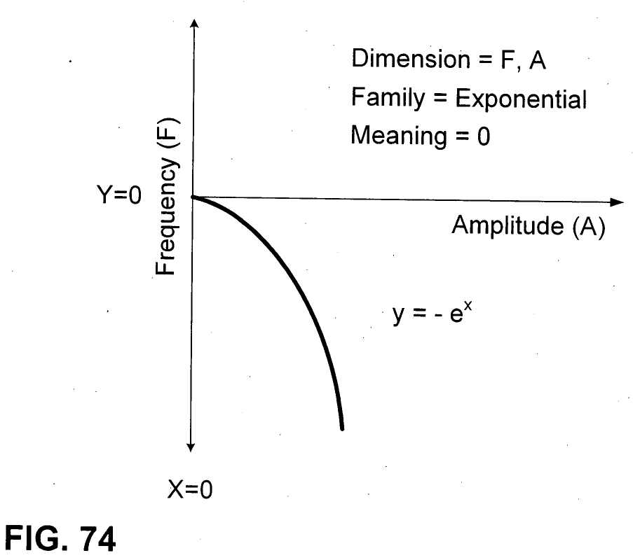

FIGS. 65 through 74 depict two-dimensional chirp waveforms mapped in frequency versus amplitude space for meanings “one” and “zero” for five different families of chirps. FIGS. 65 and 66 are formed from linear line segments. FIGS. 67 and 68 are formed from mononomial line segments. FIGS. 69 and 70 are formed from polynomial line segments. FIGS. 71 and 72 are formed from sinusoidal line segments. FIGS. 73 and 74 are formed from exponential line segments. FIGS. 65, 67, 69, 71 and 73 have meanings of “one.” FIGS. 66, 68, 70, 72 and 74 have meanings of “zero.”

III. Three Dimensional Chirp Waveforms

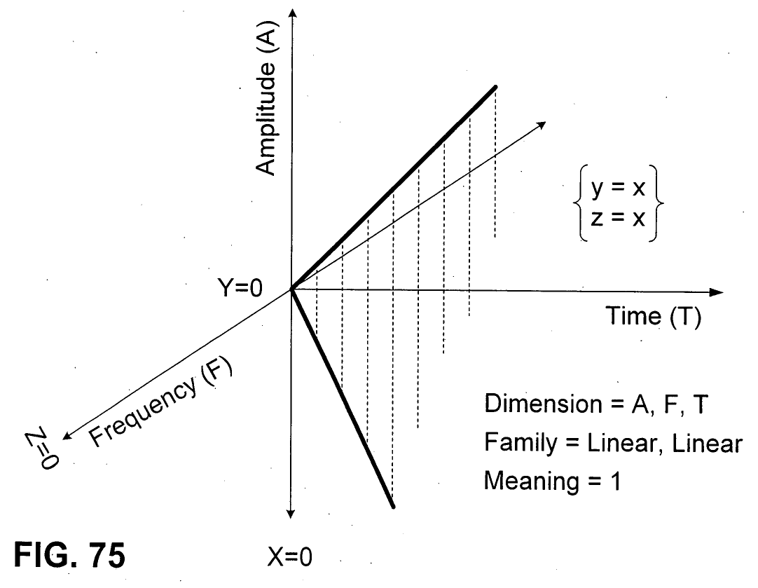

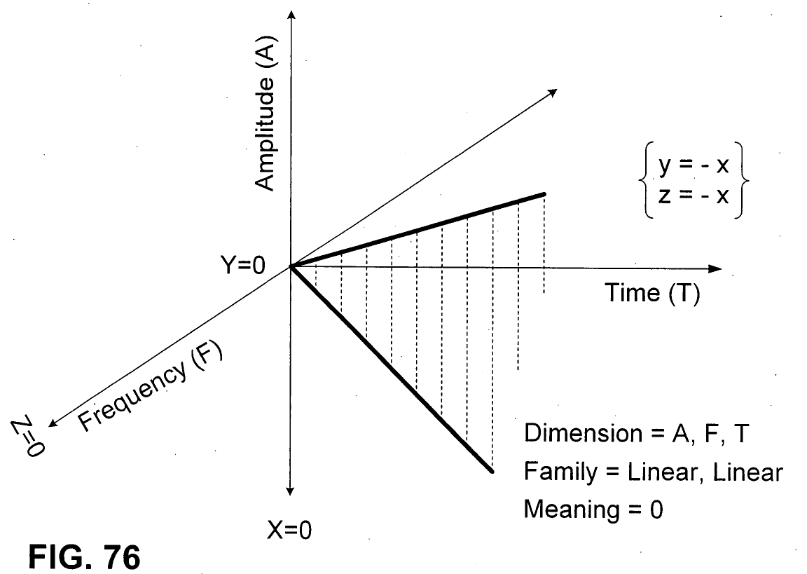

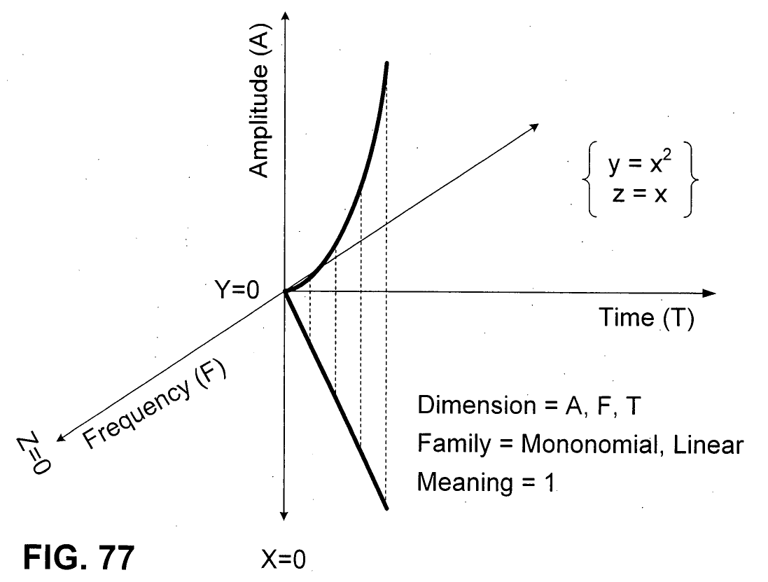

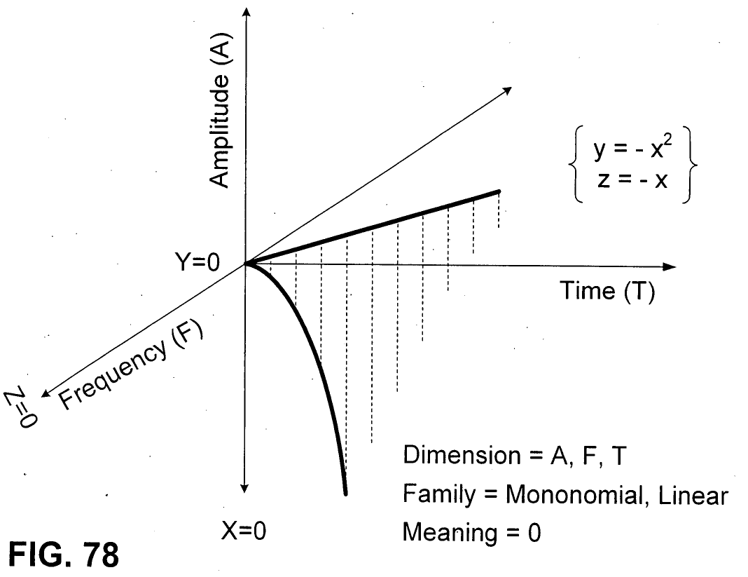

FIGS. 75 through 124 exhibit three dimensional chirp waveforms, which are mapped in amplitude, frequency and time space. FIG. 75 utilizes linear line segments and has a meaning of “one.” FIG. 76 utilizes linear line segments and has a meaning of “zero.” FIG. 77 utilizes linear and mononomial line segments and has a meaning of “one.” FIG. 78 utilizes linear and mononomial line segments and has a meaning of “zero.”

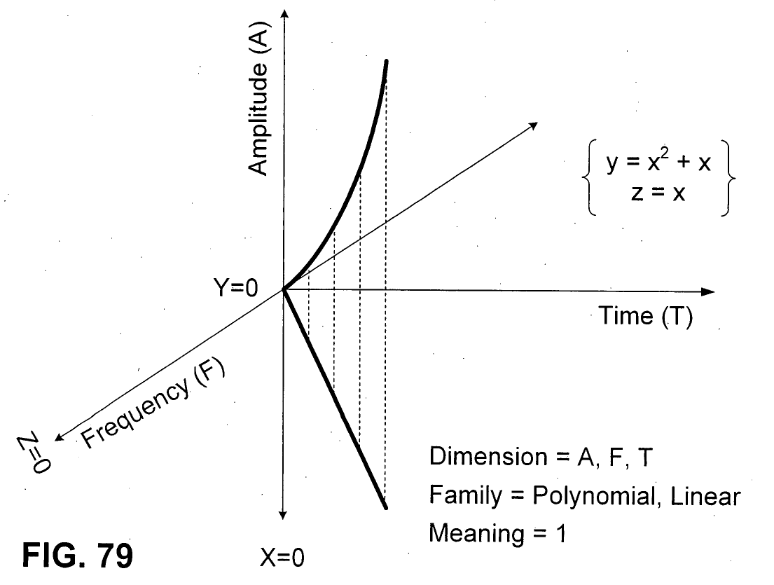

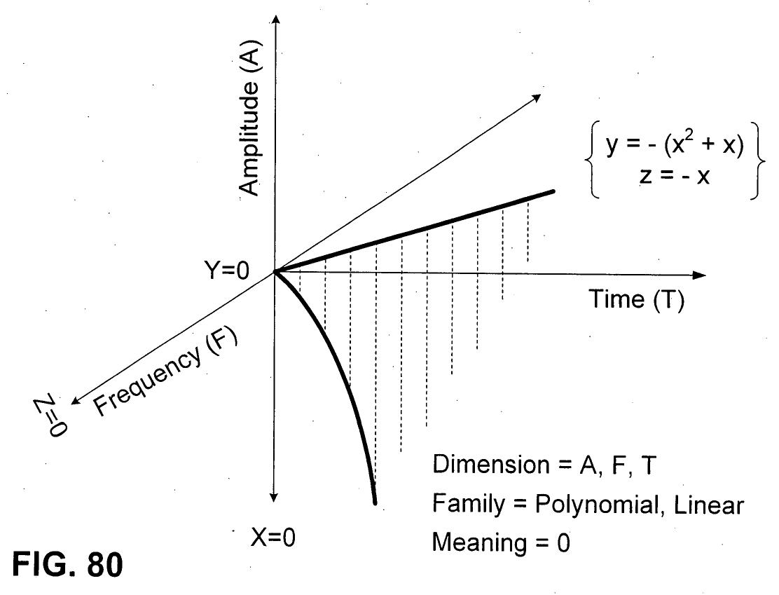

FIGS. 79 and 80 utilize polynomial and linear line segments. FIG. 79 shows a waveform that has a meaning of “one,” while FIG. 80 shows a waveform that has a meaning of “zero.”

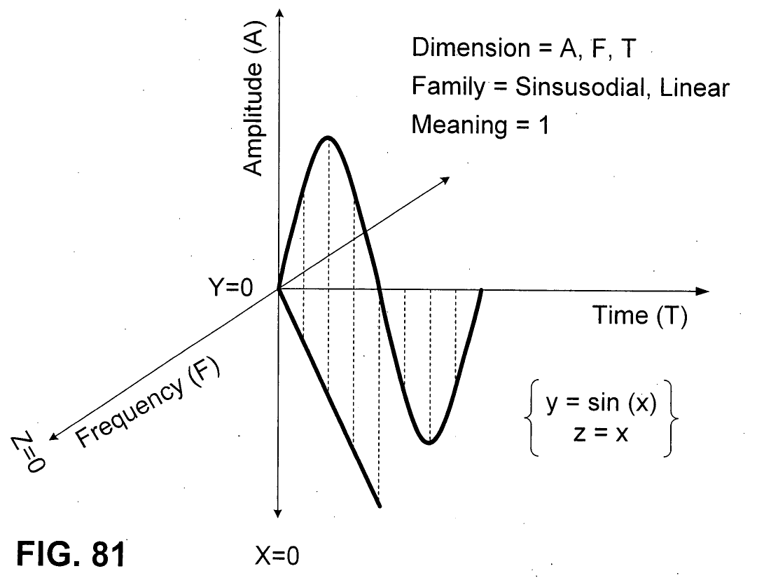

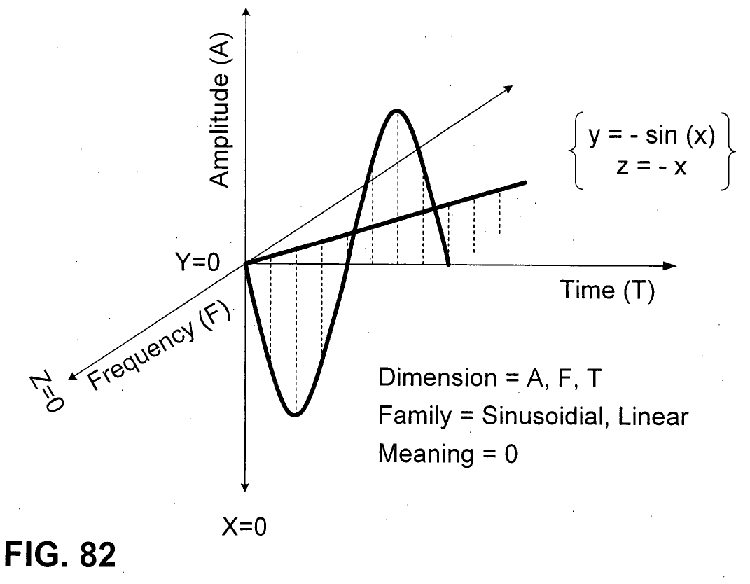

FIGS. 81 and 82 utilize sinusoidal and linear line segments. FIG. 81 shows a waveform that has a meaning of “one,” while FIG. 82 shows a waveform that has a meaning of “zero.”

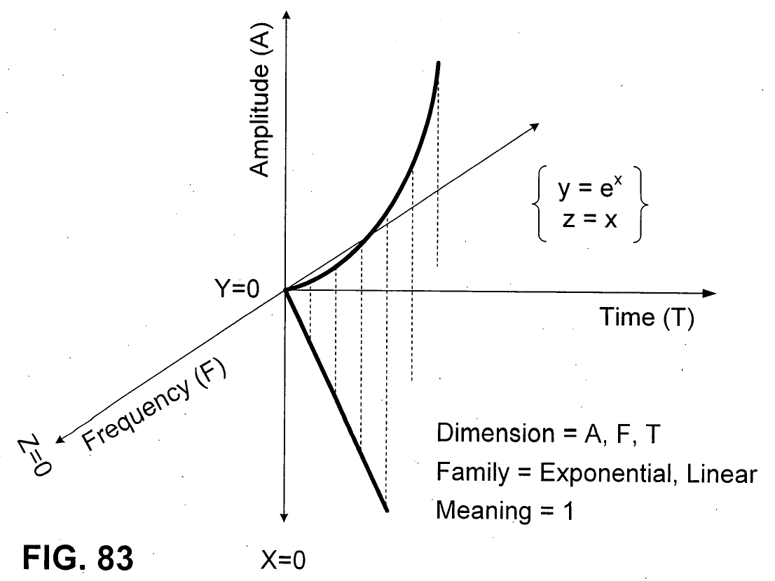

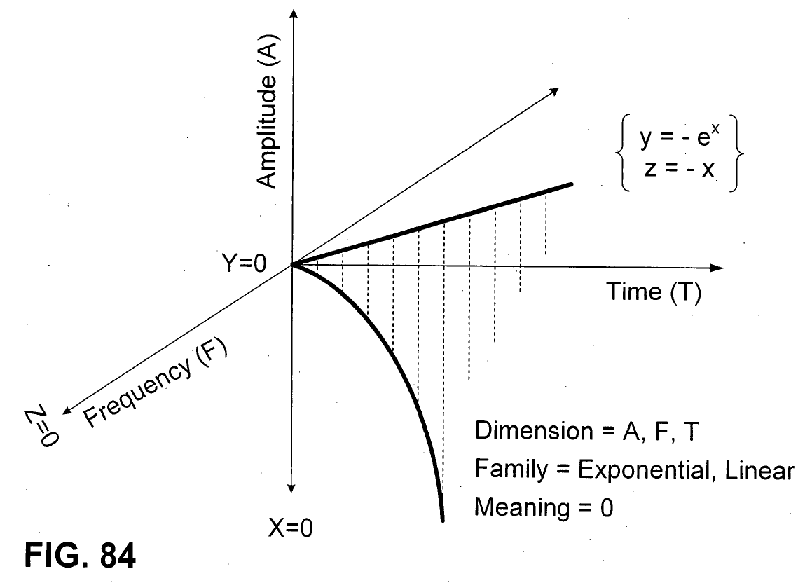

FIGS. 83 and 84 utilize exponential and linear line segments. FIG. 83 shows a waveform that has a meaning of “one,” while FIG. 84 shows a waveform that has a meaning of “zero.”

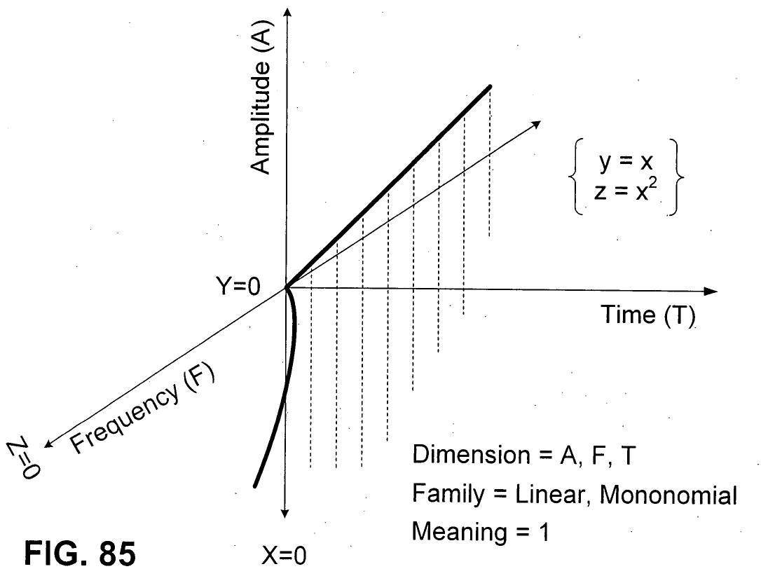

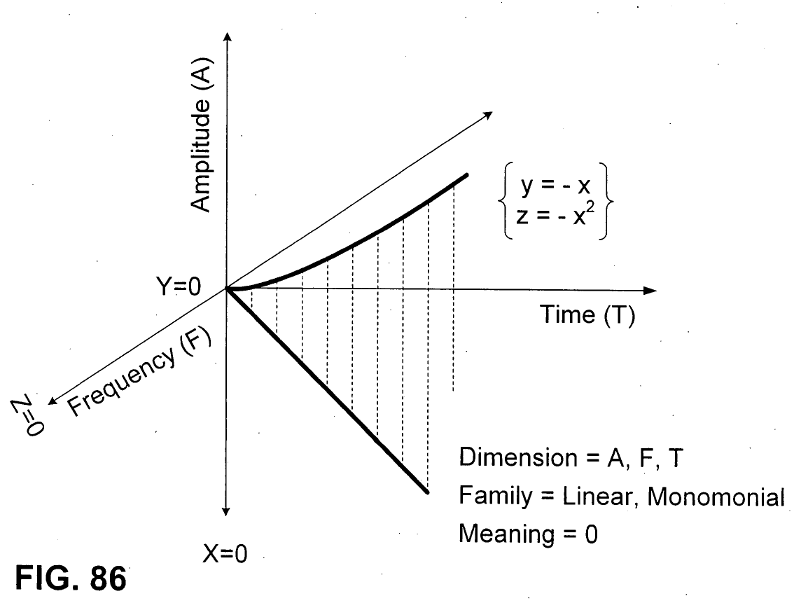

FIGS. 85 and 86 utilize linear and mononomial line segments. FIG. 85 shows a waveform that has a meaning of “one,” while FIG. 86 shows a waveform that has a meaning of “zero.”

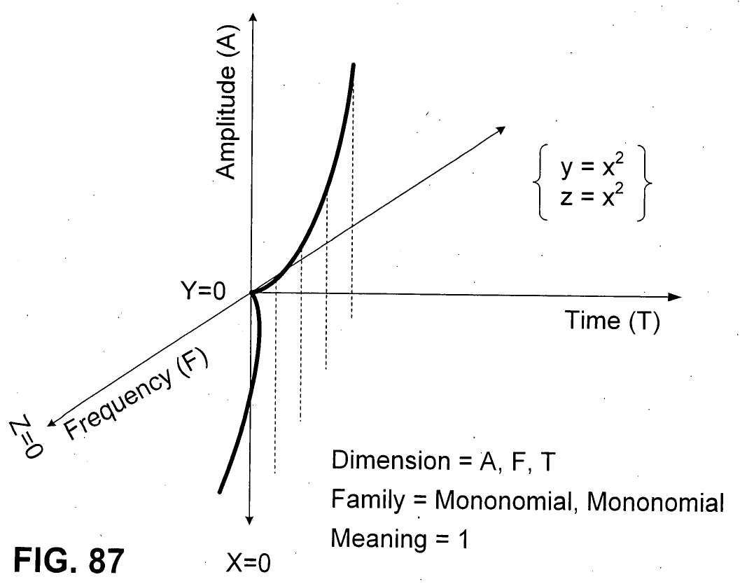

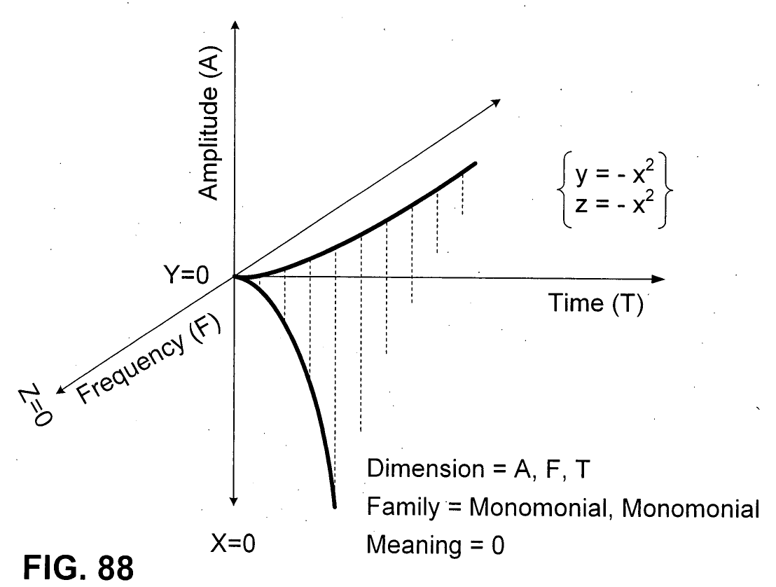

FIGS. 87 and 88 utilize mononomial and mononomial line segments. FIG. 87 shows a waveform that has a meaning of “one,” while FIG. 88 shows a waveform that has a meaning of “zero.”

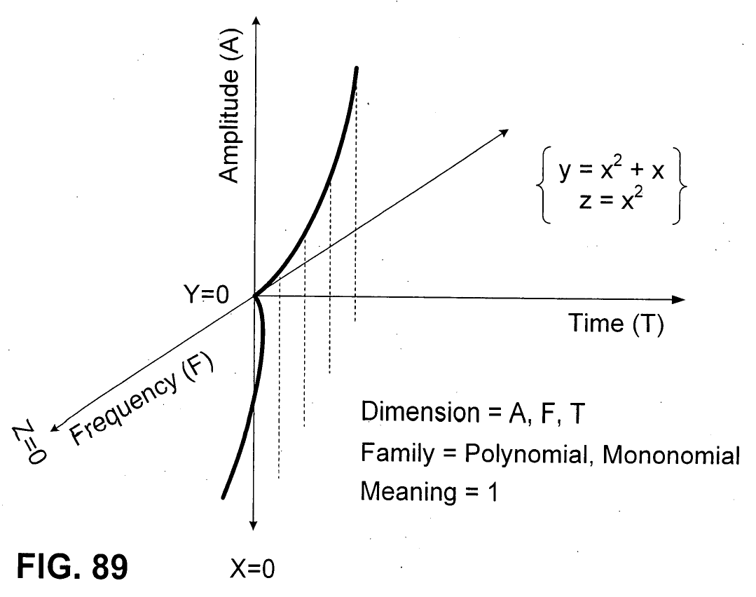

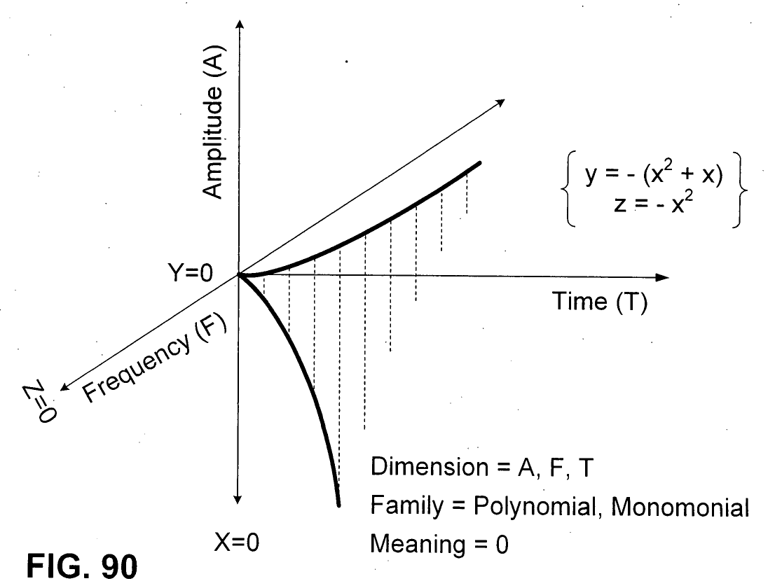

FIGS. 89 and 90 utilize polynomial and mononomial line segments. FIG. 89 shows a waveform that has a meaning of “one,” while FIG. 90 shows a waveform that has a meaning of “zero.”

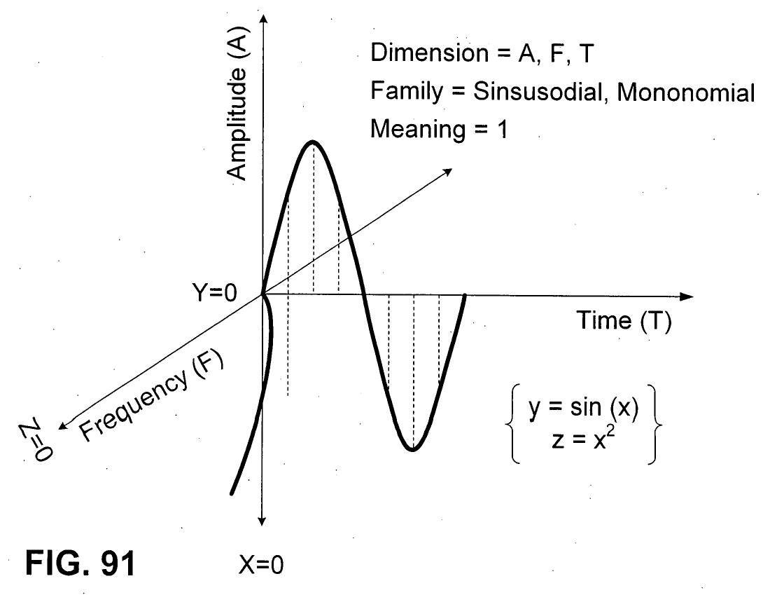

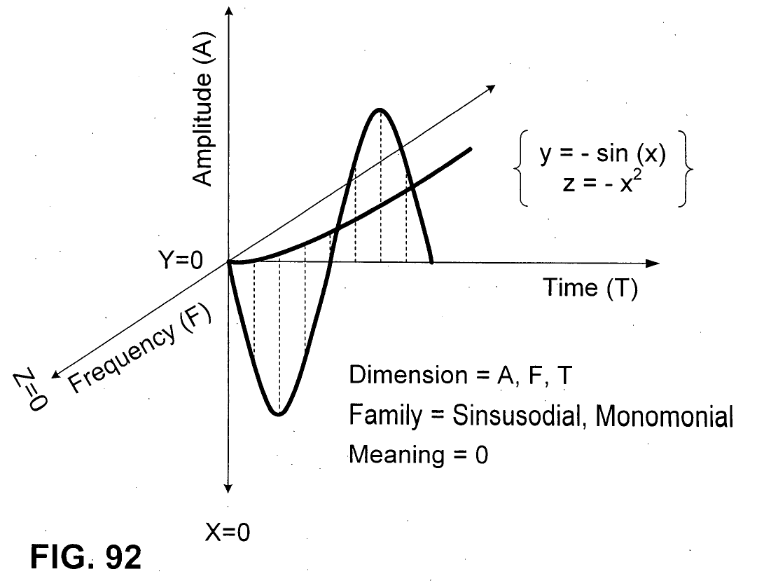

FIGS. 91 and 92 utilize sinusoidal and mononomial line segments. FIG. 91 shows a waveform that has a meaning of “one,” while FIG. 92 shows a waveform that has a meaning of “zero.”

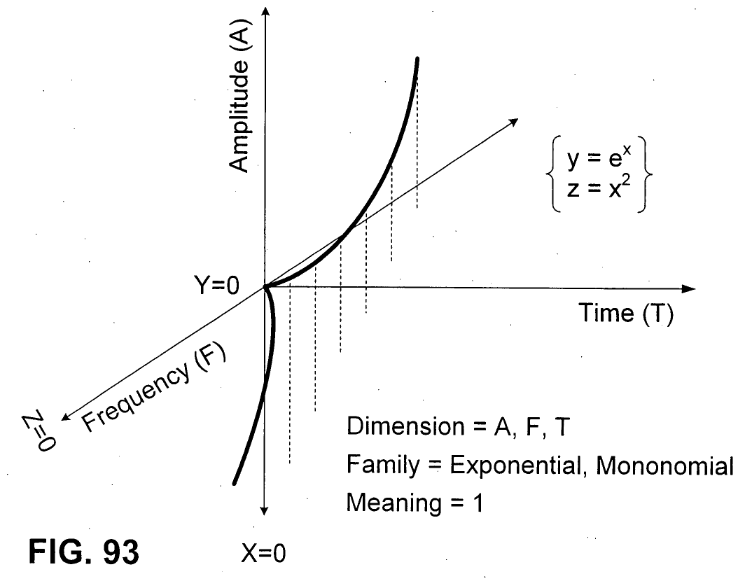

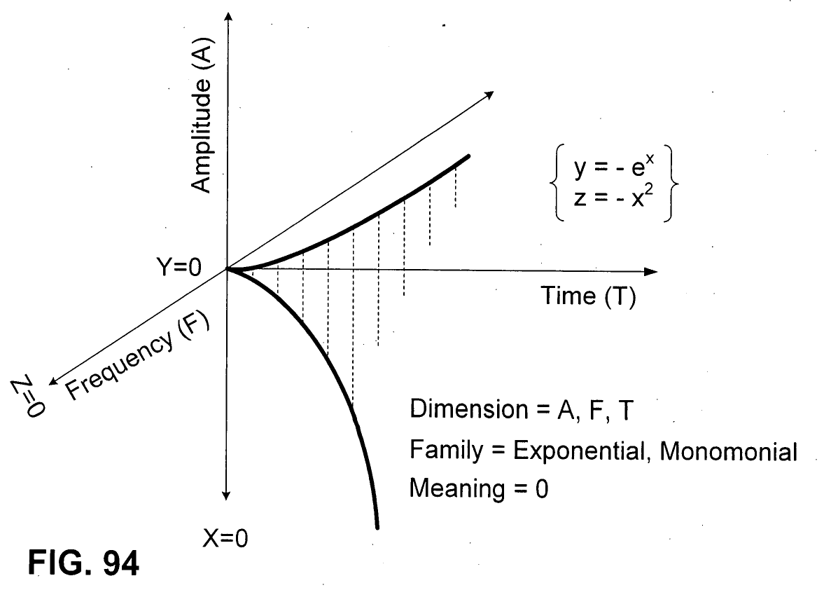

FIGS. 93 and 94 utilize exponential and mononomial line segments. FIG. 93 shows a waveform that has a meaning of “one,” while FIG. 94 shows a waveform that has a meaning of “zero.”

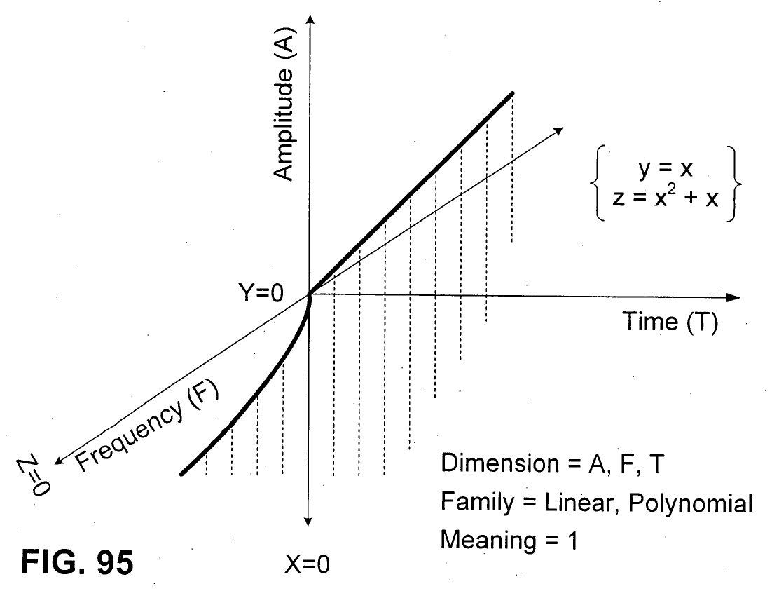

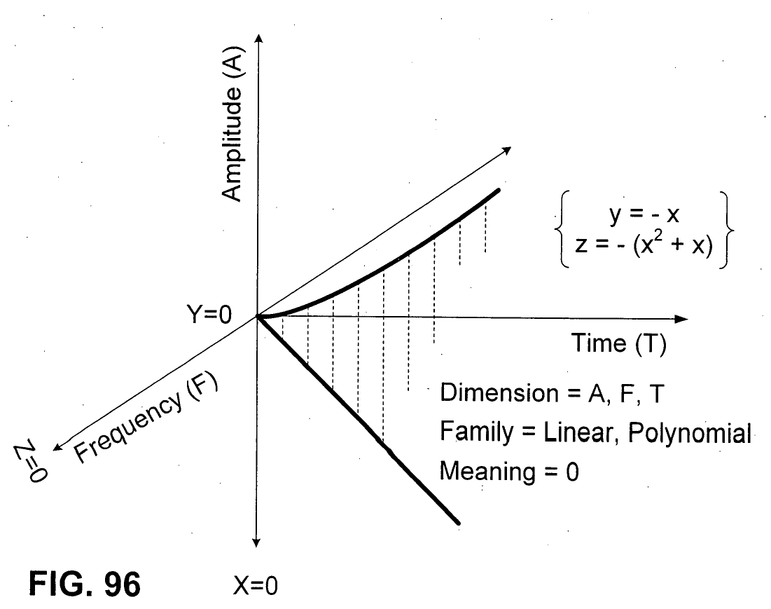

FIGS. 95 and 96 utilize linear and polynomial line segments. FIG. 95 shows a waveform that has a meaning of “one,” while FIG. 96 shows a waveform that has a meaning of “zero.”

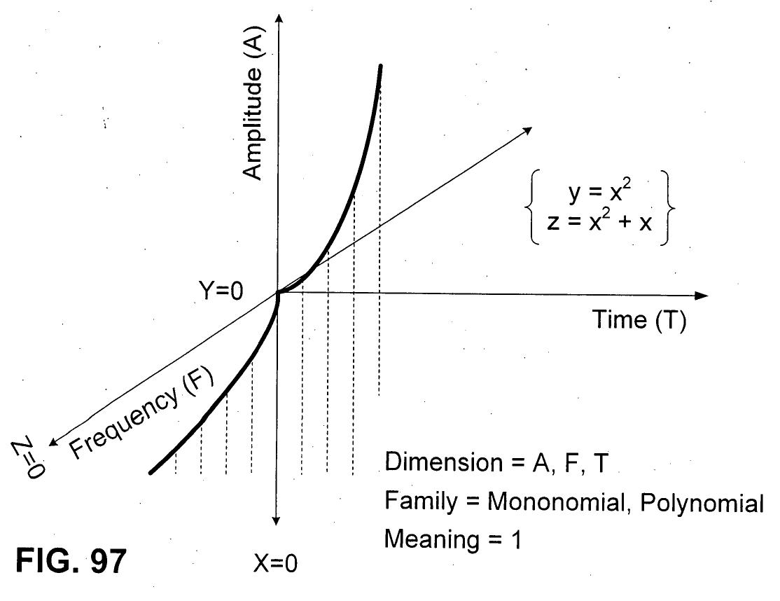

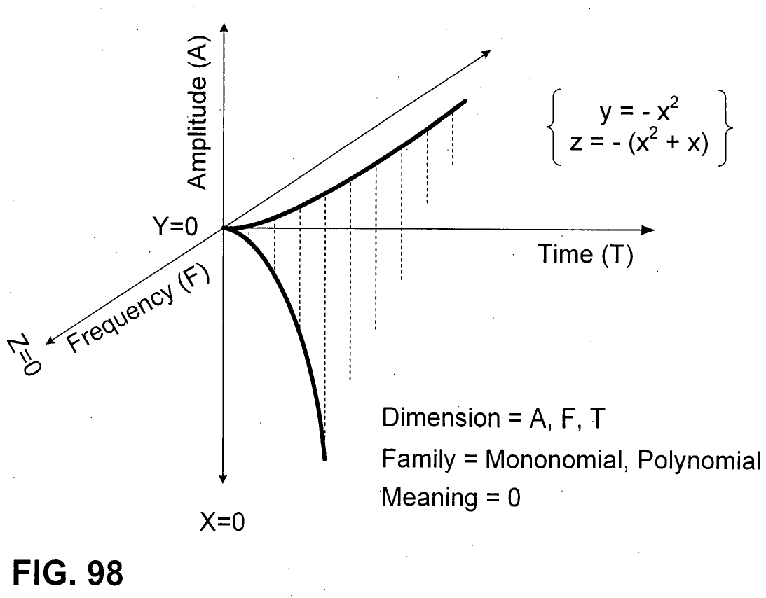

FIGS. 97 and 98 utilize mononomial and polynomial line segments. FIG. 97 shows a waveform that has a meaning of “one,” while FIG. 98 shows a waveform that has a meaning of “zero.”

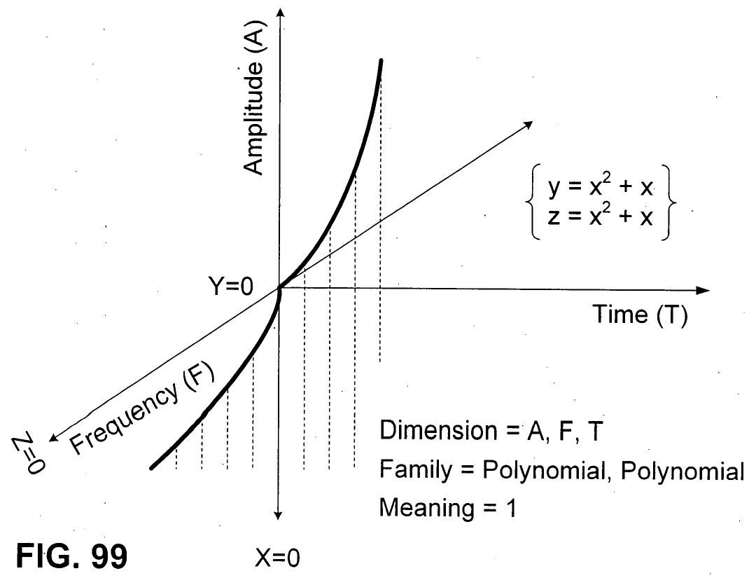

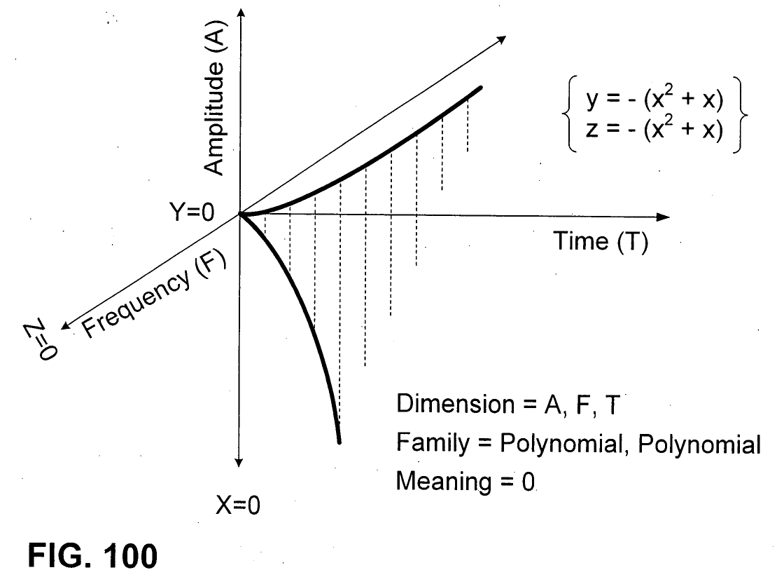

FIGS. 99 and 100 utilize polynomial and polynomial line segments. FIG. 97 shows a waveform that has a meaning of “one,” while FIG. 98 shows a waveform that has a meaning of “zero.”

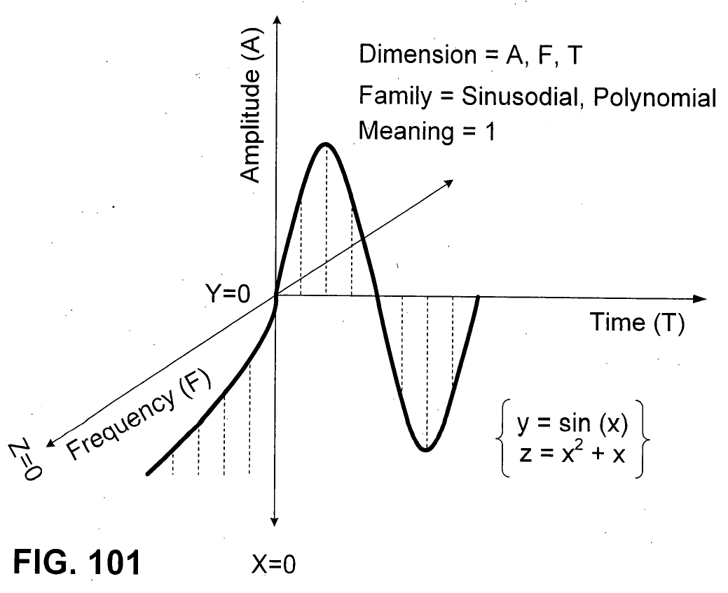

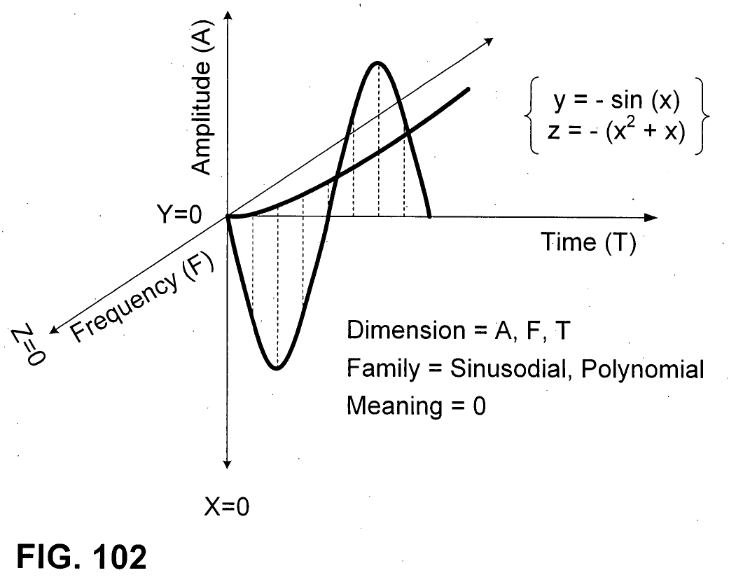

FIGS. 101 and 102 utilize sinusoidal and polynomial line segments. FIG. 101 shows a waveform that has a meaning of “one,” while FIG. 102 shows a waveform that has a meaning of “zero.”

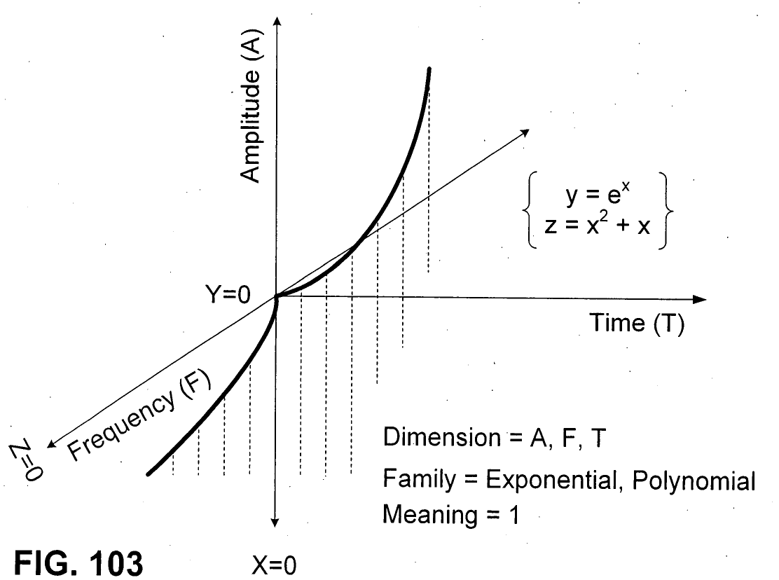

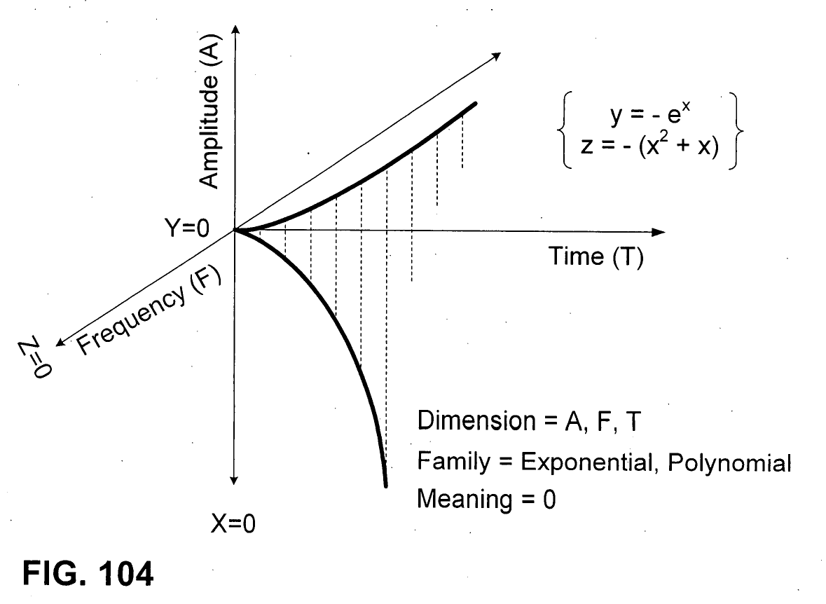

FIGS. 103 and 104 utilize exponential and polynomial line segments. FIG. 103 shows a waveform that has a meaning of “one,” while FIG. 104 shows a waveform that has a meaning of “zero.”

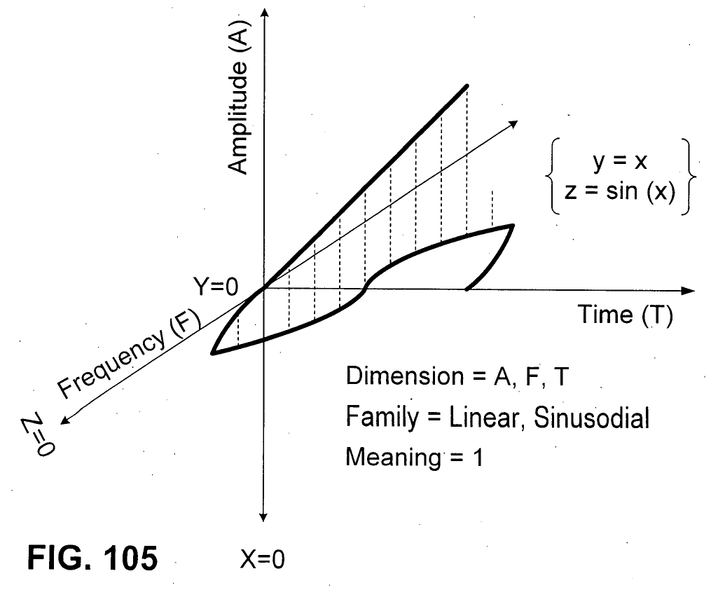

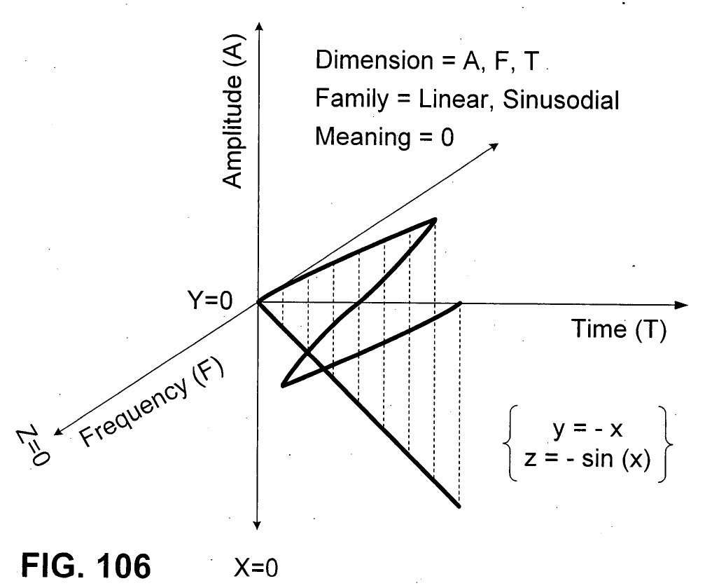

FIGS. 105 and 106 utilize linear and sinusoidal line segments. FIG. 105 shows a waveform that has a meaning of “one,” while FIG. 106 shows a waveform that has a meaning of “zero.”

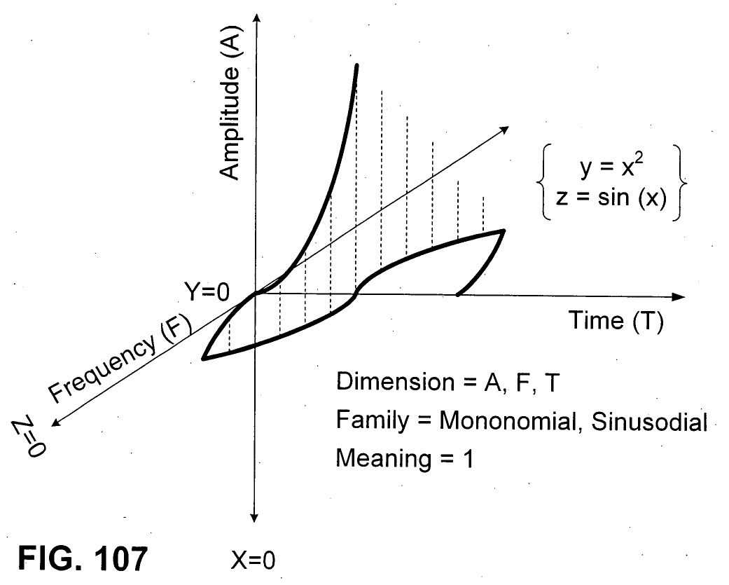

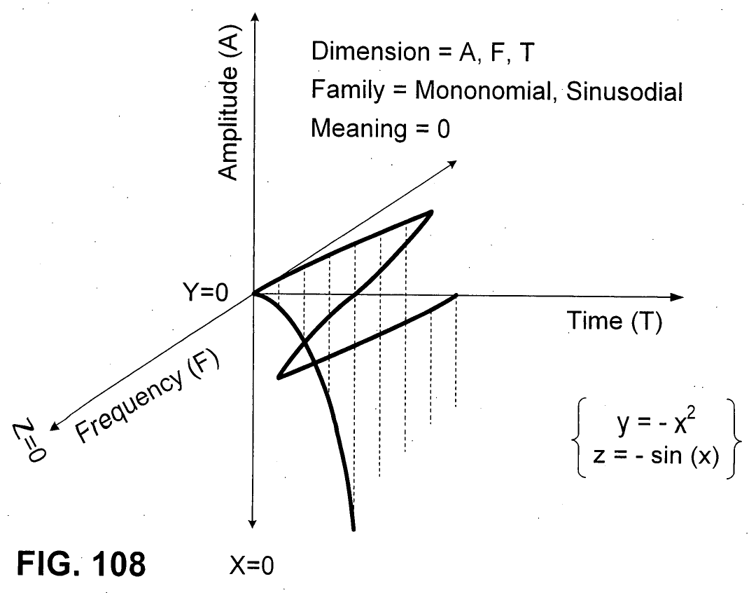

FIGS. 107 and 108 utilize mononomial and sinusoidal line segments. FIG. 107 shows a waveform that has a meaning of “one,” while FIG. 108 shows a waveform that has a meaning of “zero.”

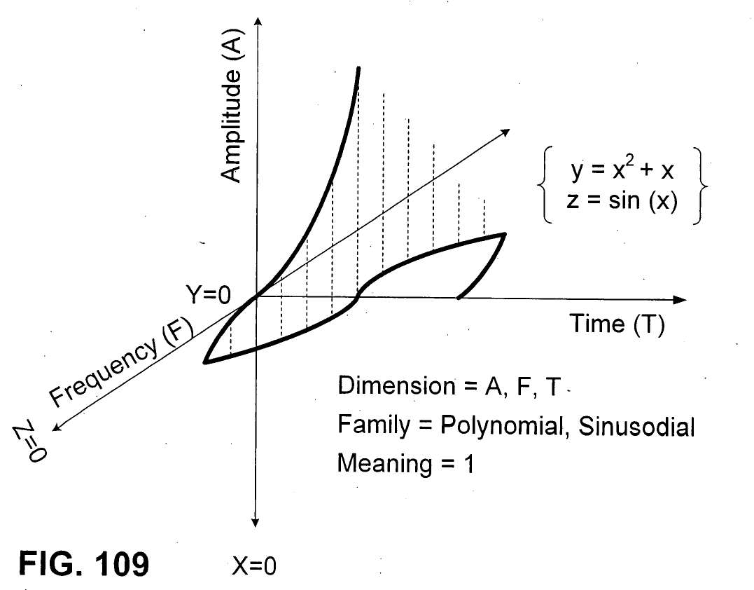

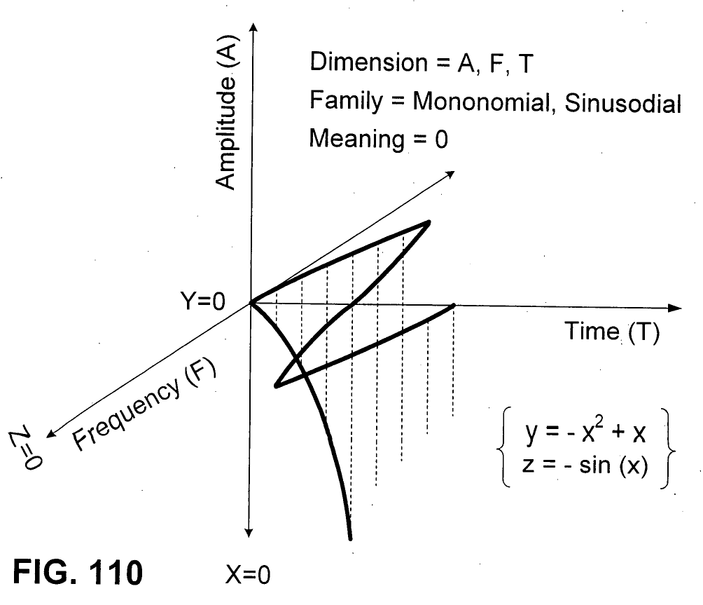

FIGS. 109 and 110 utilize polynomial and sinusoidal line segments. FIG. 109 shows a waveform that has a meaning of “one,” while FIG. 110 shows a waveform that has a meaning of “zero.”

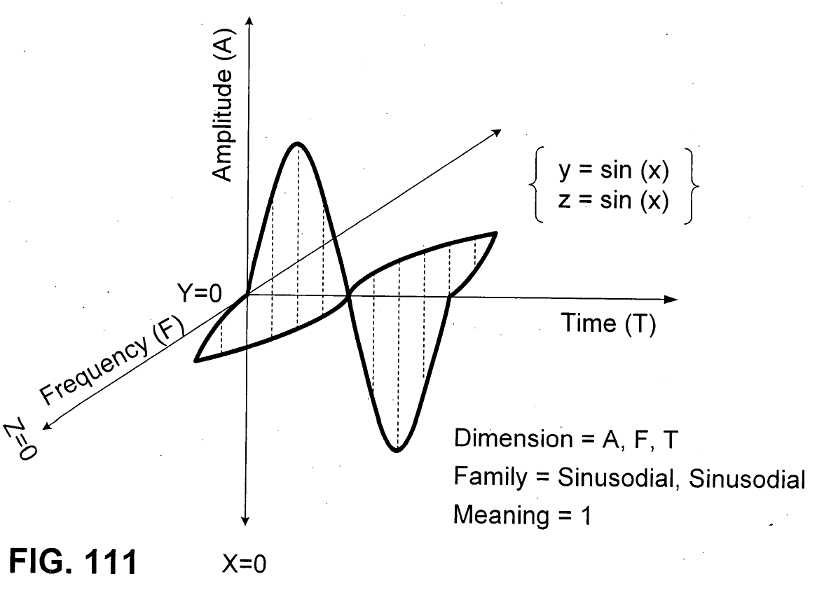

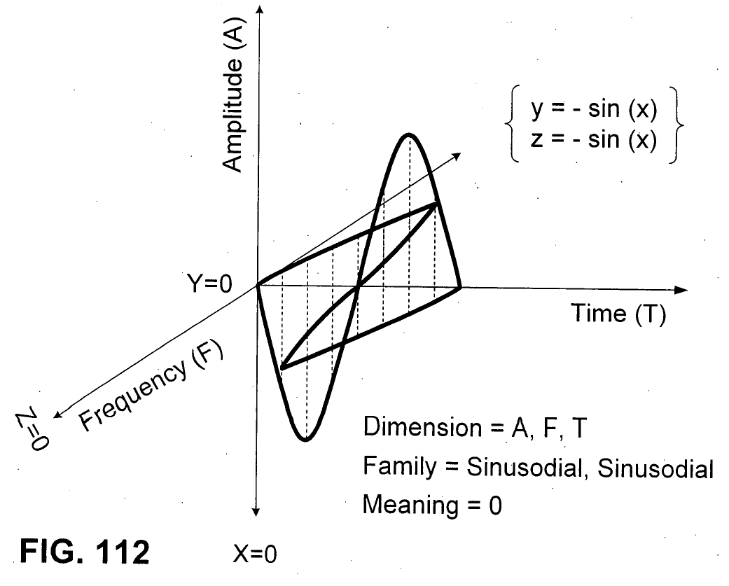

FIGS. 111 and 112 utilize sinusoidal and sinusoidal line segments. FIG. 111 shows a waveform that has a meaning of “one,” while FIG. 112 shows a waveform that has a meaning of “zero.”

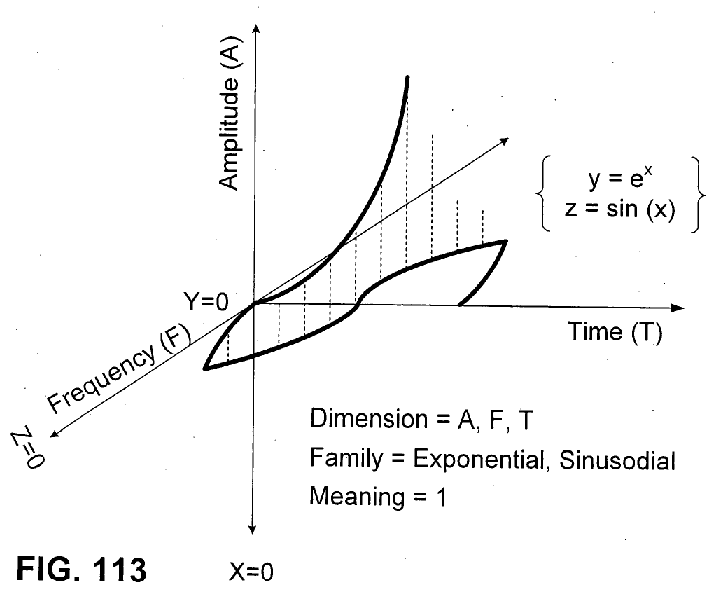

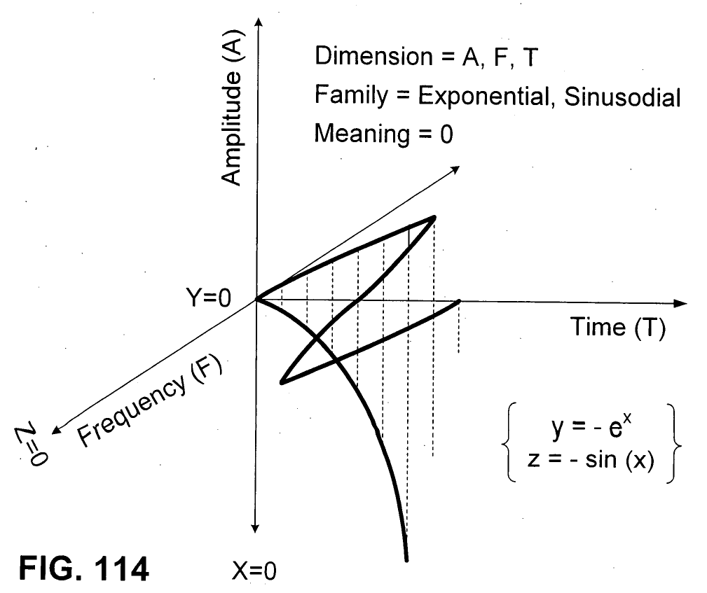

FIGS. 113 and 114 utilize exponential and sinusoidal line segments. FIG. 113 shows a waveform that has a meaning of “one,” while FIG. 114 shows a waveform that has a meaning of “zero.”

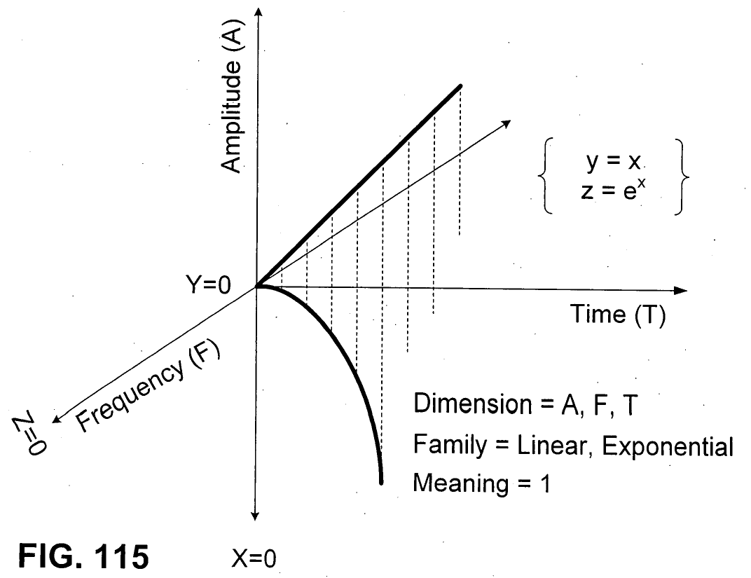

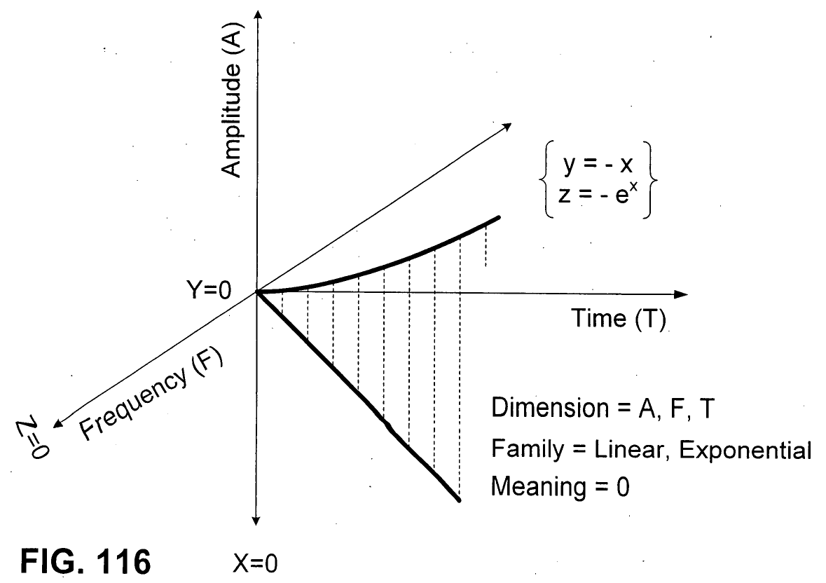

FIGS. 115 and 116 utilize linear and exponential line segments. FIG. 115 shows a waveform that has a meaning of “one,” while FIG. 116 shows a waveform that has a meaning of “zero.”

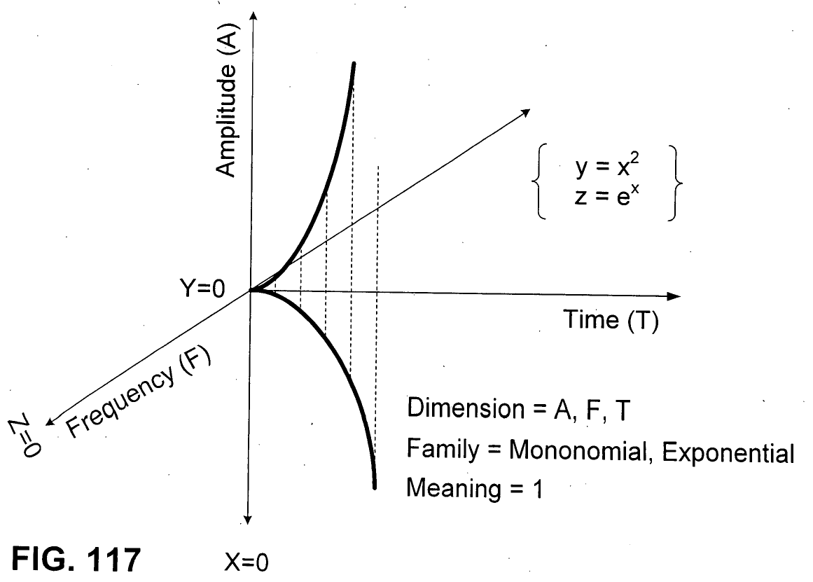

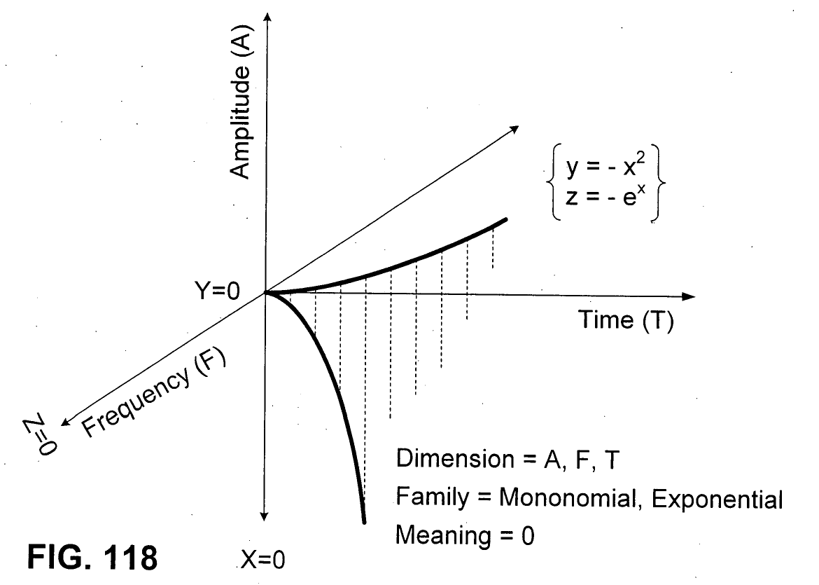

FIGS. 117 and 118 utilize mononomial and exponential line segments. FIG. 117 shows a waveform that has a meaning of “one,” while FIG. 118 shows a waveform that has a meaning of “zero.”

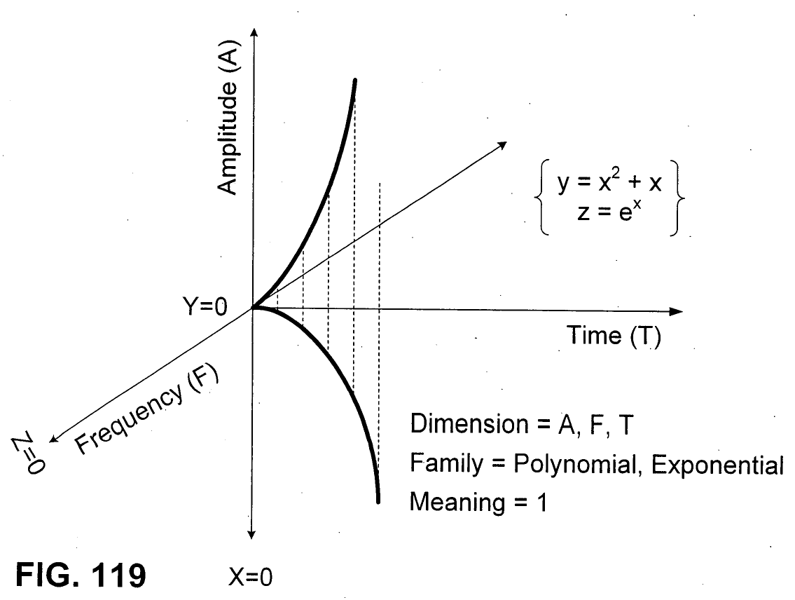

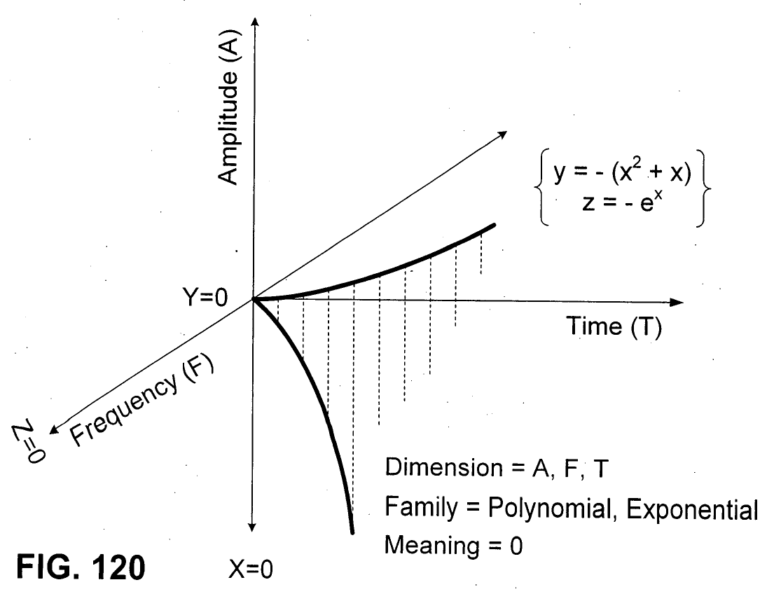

FIGS. 119 and 120 utilize polynomial and exponential line segments. FIG. 119 shows a waveform that has a meaning of “one,” while FIG. 120 shows a waveform that has a meaning of “zero.”

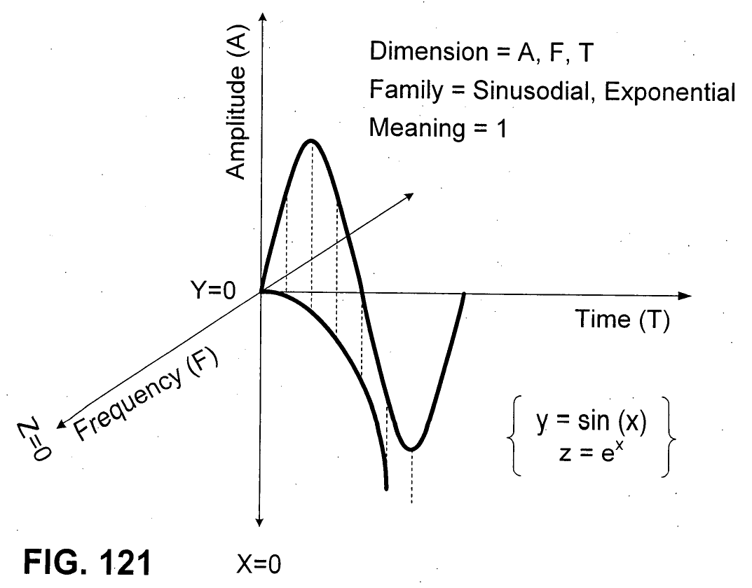

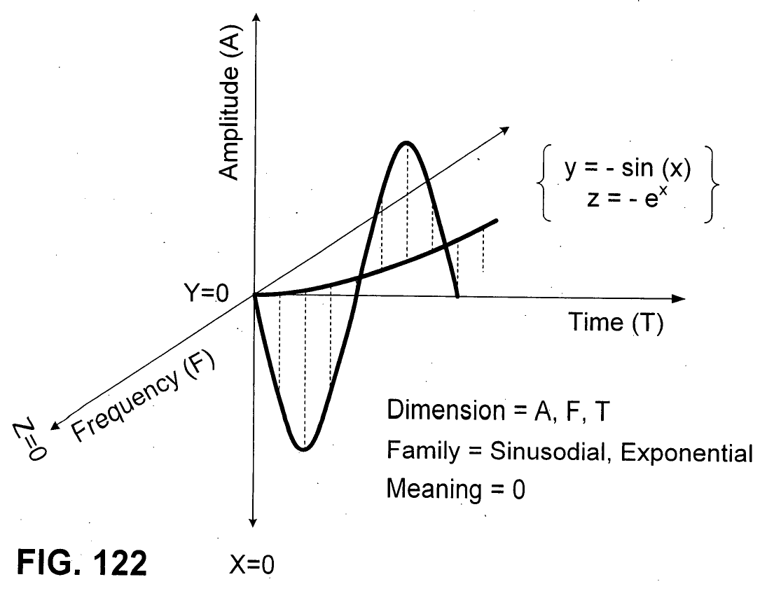

FIGS. 121 and 122 utilize sinusoidal and exponential line segments. FIG. 121 shows a waveform that has a meaning of “one,” while FIG. 122 shows a waveform that has a meaning of “zero.”

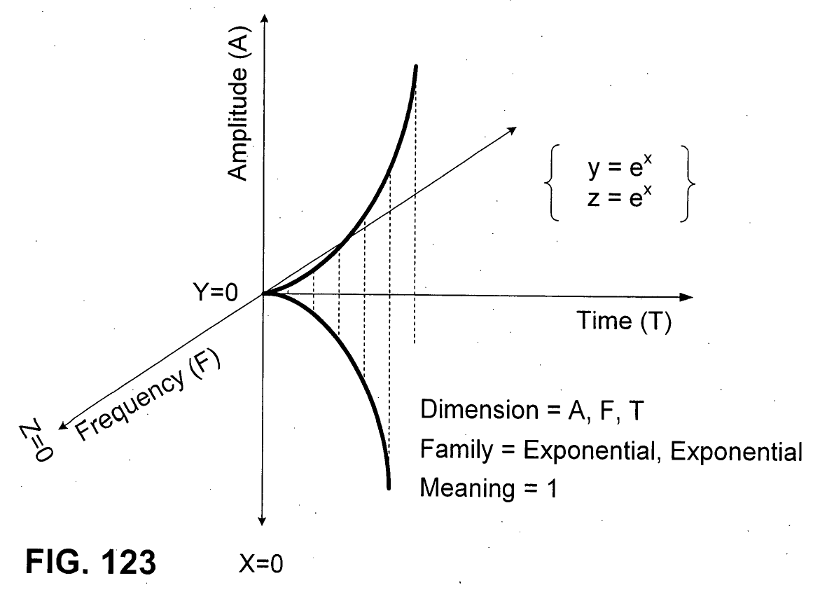

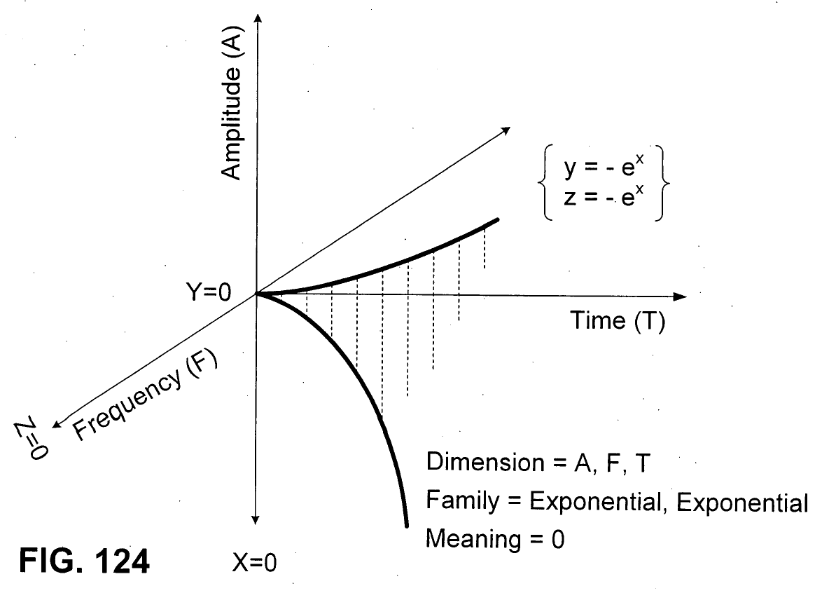

FIGS. 123 and 124 utilize exponential and exponential line segments. FIG. 123 shows a waveform that has a meaning of “one,” while FIG. 124 shows a waveform that has a meaning of “zero.”

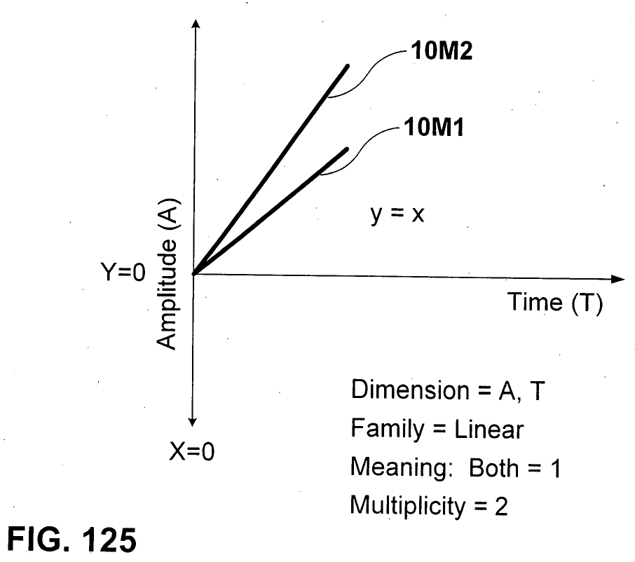

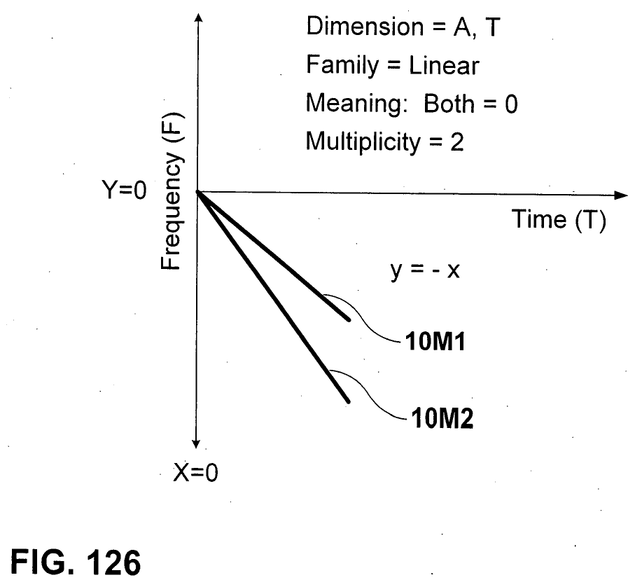

FIGS. 125 and 126 show multiple line segments 10M1 and 10M2 mapped in amplitude versus time space. Both line segments originate at or generally near the origin. The invention may utilize a plurality of multiple simultaneous line segments which are propagated over the same time interval. FIG. 125 shows two waveforms that both have a meaning of “one,” while FIG. 126 shows two waveforms that both have a meaning of “zero.”

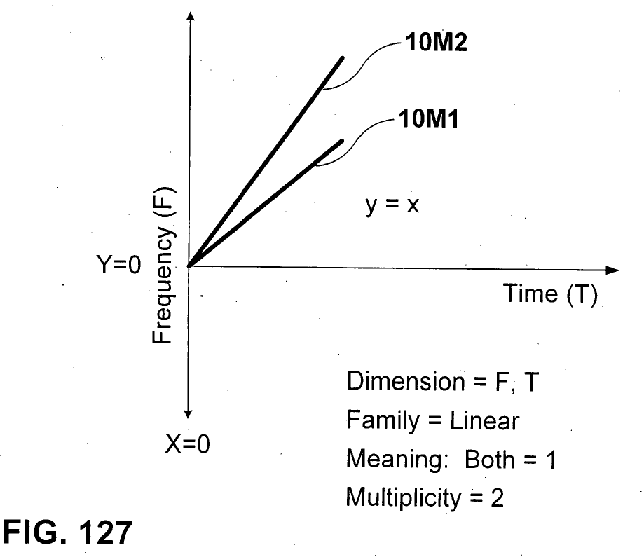

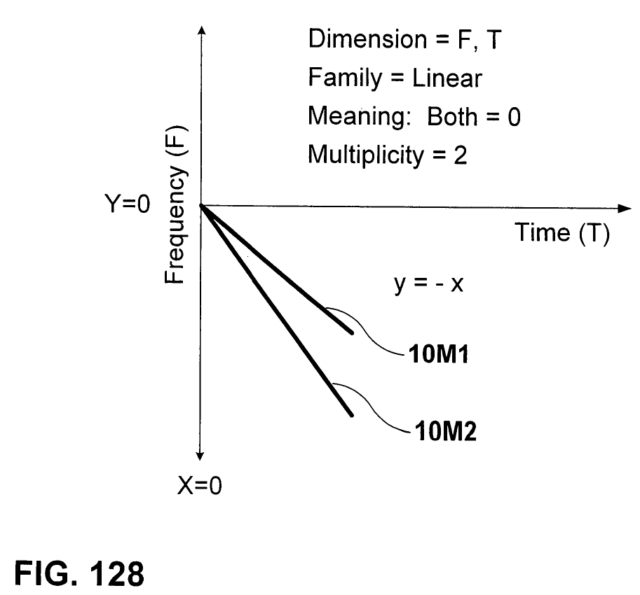

FIGS. 127 and 128 show multiple line segments mapped 10M1 and 10M2 in frequency versus time space. FIG. 127 shows two waveforms that both have a meaning of “one,” while FIG. 128 shows two waveforms that both have a meaning of “zero.”

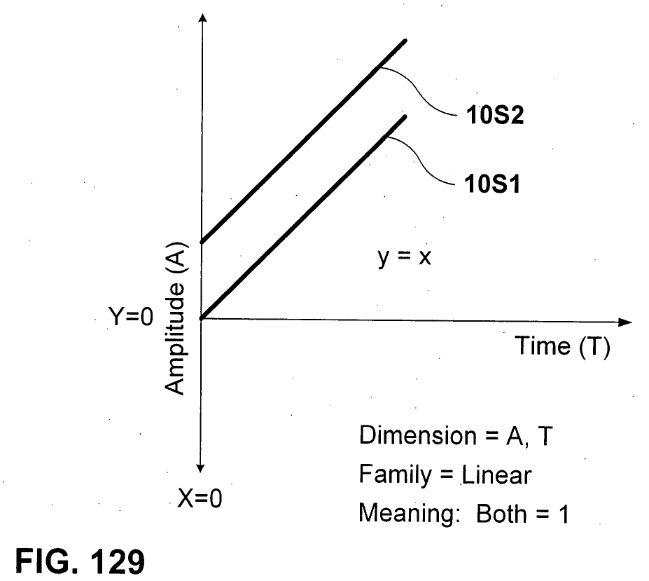

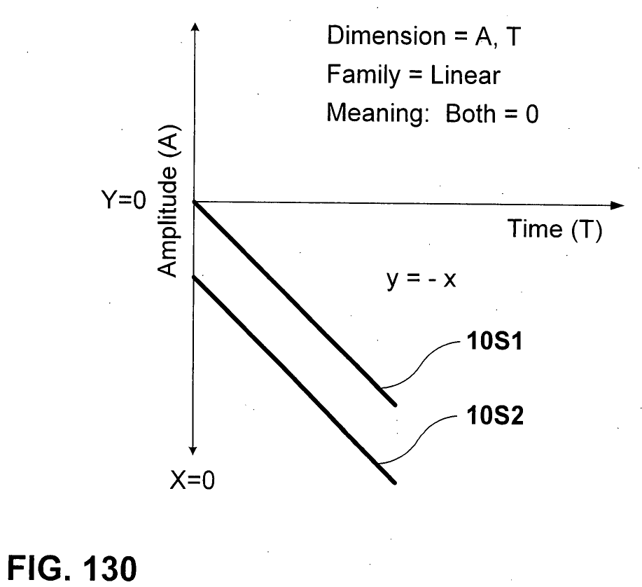

FIGS. 129 and 130 show “stacked” line segments 10S1 and 10S2 mapped in amplitude versus time space. The stacked line segments are generally propagated during the same time interval, but do not all originate at the origin. The invention may utilize a plurality of stacked line segments that are propagated during generally the same time interval. FIG. 129 shows two waveforms that both have a meaning of “one,” while FIG. 130 shows two waveforms that both have a meaning of “zero.”

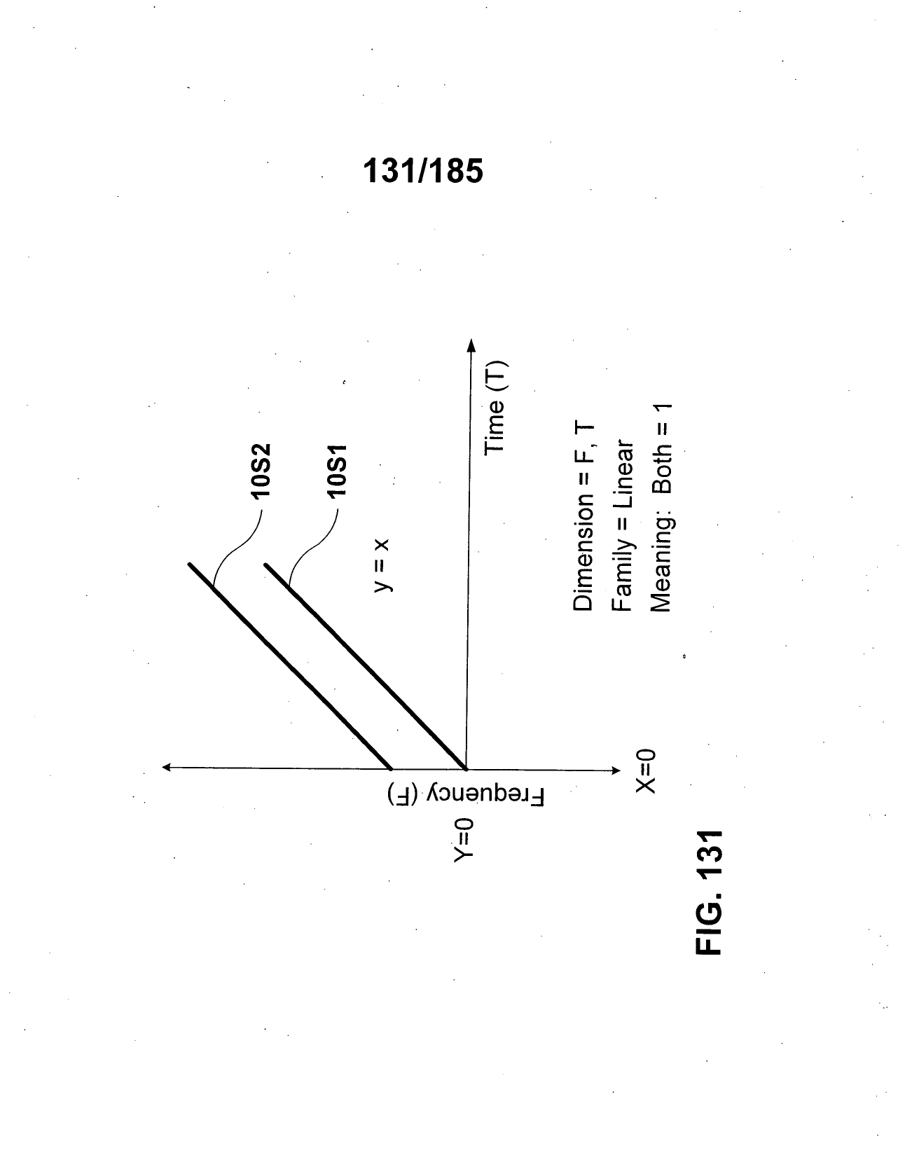

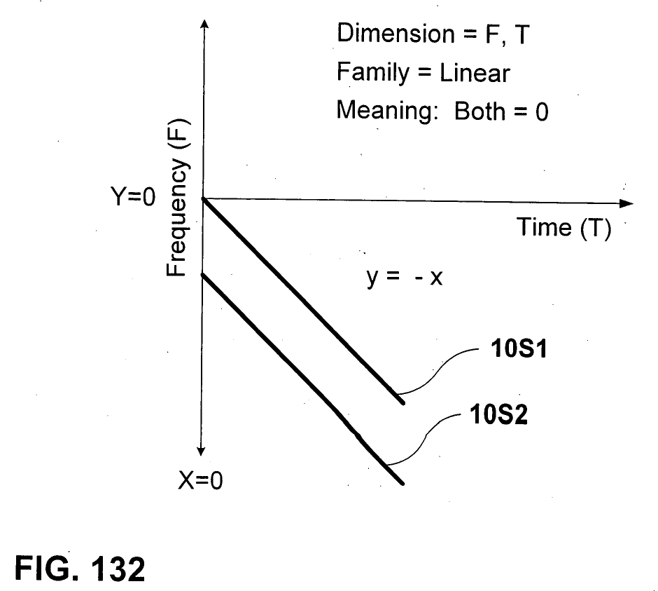

FIGS. 131 and 132 show stacked line segments 10S1 and 10S2 mapped in frequency versus time space. FIG. 131 shows two waveforms that both have a meaning of “one,” while FIG. 132 shows two waveforms that both have a meaning of “zero.”

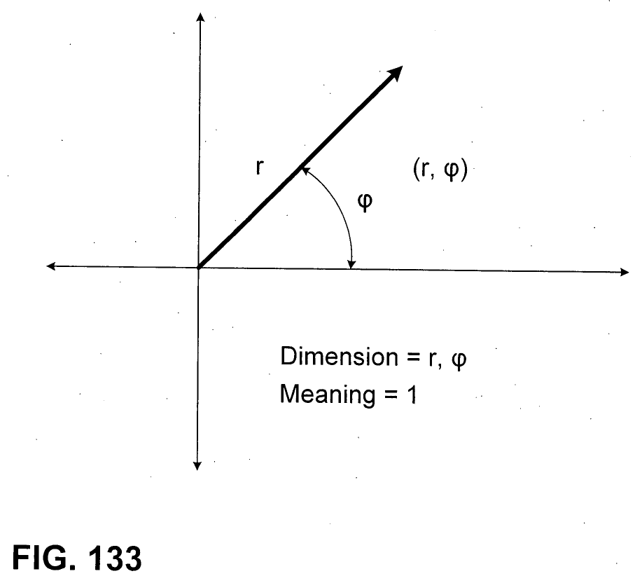

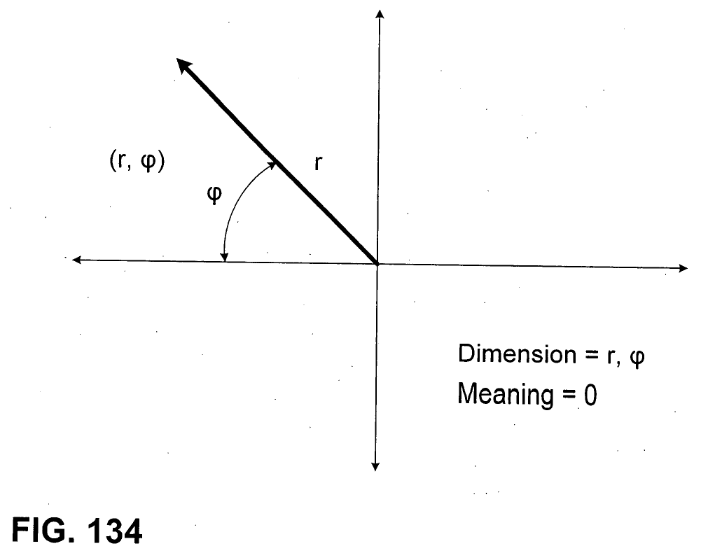

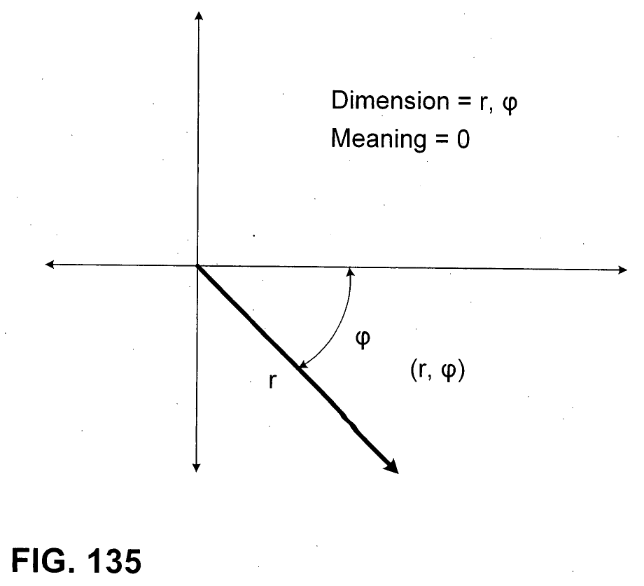

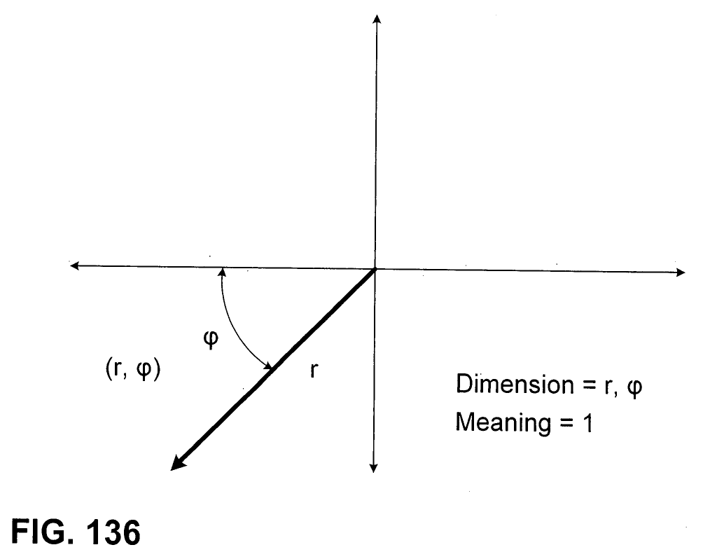

FIGS. 133 through 136 show a chirp waveform vector mapped in polar coordinate space (r,φ). FIGS. 133 and 136 show a chirp waveform vector having the meaning of “one,” while FIGS. 134 and 135 show vectors having the meaning of “zero.”

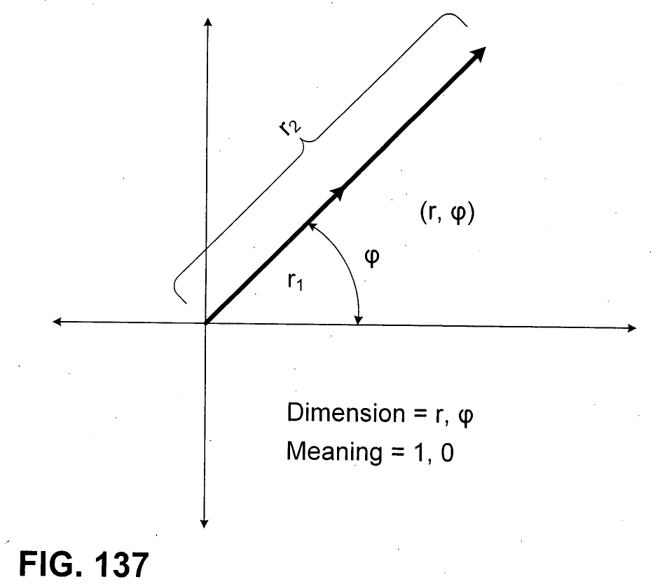

FIG. 137 shows two chirp waveform vectors mapped in polar coordinate space (r,φ) having the same φ but with r₁ having the meaning of “one” and r₂ having the meaning of “zero.”

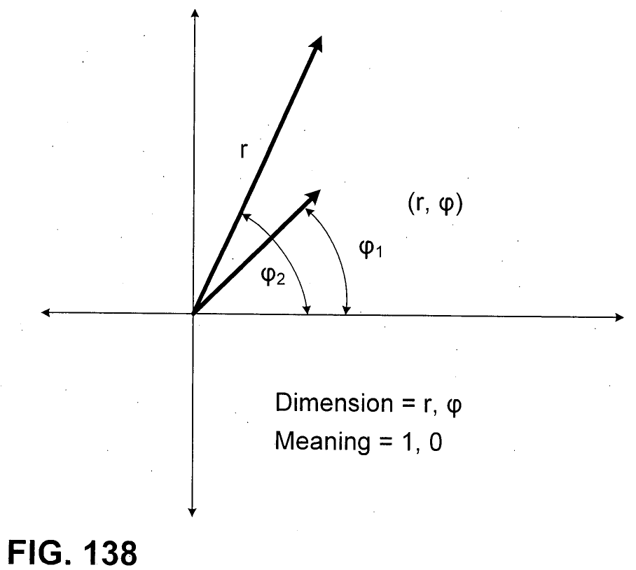

FIG. 138 shows two chirp waveform vectors mapped in polar coordinate space (r,φ) having the same r but with φ₁ having the meaning of “one” and φ₂ having the meaning of “zero.”

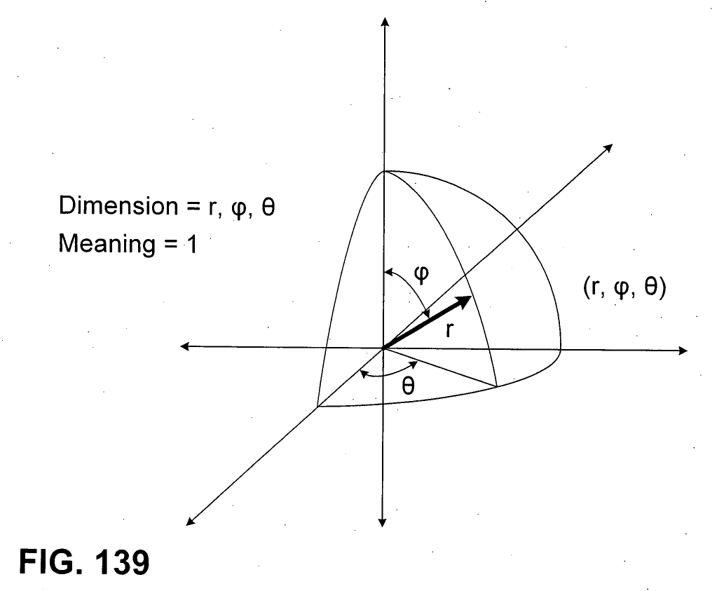

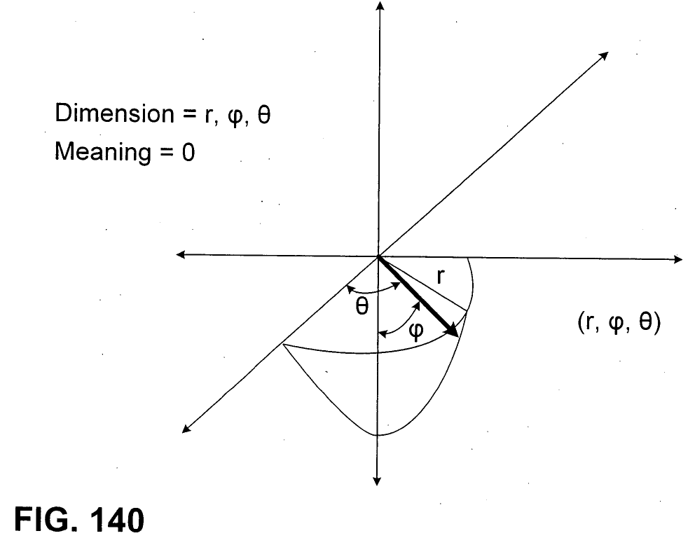

FIGS. 139 and 140 exhibit three dimensional chirp waveforms, which are mapped in spherical polar coordinates. FIG. 139 shows a waveform having a meaning of “one,” and FIG. 140 shows a waveform having a meaning of “zero.”

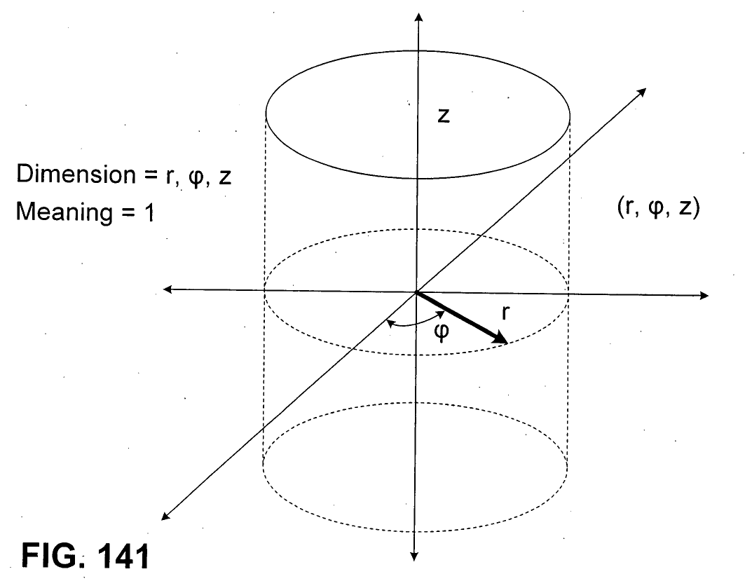

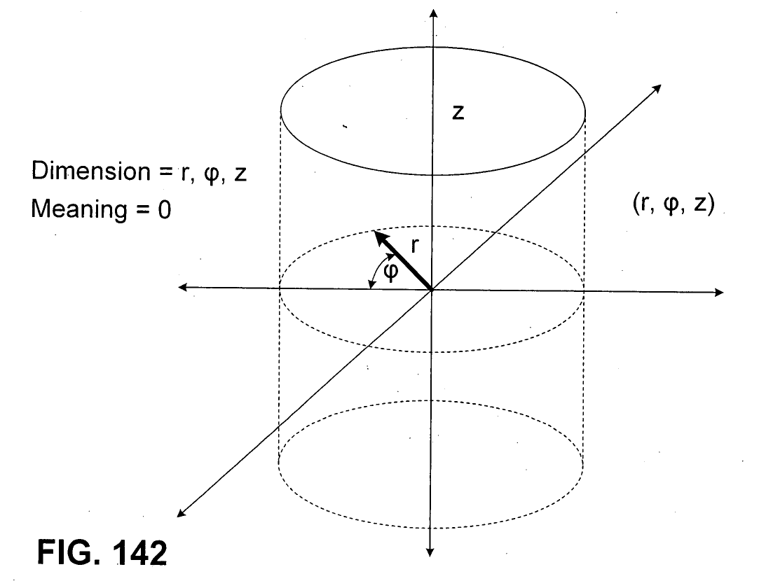

FIGS. 141 and 142 exhibit three dimensional chirp waveforms, which are mapped in cylindrical polar coordinates. FIG. 141 shows a waveform having a meaning of “one,” and FIG. 142 shows a waveform having a meaning of “zero.”

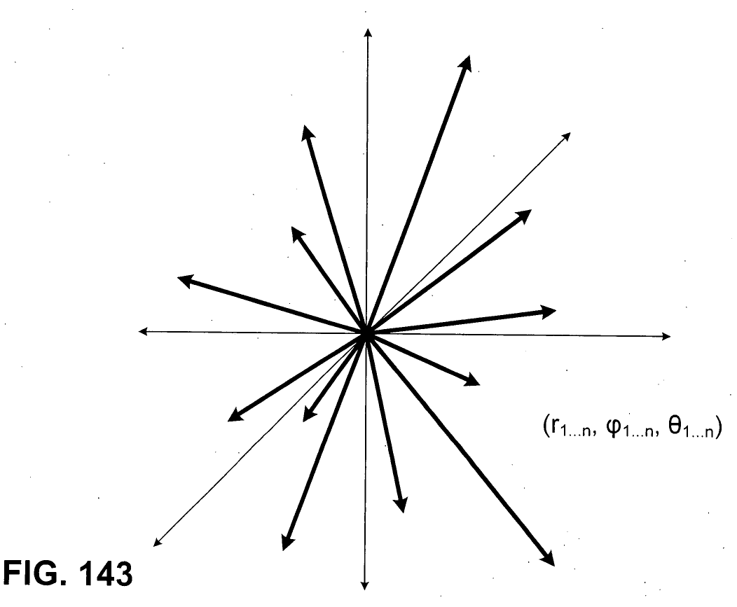

FIG. 143 exhibits multiple three dimensional chirp waveforms that are propagated over generally the same time interval, which are mapped in spherical polar coordinate space. The invention may utilize a wide variety of three or higher dimensional chirp waveforms.

IV. A Wireless Network for Conveying Chirp Waveforms

The preferred embodiment of the invention utilizes chirp waveforms in combination with a modulation scheme that eliminates discontinuities in frequency, phase and amplitude.

A specific embodiment of the invention uses linear frequency chirp waveforms because they spread the available energy as broadly and uniformly as possible in frequency. If the signal is spread uniformly over a range of frequencies, that is, there are no sharp peaks at any particular frequency in the band, then the overall signal power in the signal can be maximized without violating legal or regulatory restrictions. Linear frequency chirp waveforms accomplish this goal.

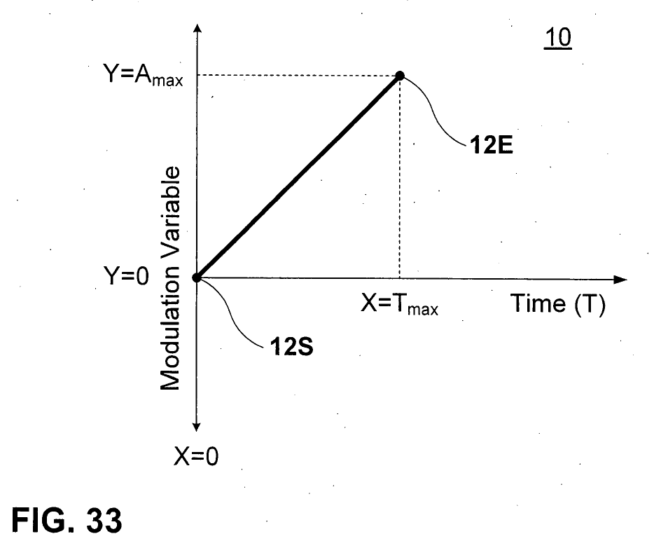

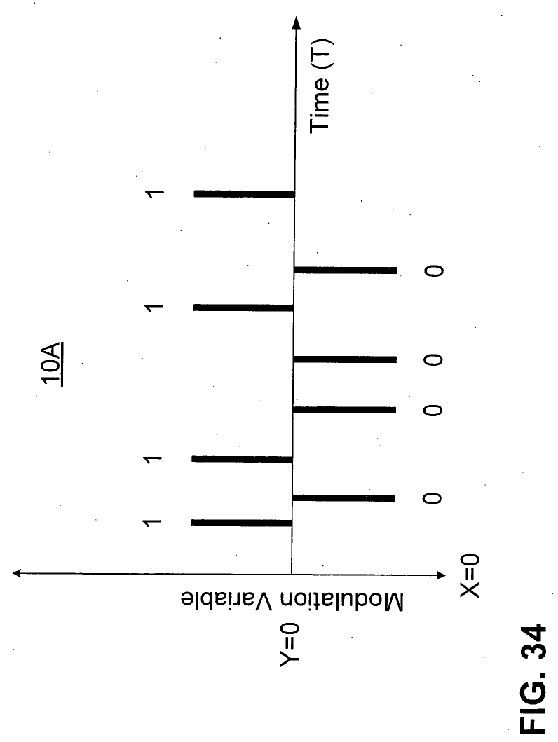

Furthermore, a study of existing digital encoding schemes reveals that every one of them encodes state changes from “zero” to “one” as discrete changes in either frequency, as in binary frequency shift keying (BFSK), or phase, as in binary phase shift keying (BPSK) and quadrature phase shift keying (QPSK), amplitude or some combination, as in quadrature amplitude modulation (QAM). Because the source digital stream is inherently discontinuous in time, the baseband signal that each of these techniques uses is also discontinuous. However, such discontinuities in frequency, phase or amplitude necessarily spread the energy over a wider range of frequencies than intended or desired. The spreading of energy into unintended sidebands forces the use of filtering techniques and acceptance of performance compromises. The use of linear frequency chirp waveforms ensures baseband signal continuity, and the resultant spectral spread of energy into sidebands is dramatically reduced. The combination of even spectral spreading of signal energy from linear frequency chirping and reduced sideband spreading from continuous baseband signaling allows the waveform to achieve higher information density, measured in bits per Hertz, than more traditional modulation techniques. FIG. 33 shows a linear frequency chirp waveform.

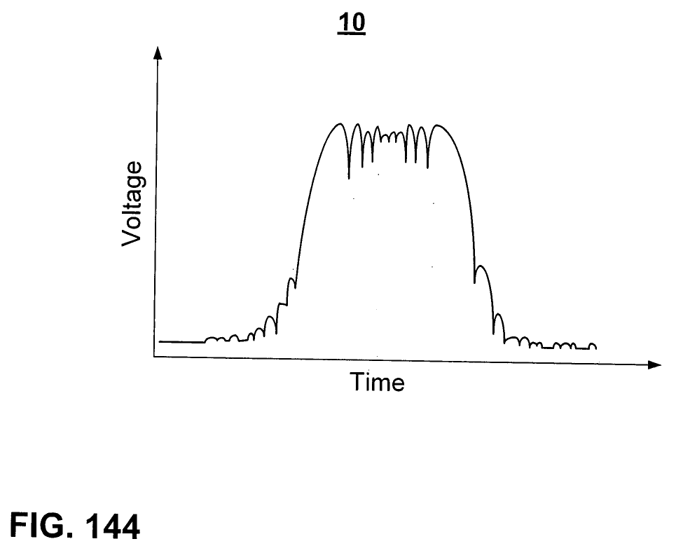

All electronic signals have a frequency distribution associated with them and a corresponding bandwidth. The use of linear frequency chirp waveforms in the present invention produces a frequency distribution that is predetermined and well known. With modern digital electronics, the frequency distribution can also be very precisely controlled such that no intermediate frequency (IF) or baseband filters are required. FIG. 144 shows a screen shot of a linear frequency chirp waveform 10 on a spectrum analyzer.

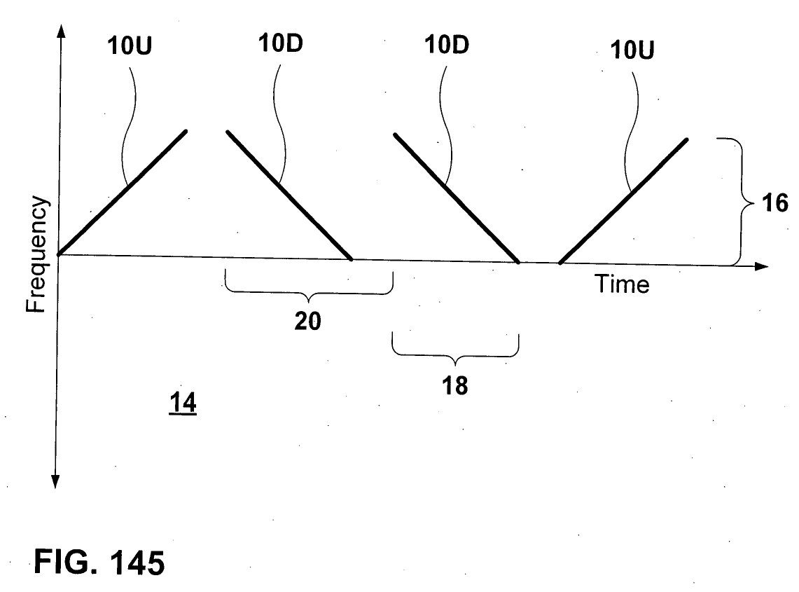

Impression of a digital structure to such a signal can be accomplished as described above by defining a binary “one” to be an up-chirp 10U and a binary “zero” to be a down-chirp 10D, or vice versa. FIG. 145 shows a progression of linear frequency up-chirps 10U and down-chirps 10D, a chirp train 14, in frequency and time space. Such a sequence would be generated by a digital data stream of “ones” and “zeros.” Note that the bandwidth of the stream of data is equal to the frequency difference 16, also known as “deviation,” of the linear frequency chirp waveform, that is, the difference in the chirp waveform boundaries 12 measured in frequency space in the instant embodiment. The chirp period 18 and the chirp interval 20 determine the throughput of a wireless communications system based upon these principles. The data rate is independent of bandwidth.

One embodiment of the invention utilizes large spacing and long pulses, and both can be shortened as the system matures and more throughput is required. In an alternative embodiment, multiple sub-bands are established and the chirps broadcast within the sub-bands.

Dead time between the chirp waveforms is not necessary, but allows such strategies as range and/or time gating at the receiver, for example, using differential Global Positioning System (GPS) for receiver location. This eliminates the multipath problem in urban environments and makes reception of weaker and/or noisier signals more reliable.

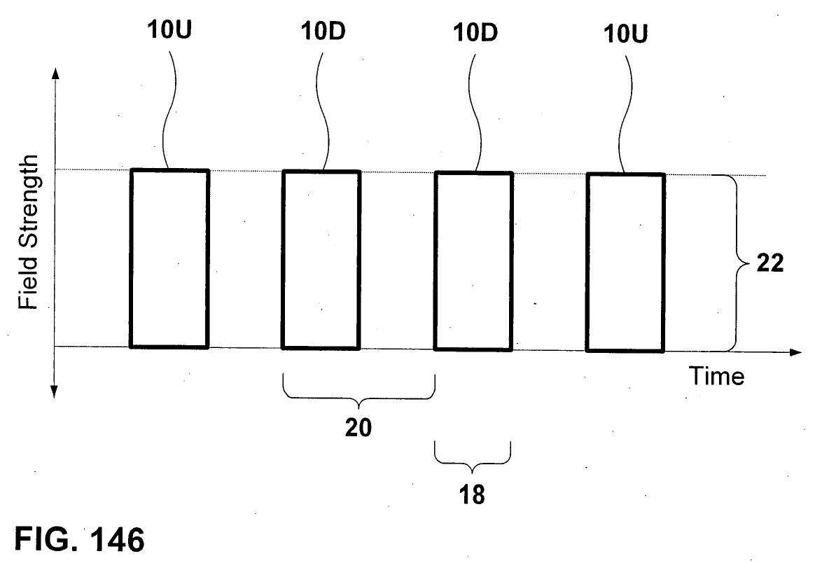

Further note that since the field strength (e_{f}) 22 is constant during the pulse as the frequency is swept through the bandwidth that the energy density is distributed uniformly throughout the band as shown in FIG. 146.

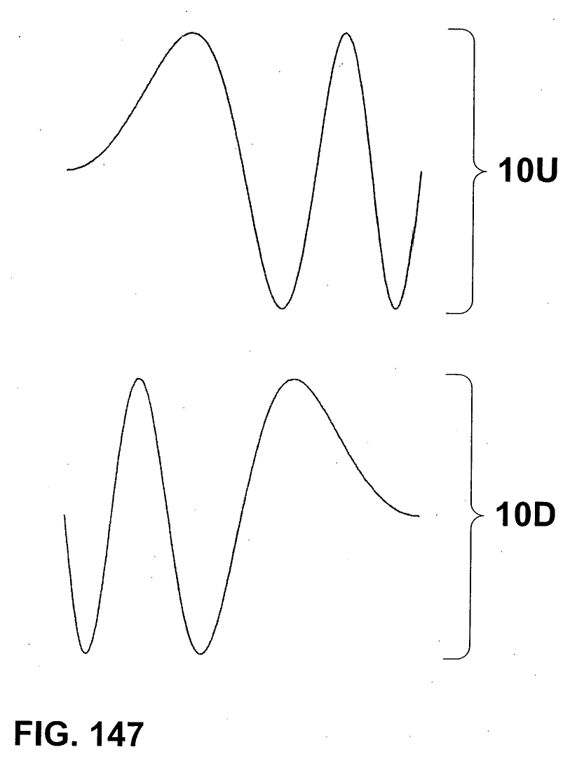

FIG. 147 shows transmitted up-chirps 10U and down-chirps 10D. Note that the interval between oscillations grows smaller with time as the frequency increases during an up-chirp 10U, the frequency is increasing, and larger for the down chirp 10D as the frequency decreases. Also note that the linear frequency chirp waveforms start and stop at zero amplitude. This minimizes the spectral spreading associated with starting and stopping the pulses.

The linear frequency chirp waveforms 10 described to this point are based on discrete discontinuous baseband signals encoded using traditional frequency modulation techniques. Modulating a discrete baseband signal requires higher performance transmitters than for continuous signals. In addition, receivers with special filtering and more complex demodulation approaches are required to detect and decode the waveform, resulting in more expensive hardware implementations.

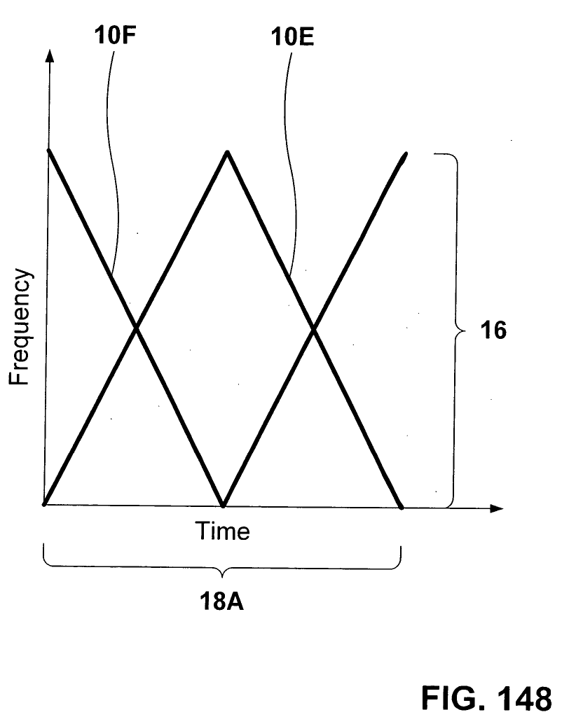

In a preferred embodiment, a continuous waveform is employed, which increases performance and reduces complexity, cost, packaging and weight. One way to create continuity is to redefine a symbol “zero” 10E in linear frequency chirp waveform terms as an up-chirp 10U immediately and continuously followed by a down-chirp 10D, and a symbol “one” 10F in linear frequency chirp waveform terms as the converse, a down-chirp 10D immediately and continuously followed by an up-chirp 10U, as shown in FIG. 148. The redefined chirp period 18A is twice the original chirp period 18.

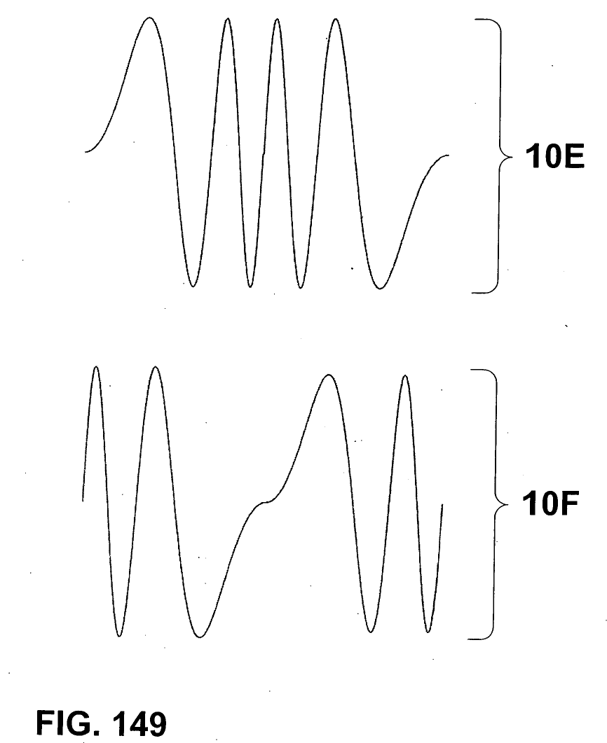

This redefinition yields significant advantages. It eliminates spectral energy spreading associated with turning transmitters and receivers on and off or with discontinuities in frequency or phase. In voltage-time space, each “one” symbol or “zero” symbol starts and stops at zero reference voltage. Successive linear frequency chirp waveforms 10, whether representing a “one” or a “zero,” are combined into a continuous wave that looks very much like a traditional frequency modulated (FM) signal. See FIG. 149. To the extent that the redefined waveform can be processed as a “traditional” FM radio signal, it may be implemented using inexpensive and commonly available electronic components.

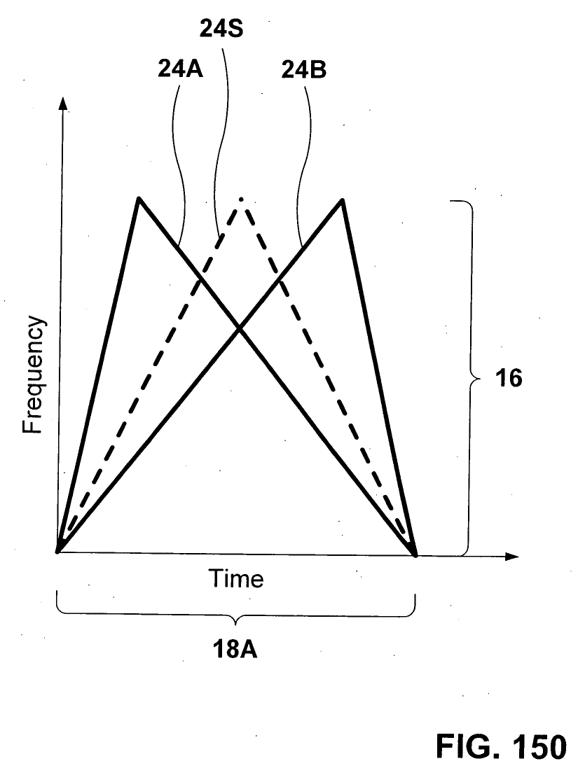

However, the positive/negative deviation technique described above has the disadvantage of using only half the deviation 16 per symbol. For long trains 14 of either “zeros” or “ones,” energy will be concentrated in the half of the band associated with that symbol. Furthermore, encoding multiple bits per linear frequency chirp waveform 10 is not easily accomplished. Given the desire to spread the energy evenly for any data content distribution, a modified encoding technique uses chirp rate, the rate of frequency change, to distinguish symbols. In this technique, a fast rise followed by a slow fall of the linear frequency chirp waveform 10 has the meaning of the symbol “zero” 24A, and a slow rise followed by a fast fall of the linear frequency chirp waveform has the meaning of the symbol “one” 24B. A symmetric rise and fall can be used to represent a synchronization 24S, no data content, symbol. This modified continuous waveform is shown in FIG. 150.

This embodiment of the linear frequency chirp waveform 10 has the following attributes:
1. It is continuous in phase and frequency, and when applied to standard FM hardware, in amplitude as well.
2. Symbols, the meanings associated with this embodiment of the linear frequency chirp waveform 10 are evenly spaced in time and self-synchronizing; a receiver needs no additional information to know when symbols start and stop.
3. Energy distribution over each linear frequency chirp waveform interval is evenly distributed across the entire frequency deviation 16 for both “ones” and “zeros.”
4. Time averaged energy distribution is nearly identical for any data content, including intervals when no data is sent, a continuous train of synchronization symbols 24S, compared to traditional waveforms that normally exhibit a power peak at the carrier frequency when data is constant or not present, limiting the allowable transmitter output power.

In this embodiment, information is essentially encoded in the total phase change from the beginning of the symbol duration 18A. Though the total phase change difference over the entire symbol interval 18A is the same for all three symbols 24A, 24S, 24B depicted in FIG. 150, there is excellent discrimination between the symbols 24 at the midpoint in the linear frequency chirp waveform. By accumulating phase change from an open integration of the time-varying frequency signal, the total phase interval over which symbols 24 can be encoded is many times the 2π range available to phase shift keying techniques such as QPSK. In effect, there is no “wrap-around” aliasing causing confusion among transmitted signals. This, in turn, results in a larger dynamic range of phase values that creates the potential for more dense information packing.

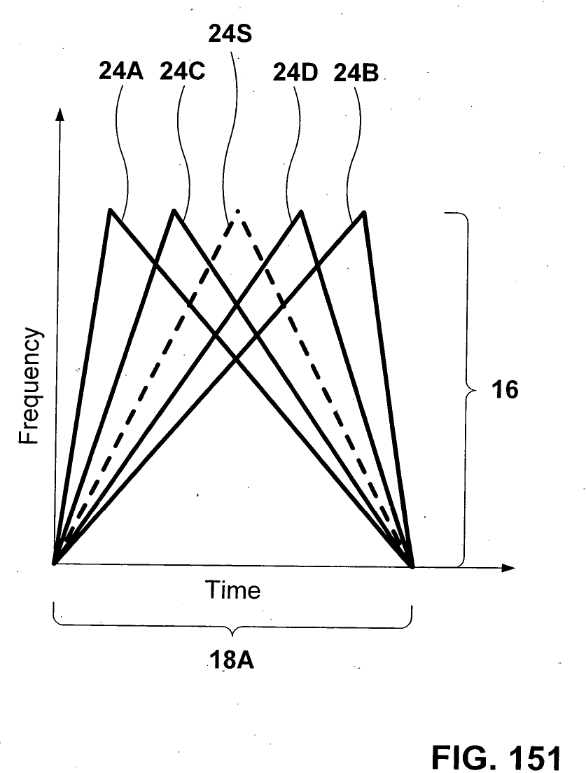

With this technique, it is possible to encode multiple bits in a single symbol 24, an up-down linear frequency chirp waveform 10 combination, by discriminating different up/down chirp slopes. By allowing multiple different peak locations, multiple bits can be encoded on the same linear frequency chirp waveform symbol 24. This technique is illustrated in FIG. 151. In FIG. 151 linear frequency chirp waveform symbol 24A has the meaning “zero zero,” linear frequency chirp waveform symbol 24C has the meaning “zero one,” linear frequency chirp waveform symbol 24D has the meaning “one zero,” and linear frequency chirp waveform symbol 24B has the meaning “one one.” FIG. 151 shows two bits encoded on a single linear frequency chirp waveform symbol 24. Following a similar technique allows encoding more than two bits per linear frequency chirp waveform symbol 24. The limit to multiple bit encoding is the ability of a receiver to identify and discriminate between the received linear frequency chirp waveform symbols 24, in other words, the ability of the receiver to tell the differences in the various slopes. Three bits per linear frequency chirp waveform symbol 24 has been demonstrated. Theoretical calculations indicate that up to eight bits per linear frequency chirp waveform symbol 24 are possible with the appropriate equipment.

The overall data rate of a particular chirp train 14 is a function of the number of bits encoded per linear frequency chirp waveform symbol 24 and the redefined chirp period 18A, or conversely the chirp rate. The overall data rate also depends upon the frequency deviation 16 required to identify and discriminate the received symbols 24.

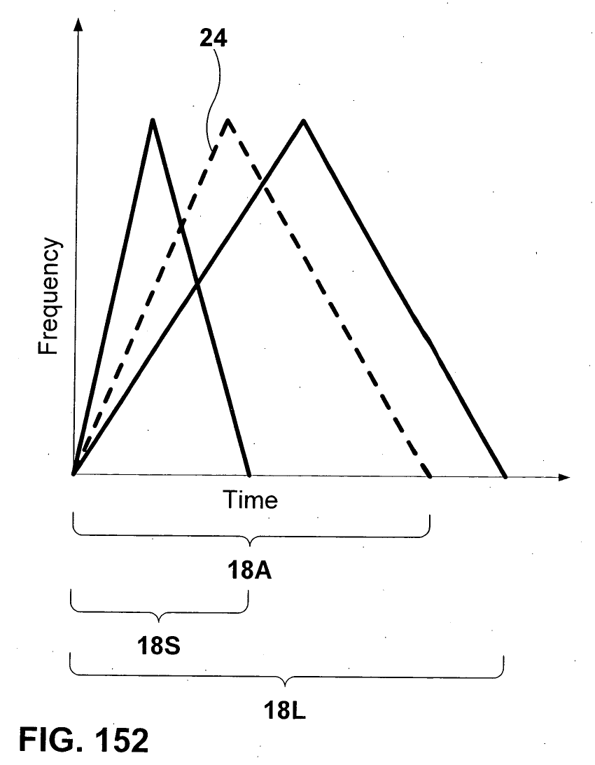

A first alternative embodiment to affect the overall data rate is to vary the symbol period 18A as shown in FIG. 152. FIG. 152 shows a symbol period 18S that is shorter than the reference symbol period 18A, that is a higher chirp rate, and a symbol period 14L that is longer than the reference symbol period 18A, that is a lower chirp rate. Combining alternative embodiments of the symbol rate within a single chirp train 14 can help discriminate between symbols 24. Such a combination requires establishing and maintaining appropriate reference clocks, and synchronizing them.

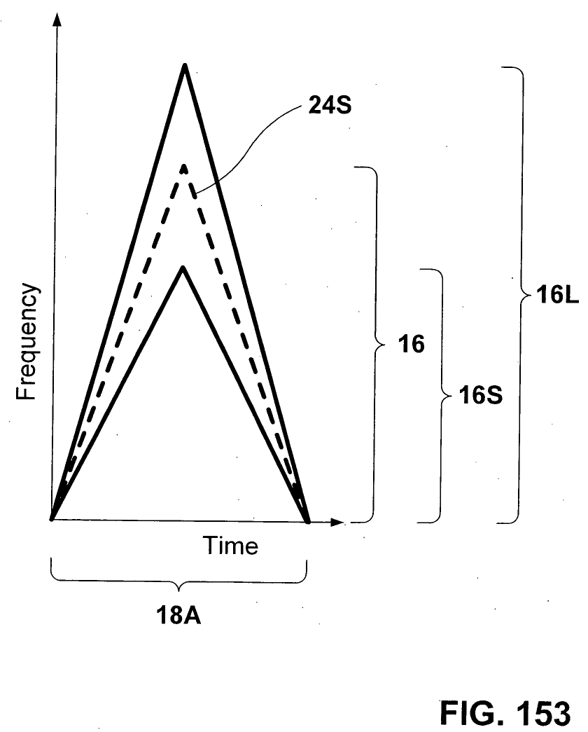

A second alternative embodiment to affect the overall data rate is to vary the frequency deviation 16 as shown in FIG. 153. FIG. 153 shows a frequency deviation 16S that is shorter than the reference frequency deviation 16, and a frequency deviation 16L that is longer than the reference frequency deviation 16. Being able to vary the frequency deviation 16 offers significant advantages in symbol 24 discrimination, one approach being to use a shorter frequency deviation 16S for lower rate data and a longer frequency deviation 16L for higher rate data. Varying the frequency deviation 16 rather than the symbol period 14A has the implementation advantage of having a single reference clock for establishing and maintaining chirp rate, as well as for chirp synchronization.

An alternative embodiment combines variations in symbol period 18A with variations in frequency deviation 16.

V. Network Architecture

The design principles of traditional wireless communications networks are well established, as are their limitations. Transmission continuity and integrity is established and maintained by getting the signal from the base station AG to the user terminal AC and from the user terminal AC to the base station AG by providing signal coverage AH with adequate link margin. Constrained to a particular frequency band AE, accomplishing this can mean installing additional base stations AG, aligning base station antennas to accommodate particular transmission situations, or other techniques well known in the cellular and PCS industries.

As has been explained above, traditional wireless communications networks are deployed with fixed channels AD with fixed widths. Linear frequency chirp waveform trains 14 are not channels AD, although it may be convenient at times to think of them that way. As stated above, linear frequency chirp waveform trains 14 are defined by their frequency deviation 16 and their symbol period 18A. The number of bits encoded per symbol 24 is important for determining the data rate supported by the particular chirp train 14.

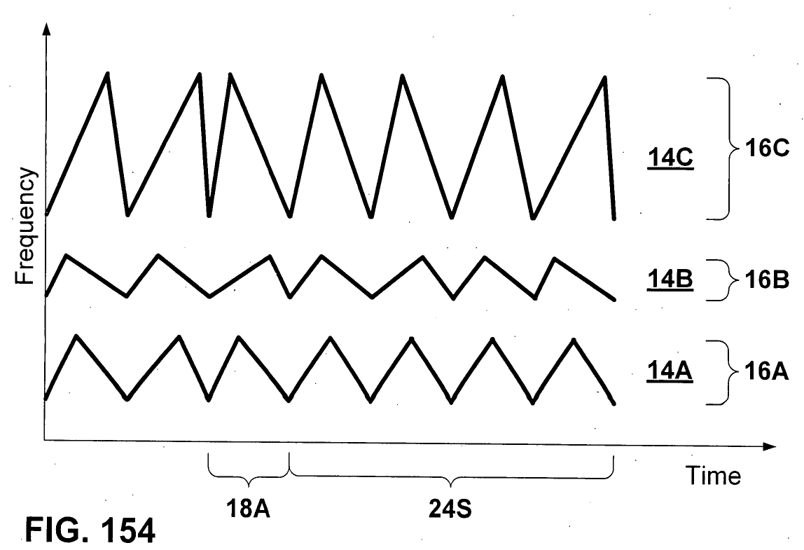

The network architecture of the disclosed invention includes multiple chirp trains 14 within any particular frequency band AE. As shown in FIG. 154, each of the linear frequency chirp waveform trains 14 can be transmitting a different data rate or the same rate. However, in the most preferred embodiment of the disclosed invention, the chirp rate is constant, that is, all chirp trains 14 have the same symbol period 18A. For example, chirp train 14A has a frequency deviation 16A and represents an intermediate data rate. Chirp train 14B has a smaller frequency deviation 16B and represents a lower data rate. Chirp train 14C has a larger frequency deviation 16C and represents a higher data rate. Note that the symbols 24S in chirp train 14A are synchronization symbols, no data is being transmitted. By changing the configuration of the chirp trains 14, the network architecture of the disclosed invention can give a particular user a linear frequency chirp waveform train 14 that meets his or her data rate requirements at any given particular time.

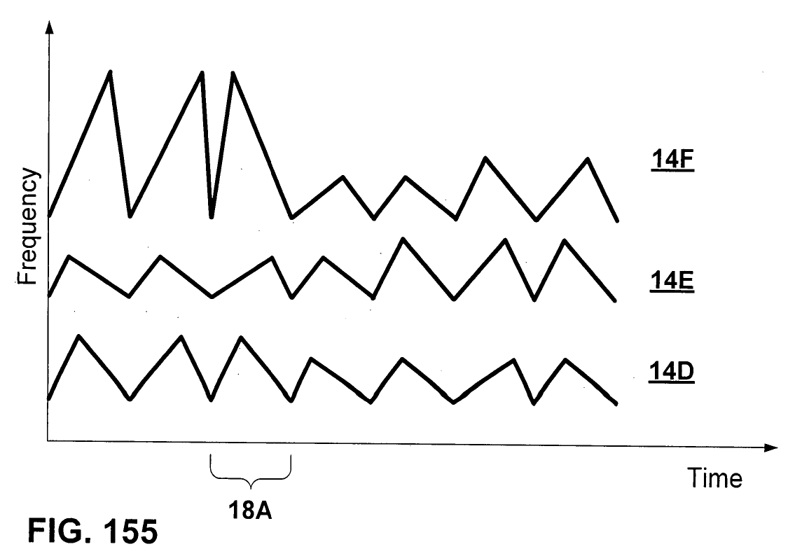

Furthermore, the data rate available to a particular user can be changed at any time, as shown in FIG. 155. Chirp train 14D starts out at an intermediate data rate but drops down to a lower rate. Chirp train 14E starts out at a low rate but increases to an intermediate rate. Chirp train 14F starts out at a high rate, drops to a low rate and then increases to an intermediate rate.

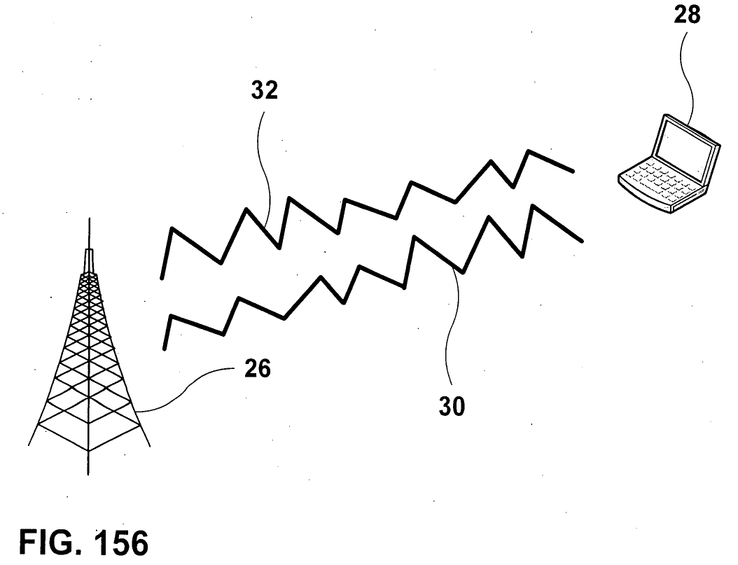

Duplex communications means that two linear frequency chirp waveform trains 14 are required, one from the base station 26 to the user's terminal 28 and one from the user's terminal 28 to the base station. See FIG. 156. Chirp train 30 is called the “forward link” or the “downlink” from the base station 26 to the user terminal, and chirp train 32 is called the “reverse link” or the “uplink” from the user terminal 28 to the base station. The chirp trains 30, 32 may be changed at any time depending upon the user's particular application, which means the data rate changes depending upon user demand. Hence the network architecture of the disclosed invention is characterized by asymmetric bandwidth.

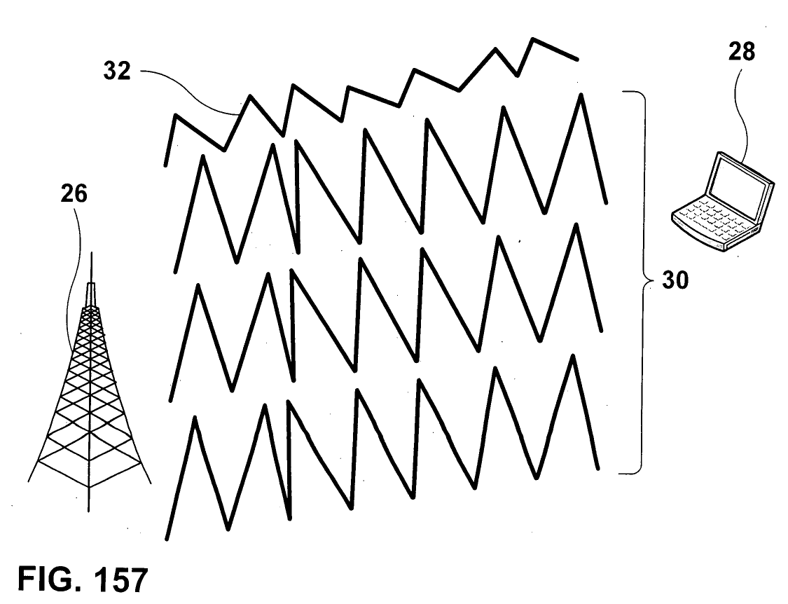

There are limits to the amount of bandwidth, that is, data rate, that can be delivered by a particular linear frequency waveform chirp train 14. The limits flow from the ability of electronic circuits to discriminate and decode the individual symbols 24. However, the network architecture of the disclosed invention enables multiple chirp trains to be allocated to a particular user's application. FIG. 157 shows three chirp trains 30 making up the forward link to a user, providing high bandwidth to the user's download application.

Linear frequency chirp waveform trains 14 have been demonstrated at 350 kilochirps per second chirp rate with a frequency deviation 16 of 2 MHz coded at four bits per linear frequency waveform chirp symbol 24. The data rate of the demonstrated chirp train 14 is 1.4 megabits per second. The three chirp trains 30 shown in FIG. 157 would therefore provide 4.2 megabits in the forward link for the user's application. It is expected that with improved electronics, the frequency deviation 16 required to deliver the 1.4 megabits per chirp train 14 will shrink to approximately 1 MHz.

As shown in FIG. 30, the 2.4 GHz ISM band comprises 100 MHz. At 2 MHz frequency deviation 16 per chirp train 14, the 2.4 GHz band can accommodate fifty chirp trains 14 at 1.4 megabits per second each; at 1 MHz frequency deviation 16 it would accommodate 100 chirp trains 14. The total bandwidth available in the 2.4 GHz band therefore ranges from 70 to 140 megabits per second with current and near future term electronics technology, all of which could be devoted to one or multiple users. Hence the network architecture of the disclosed invention is characterized by bandwidth on demand (BOD).

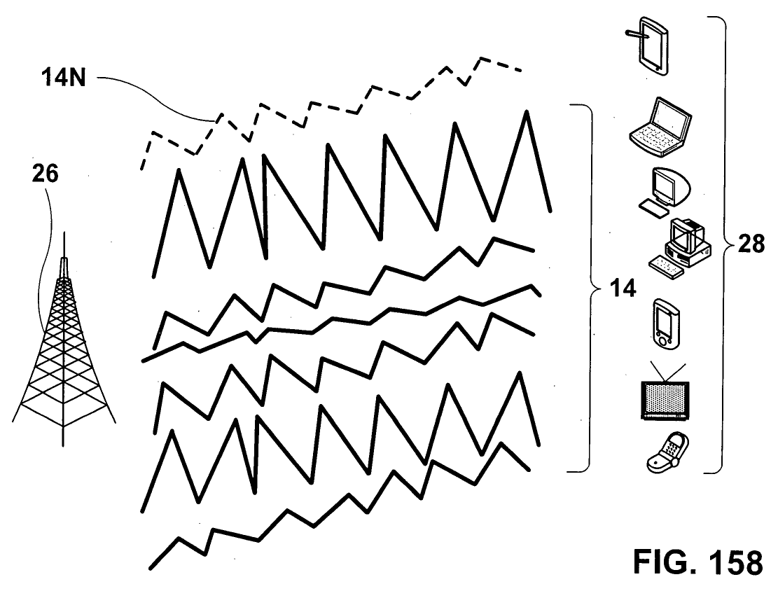

The adjustability of the linear frequency chirp waveform trains 14, meaning that the frequency deviation 16 can be adjusted on demand which affects the data rate, also means that when all of the available bandwidth is in use the next user can still be accommodated. The network architecture of the disclosed invention takes a little data rate from each existing linear frequency chirp waveform train 14, combines it and makes it available to the next user. For example, if there are six chirp trains 14 in use, one providing 1.4 megabits per second, a second providing 256 kilobits per second, a third 64 kilobits per second, a fourth providing 512 kilobits per second, a fifth providing 1 megabit per second, and a sixth providing 768 kilobits per second, taking only ten percent (10%) of the larger ones, 512 kilobits per second and over, and only two percent (2%) of the smaller ones would give the next user almost 400 kilobits per second of data rate to begin his or her communications. See FIG. 158. Some data rate is taken from each of the six active chirp trains 14 and devoted to a chirp train for the next user 14N. For most broadband applications the small decrease in data rate would probably not be apparent to the user. Therefore, the network architecture of the disclosed invention is characterized by virtually no denial of service to a user.

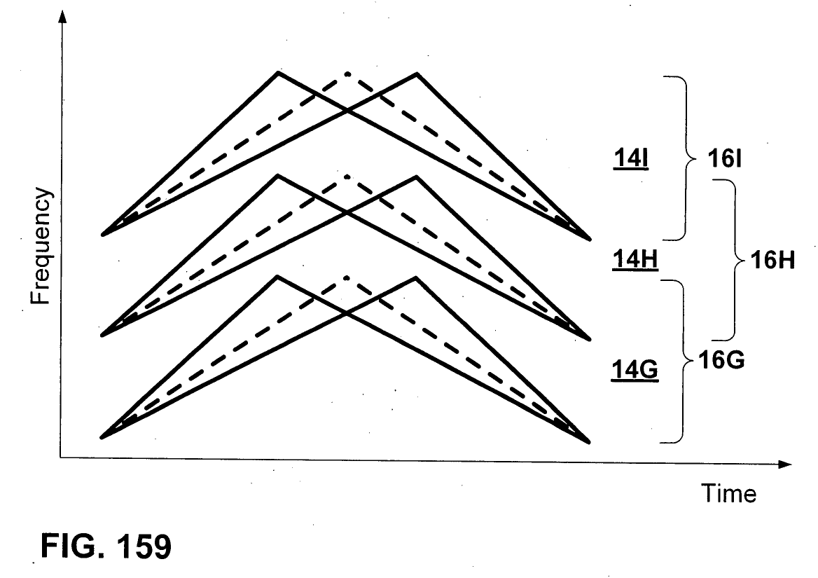

The network architecture of the disclosed invention is also characterized by a form of multiplexing of chirp trains 14. FIG. 159 shows linear frequency chirp waveform frquency multiplexing in which the frequency deviations 16G, 16H and 16I of chirp trains 14G, 14H and 14I partially overlap in frequency space. In the instant context “chirp frequency multiplexing” means that the frequency deviation 16 of chirp trains 14 may partially overlap and still be decoded for reliable communications. The net effect of the ability of the chirp trains 14 to overlap is that more chirp trains 14 may be accommodated within a particular frequency band AE. That also means that more users can be accommodated within a particular frequency band AE.

Experimental results have shown an approximate twenty percent (20%) overlap of frequency deviations 16 may still be decoded using presently available technology.

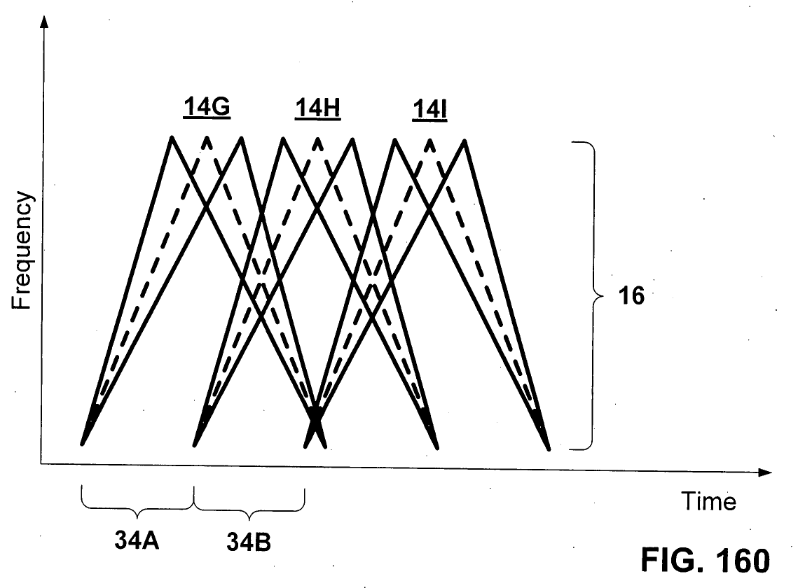

FIG. 160 shows linear frequency chirp waveform phase multiplexing, that is, each chirp train 14 is offset in phase from the preceding one. Chirp train 14H is offset in phase from chirp train 14G by the phase angle 34A. Likewise, chirp train 14I is offset in phase from chirp train 14H by phase angle 34B.

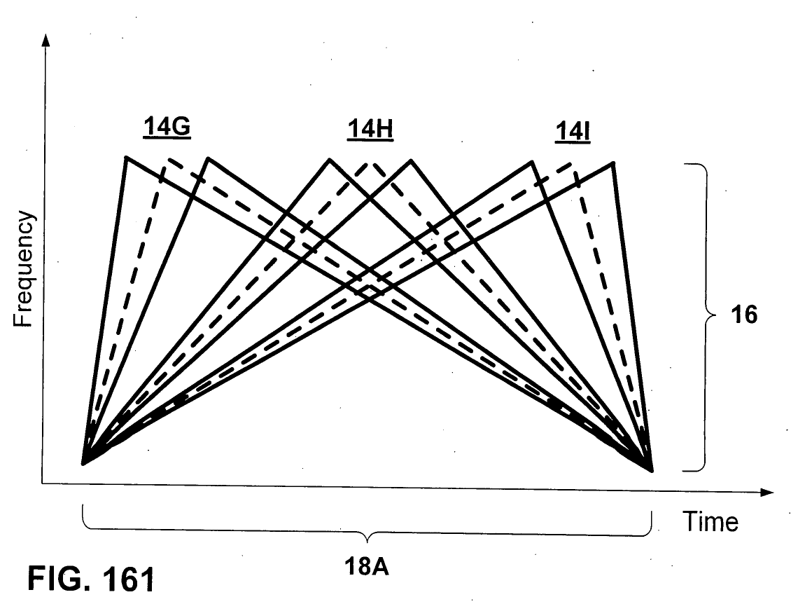

FIG. 161 shows linear frequency chirp waveform slope multiplexing. Each chirp train 14 uses a unique set of slopes to define the chirp train 14. Chirp train 14G has a different set of slopes making up its symbols 24 than do either chirp train 14H or 14I.

Linear frequency chirp waveform frequency multiplexing has been demonstrated using today's electronics technology.

The frequency bands AE in which traditional wireless communications systems operate are sufficiently small that the transmission propagation characteristics do not vary significantly across the band, and these propagation characteristics are well understood band-to-band. Transmission continuity and integrity is affected by all of the traditional parameters, including but not limited to for example, laws and regulations, transmitter power, antenna gain, noise, multipath, receiver sensitivity and selectivity, and the like.

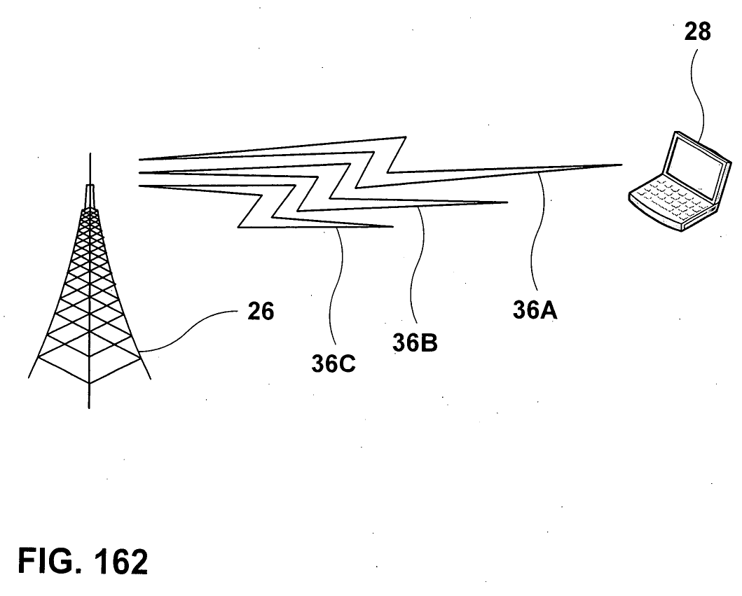

A network operating in multiple frequency bands AE with varying propagation characteristics, however, is particularly advantageous in addressing the “lack of coverage” and “dropped call” problems, quality of service (QoS) issues. The network architecture of the disclosed invention is characterized by the simultaneous utilization of multiple frequency bands AE with different propagation characteristics. FIG. 162 shows a base station 26 simultaneously transmitting chirp trains 14 on three RF frequencies 36A, 36B, 36C. If the user terminal 28 is capable of receiving all three RF frequencies 36A, 36B, 36C, then information can be transmitted to the user with a high degree of reliability because the user terminal 28 can utilize “the best” or an “aggregate of” the three frequencies 36A, 36B, 36C, depending upon the particular technique implemented. The same is true in reverse from the user terminal 28 to the base station 26. Frequency band 36A is the lowest frequency band, 36B an intermediate frequency band, and 36C the highest frequency band.

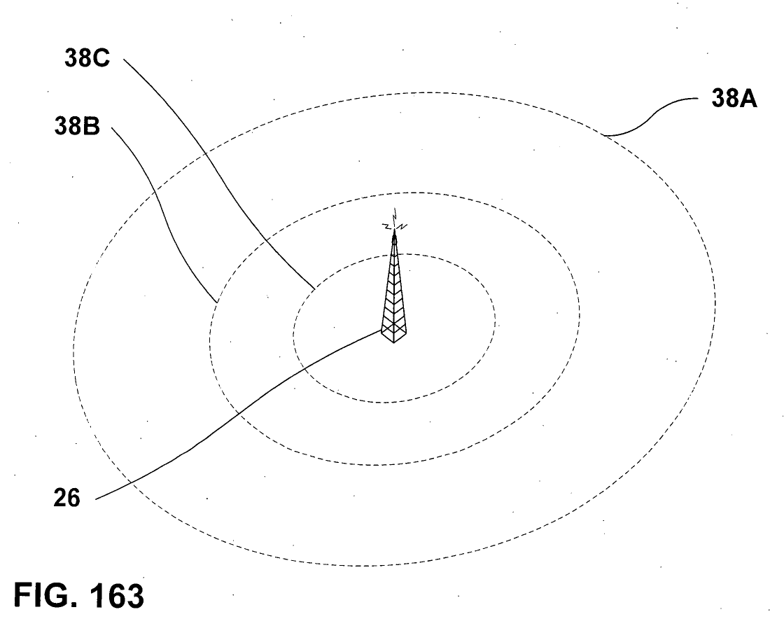

To give a specific example, three selected frequency bands AE have been selected: the ISM and U-NII bands: 902 to 928 MHz 36A, 2400 to 2483.5 MHz 36B, and 5725 to 5825 MHz 36C as shown in FIG. 30. Table 1 shows the free space line-of-sight (LOS) link budget for a 256 kbps data transmission in each of the selected bands 36. The LOS calculations assume a 1 watt transmitter power, a transmitter antenna gain of 6 dBi and a receiver antenna gain of 0 dBi in each of the selected bands 36. The link margin in each selected frequency band 36 is approximately 3 dB. Table 1 shows that the signal can be expected to propagate about one hundred miles (100 mi) at 900 MHz 36A, thirty-seven miles (37 mi) at 2.4 GHz 36B, and sixteen miles (16 mi) at 5.7 GHz 36C. The signal propagation characteristics at 900 MHz are significantly different than those at 2.4 GHz and even more different than those at 5.7 GHz. “Stacking” or “tiering” these three RF frequencies on a base station 26 and in a user terminal 28 provides three overlapping coverage areas 38A,38B,38C corresponding with the set of three RF frequencies 36A, 36B, 36C with independent propagation characteristics as shown in FIG. 163.

TABLE 1
FREE SPACE LINE-OF-SIGHT LINK BUDGET
FOR SELECTED ISM AND U-NII BANDS

| | | 900 MHz | 2.4 GHz | 5.7 GHz |
|---|---|---|---|---|
| Transmit Frequency | GHz | 0.90 | 2.40 | 5.72 |
| Transmitter Power | Watts | 1 | 1 | 1 |
| Transmitter Power | dBm | 30.0 | 30.0 | 30.0 |
| Transmitter Antenna Gain | dBi | 6.00 | 6.00 | 6.00 |
| Effective Radiated Power | dBm | 36.0 | 36.0 | 36.0 |
| Noise Temperature Total | K | 800.00 | 800.00 | 800.00 |
| for Receiver | | | | |
| Total Receiver Antenna | dBi | 0.00 | 0.00 | 0.00 |
| Gain | | | | |
| Path Length/Slant Range | mi | 100.00 | 37.00 | 16.00 |
| Basic Transmission Loss | dB | 135.72 | 135.60 | 135.86 |
| Other Losses | dB | 1.00 | 1.00 | 1.00 |
| Median Received Signal | dBm | −100.72 | −100.60 | −100.86 |
| Level | | | | |
| Boltzman's Constant | dBW | 1.38E−23 | 1.38E−23 | 1.38E−23 |
| Thermal Noise per Hz of | dBm | −169.57 | −169.57 | −169.57 |
| Bandwidth | | | | |
| Data Rate | Mbps | 0.256 | 0.256 | 0.256 |
| Data Rate in dB | dB | 54.08 | 54.08 | 54.08 |
| Receiver Noise Threshold | dBm | −115.49 | −115.49 | −115.49 |
| C/N in IF Bandwidth | dB | 14.77 | 14.89 | 14.62 |
| Implementation Loss | dB | 0.00 | 0.00 | 0.00 |
| E_{b}/Nₒ | dB | 14.77 | 14.89 | 14.62 |
| Bit Error Rate | | 1E−05 | 1E−05 | 1E−05 |
| Minimum E_{b}/Nₒ Required | dB | 11.71 | 11.71 | 11.71 |
| Link Margin | dB | 3.06 | 3.18 | 2.91 |

The simultaneous or aggregated use of tiered frequencies in a wireless communications network has numerous implications for coverage, potential number of users accommodated, system implementation cost, and quality of service.

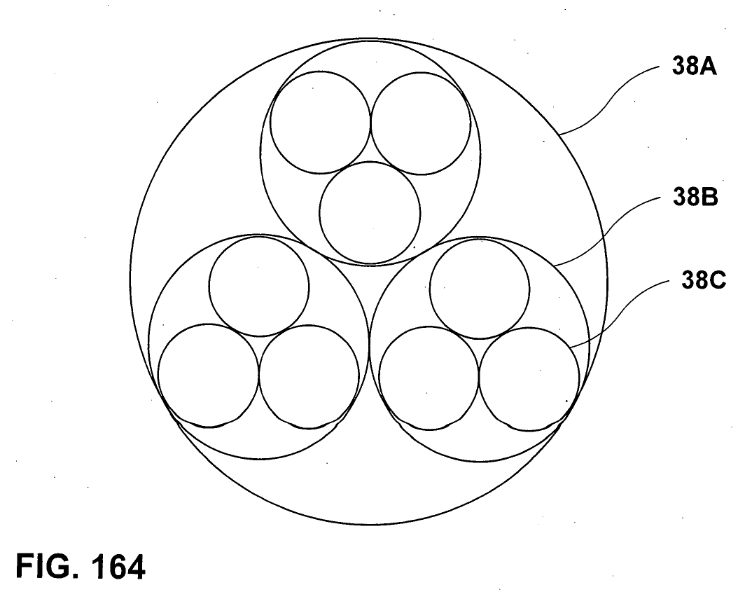

FIG. 164 shows the coverage relationship between three overlapping coverage areas 38A,38B,38C corresponding with the set of three RF frequencies 36A, 36B, 36C. A single 38B coverage area encompasses three 38C coverage areas. Similarly, a single 38A coverage area encompasses three 38B coverage areas. This “tiered” relationship offers unique advantages to ensuring reliable communications.

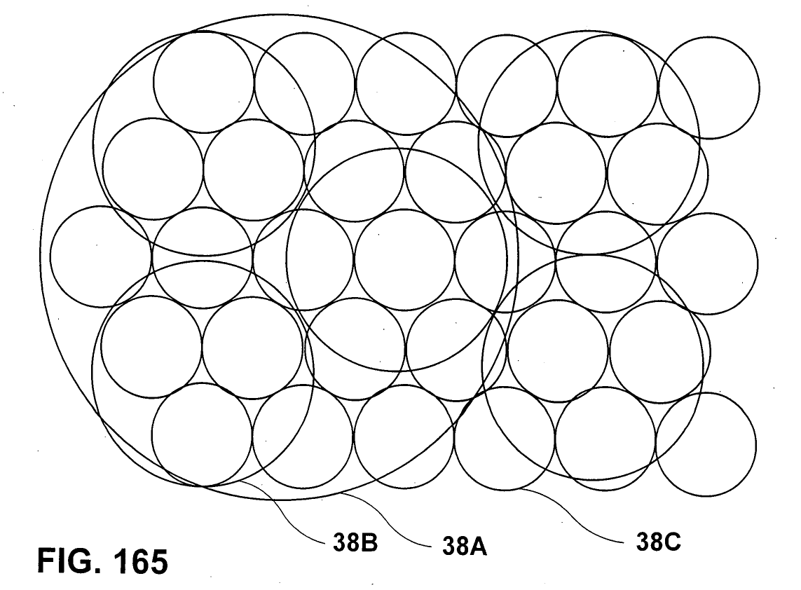

FIG. 165 shows an embodiment of how the three coverage areas 38A,38B,38C may be deployed to provide three frequency coverage over an area.

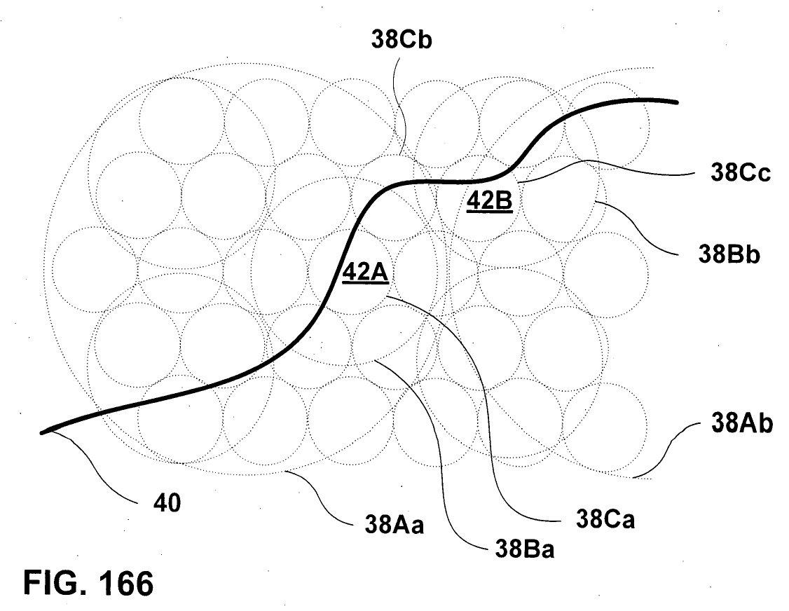

FIG. 166 shows a road 40 passing through the coverage area shown in FIG. 165. A user at point 42A is simultaneously within coverage areas 38Aa, 38Ba and 38Ca. As the user moves from point 42A to point 42B, it passes out of coverage area 38Ca and into coverage area 38Cb. Coverage area 38Cb lies partially within coverage area 38Ba and partially within coverage area 38Bb. Traveling further, the user traverses from coverage area 38Cb to coverage area 38Cc. Coverage area 38Cc lies within coverage area 38Bb and coverage area 38Ab.

One of the attributes of a preferred embodiment of the disclosed invention is that the likelihood of a dropped call or interrupted communications session is virtually zero. One embodiment of accomplishing this relates to the structure of tiering frequencies 36 and coverage areas 38.

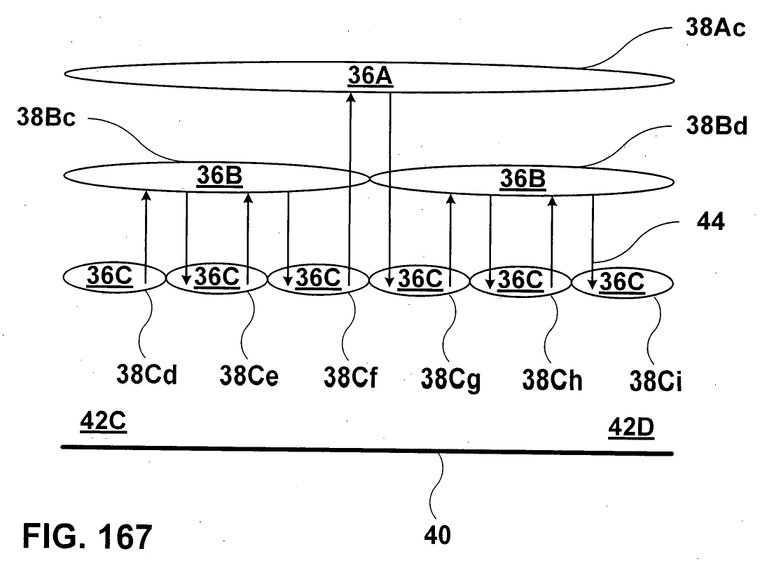

Examine FIG. 167. As a user goes from location 42C to location 42D along road 40, he, she or it traverses a number of coverage areas 38. In the embodiment shown in FIG. 167, at location 42C the user communicates within the coverage area 38Cd. As the user moves towards location 42D, their communications are transitioned from coverage area 38Cd to 38Ce by first shifting frequencies 44 from 36C in coverage area 38Cd to 36B in coverage area 38Bc and then by shifting frequencies 44 from 36B in coverage area 38Bc to 36C in coverage area 38Ce. In a normal cellular or PCS environment there would be a cell-to-cell handoff from coverage area 38Cd to 38Ce, which is often the cause of a dropped call. Handoff in a cellular or PCS system is triggered by signal fade at the edge of coverage 38. In this embodiment the signal fade at the edge of coverage area 38Cd triggers a frequency shift 44 to frequencies 36B in coverage area 38Bc where there is assured coverage. Similarly, the frequency shift 44 to coverage area 38Ce from coverage area 38Bc takes place out of the signal fade region and thereby assures connectivity.

The same process takes places when the user moves from coverage area 38Ce to coverage area 38Cf. The transition from coverage area 38Cf to coverage area 38Cg takes place at the same place there is a transition from coverage are 38Bc to coverage area 38Bd. There is a likelihood of dropped call if the frequencies are shifted 44 from 36C to 36B. In this case, therefore, the transition from coverage area 38Cf to coverage area 38Cg takes place by changing frequencies from 36C in coverage area 38Cf to frequencies 36A in coverage area 38Ac, bypassing the coverage transition from coverage area 38Bc to coverage area 38Bd. The frequency shift 44 from coverage area 38Ac to coverage area 38Cg takes place out of the signal fade region for coverage area 38Cg, thereby assuring connectivity.

The transitions from coverage area 38Cg to coverage area 38Ch and to coverage area 38Ci take place as described above. The process described assures connectivity of communications as a user moves from location 42C to location 42D.

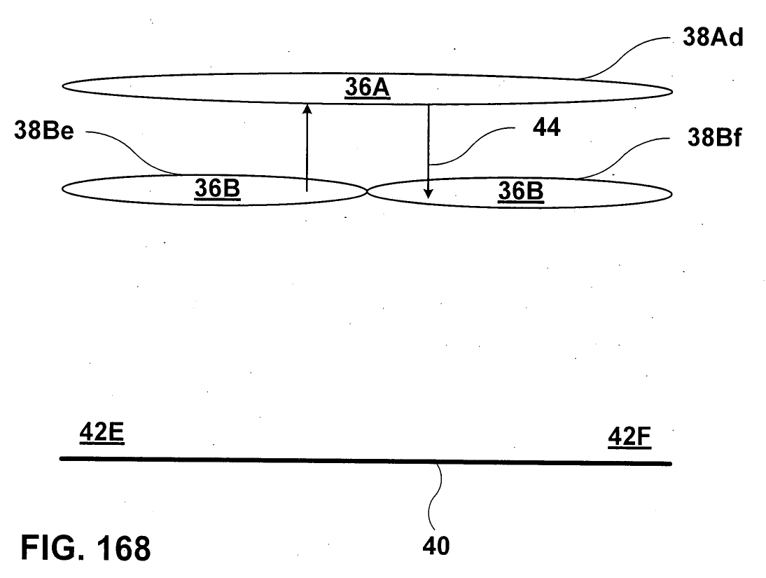

FIG. 168 shows an embodiment where there is no coverage 38C on frequencies 36C. As a user moves from location 42E to location 42F, communications first take place within coverage area 38Be. At the edge of coverage of coverage area 38Be, communications shift frequency 44 from coverage area 38Be to coverage area 38Ad and then shift 44 from coverage area 38Ad to 38Bf to assure connectivity.

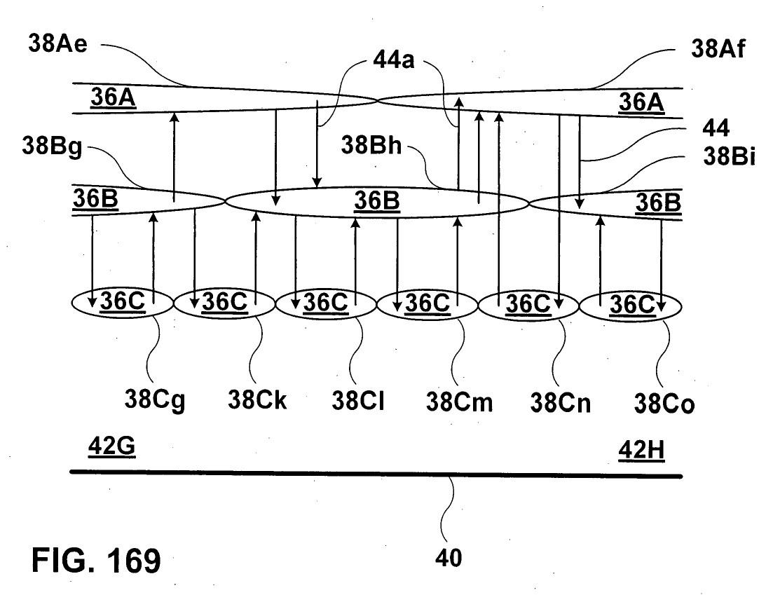

FIG. 169 shows an amalgam of FIGS. 167 and 168. In the embodiment shown in FIG. 169 persons and vehicles are simultaneously communicating in all three coverage areas 38A, 38B and 38C, and transitioning from coverage area 38 to coverage area 38 by shifting frequencies 44 both “up” and “down” at the edges of the coverage areas. Note the frequency shift pair 44a. Here communications are being transitioned from coverage area 38Ae to coverage area 38Af by shifting frequencies 44 down to coverage area 38Bh and then back up.

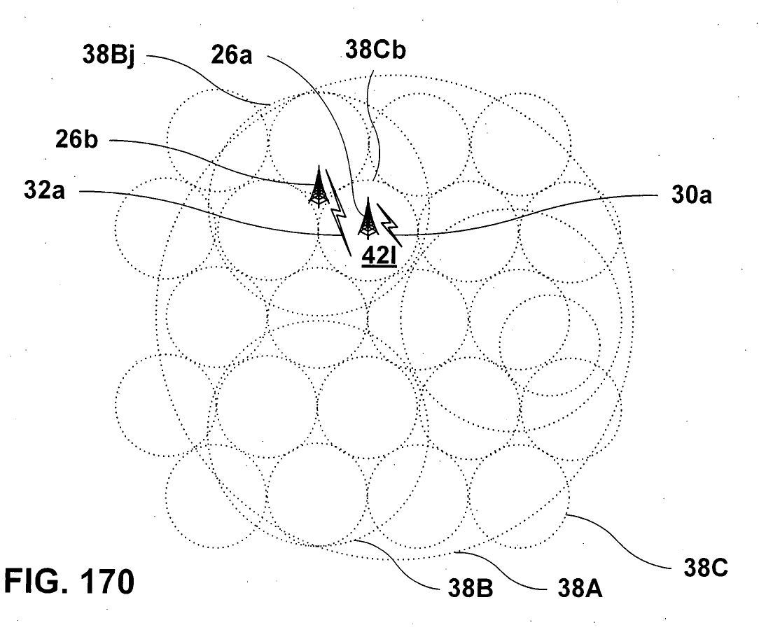

FIG. 156 shows duplex communications between a base station 26 and a user terminal 28. One chirp train 30 goes from the base station 26 to the user terminal 28, the forward link, while another chirp train 32 goes from the user terminal 28 to the base station 26, the reverse link. In an embodiment of the invention these two chirp trains 14 are operate in different frequencies 36. In FIG. 170 a user at location 42I receives their communications 30a from base station 26a in coverage area 38Cb on frequency 36C. The user transmits their communications 32a to base station 26b in coverage area 38Bj on frequency 36B. This is another technique to ensure continuous reliable communications.

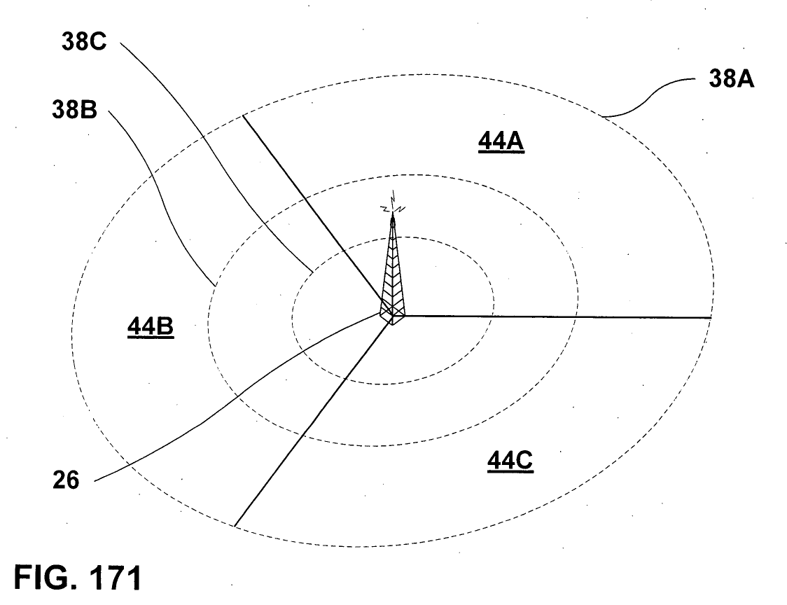

The use of sectorized antennas on a base station 26 can significantly increase the potential number of users that may be accommodated because the frequencies may be reused within each sector. FIG. 171 is basically FIG. 163 but showing antenna sectors 46A, 46B and 46C. Sectorized antennas may be utilized in any give frequency band AE or in all frequency bands simultaneously.

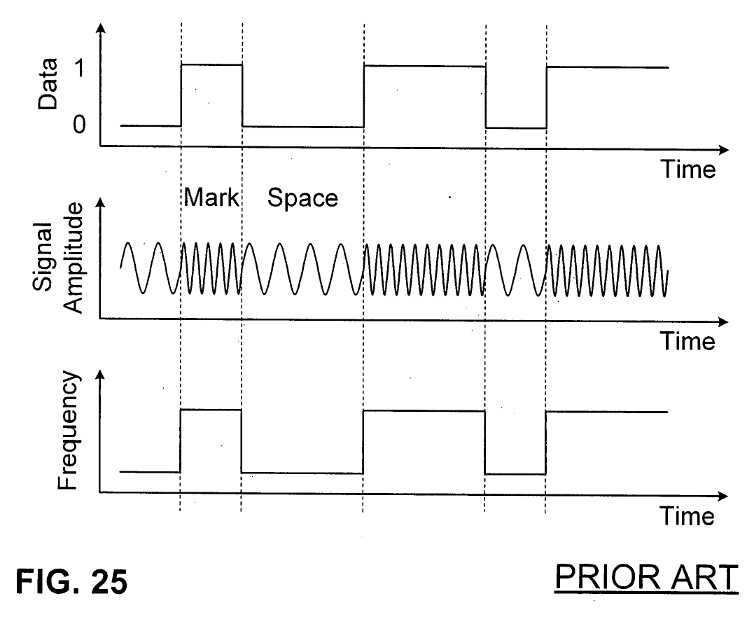

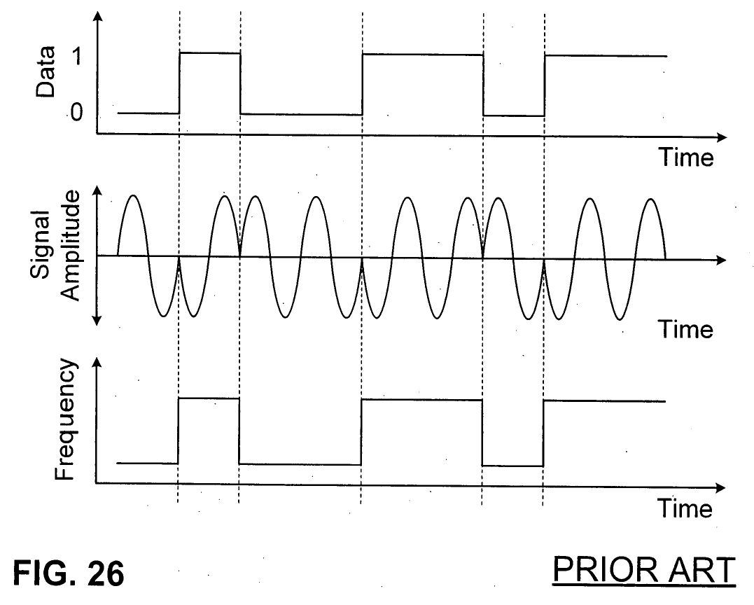

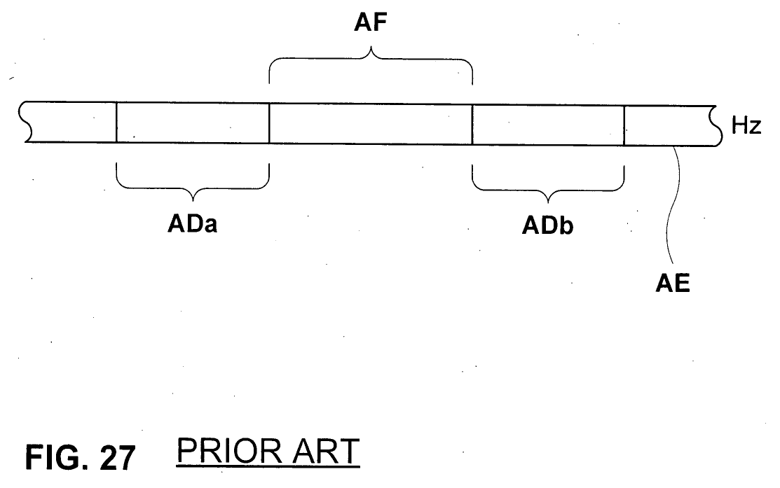

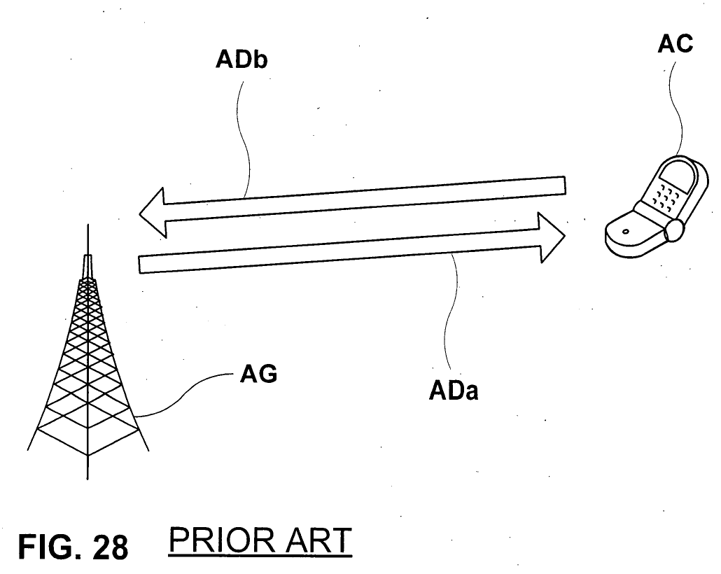

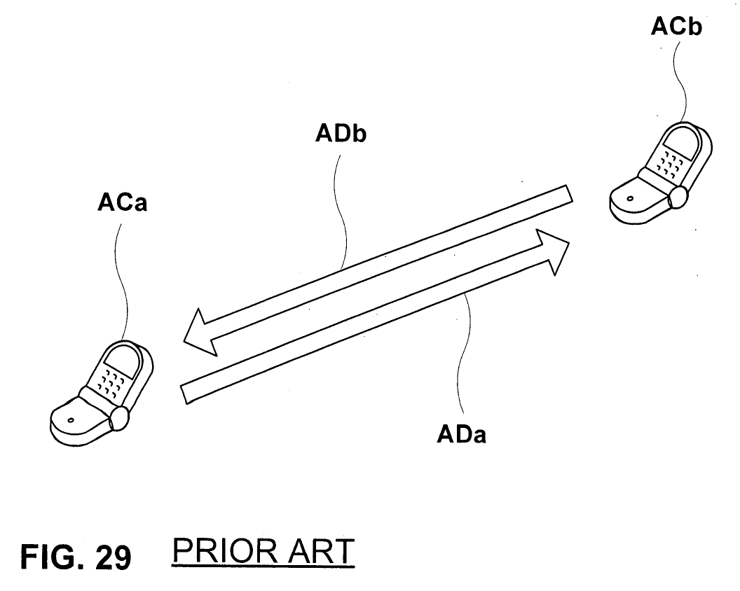

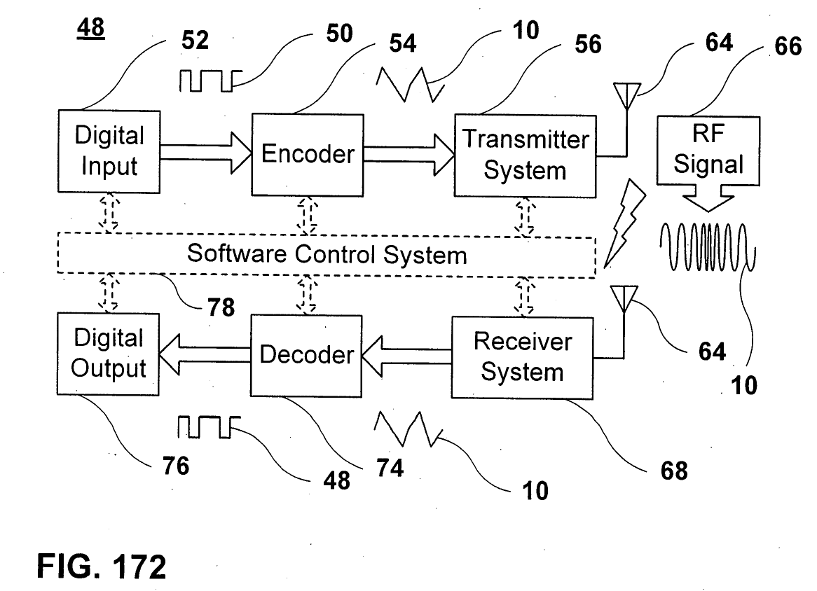

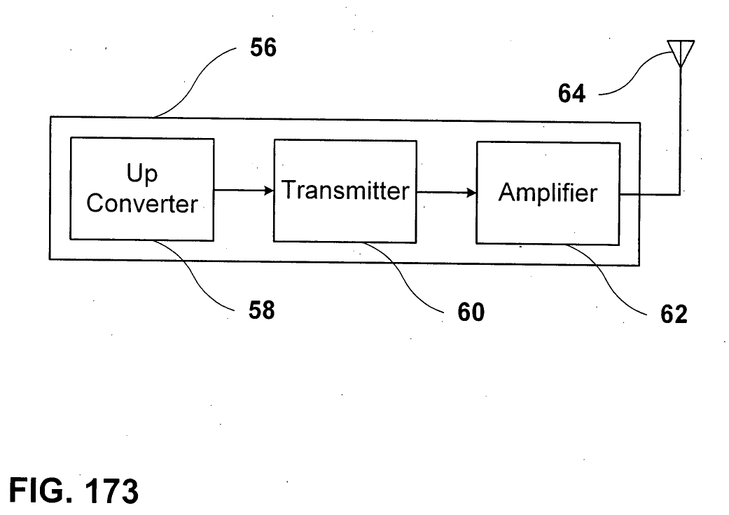

FIG. 172 shows a block diagram of a preferred embodiment of the hardware system 48 of the disclosed invention. Digital data, see FIG. 25, is the waveform 50 input 52 to the linear frequency chirp waveform encoder 54. The encoder 54 encodes the digital input 50 into the linear frequency chirp waveform 10, which is fed to the transmitter system 56. The transmitter system 56 is shown in FIG. 173. The baseband signal from the encoder is up-converted 58 to the frequency band AE in which the signal is to be transmitted, fed to the transmitter 60, boosted in power 62, and fed to the antenna system 64. The radio frequency signal 66 comprising the linear frequency chirp waveform 10 is transmitted through the ether.

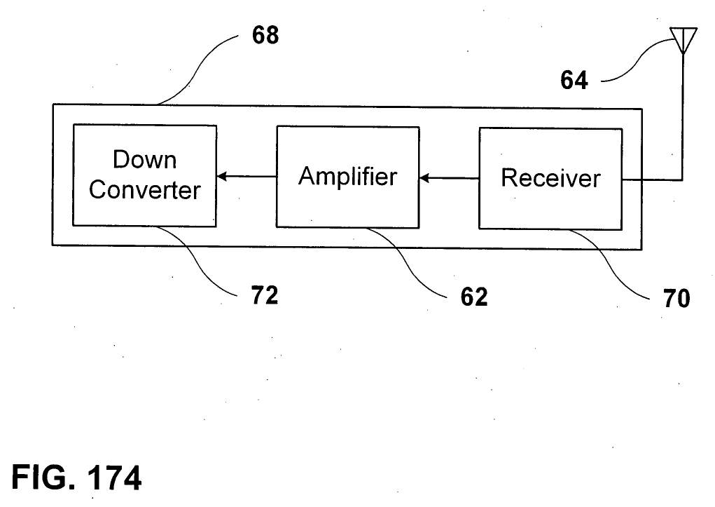

The radio frequency signal 66 is received by an antenna system 64 and fed to the receiver system 68, which is shown in FIG. 174. The receiver 70 sends the received signal 66 to an amplifier 62. The amplifier 62 sends the signal to a down converter 72 that converts the signal to baseband linear frequency chirp waveform 10. The baseband linear frequency chirp waveform 10 is fed to the decoder 74, which recovers the digital waveform 50 for the digital output 76.

All of the functions of the hardware system 48 are controlled by an embedded software system 78.

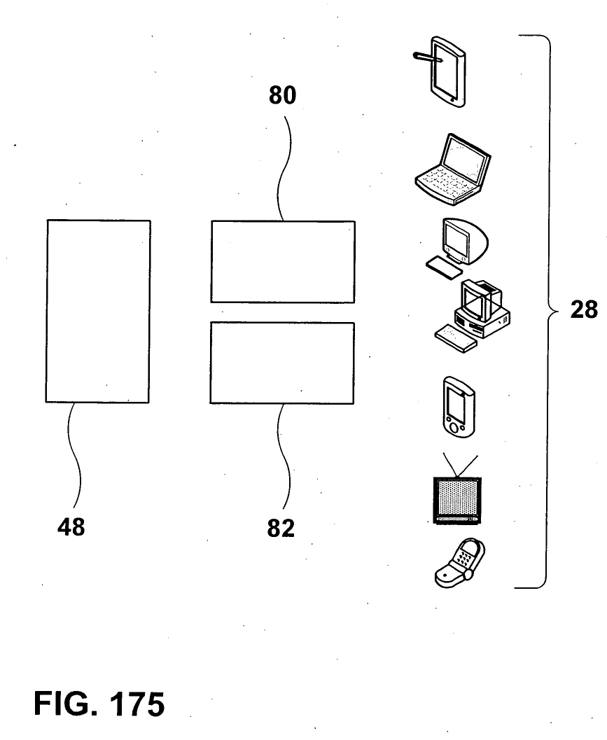

A preferred embodiment of the disclosed invention uses Ethernet as the hardware interface 80 and Transmission Control Protocol/Internet Protocol (TCP/IP) as the software interface 82 to user terminals 28, as shown in FIG. 175.

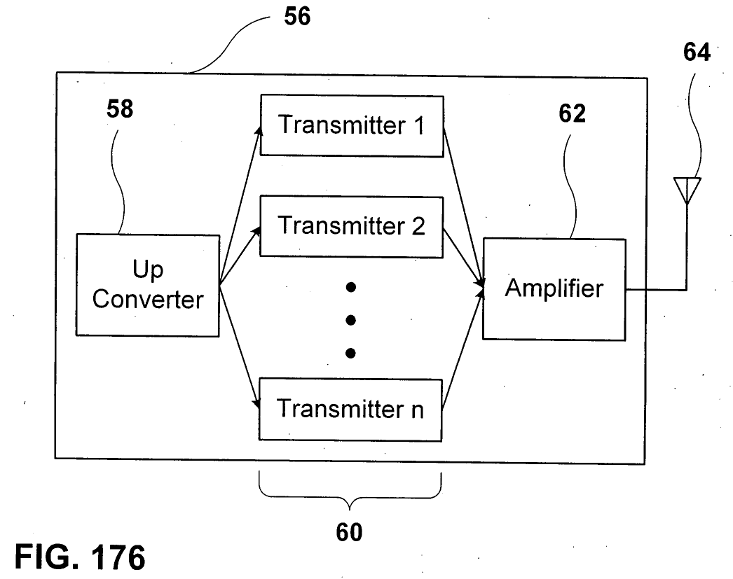

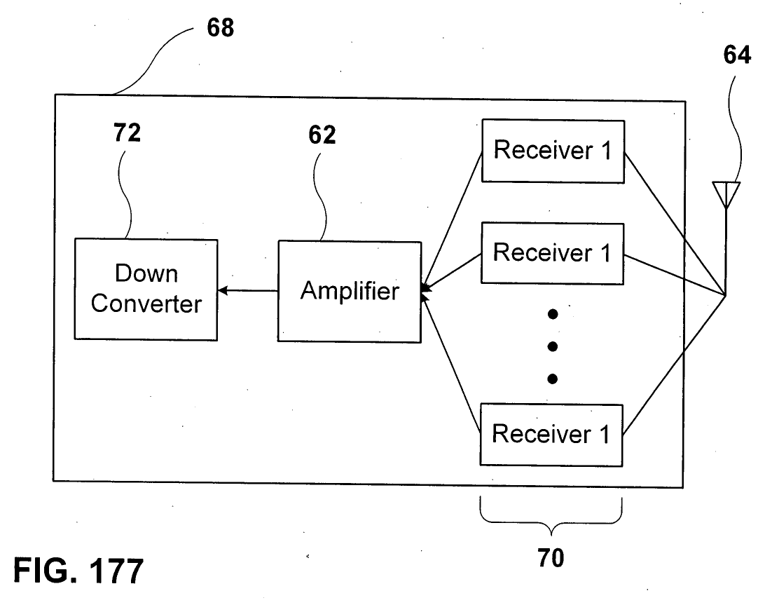

As has been described above, a preferred embodiment of the disclosed invention simultaneously utilizes multiple frequencies 36 to assure continuity of communications. Implementing this embodiment requires that the system 48 include multiple transmitters systems 56 and receiver systems 68, each operating the frequency bands 36 to be utilized. See FIG. 176 for a multi-frequency transmitter system and FIG. 177 for a multi-frequency receiver system. Multiple antennas 64 may be required in some embodiments depending upon the specific frequencies 36 to be implemented.

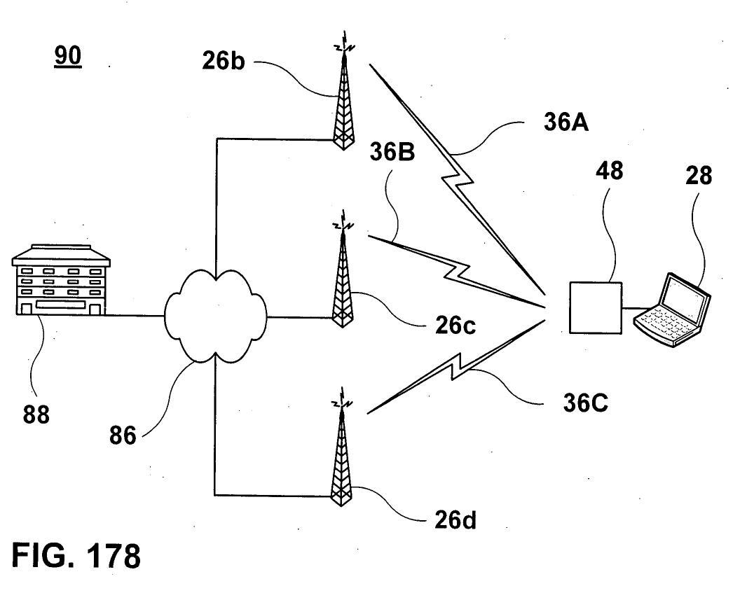

Embedded in the software control system 78 is a network management software layer 84 that handles the frequency shifts 44 described above and shown in FIGS. 167 through 169, as well as the split frequency operations shown in FIG. 170. An additional element of the network management software layer 84 is used to manage access to a multitude of telecommunications networks 86, specifically including the Internet 86-I. The network management software 84 also resides in a network management center 88 that manages the overall network 90. See FIG. 178.

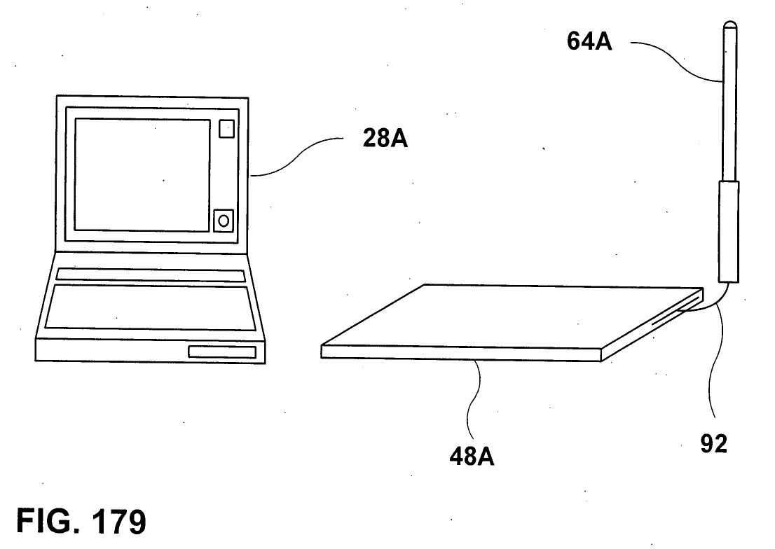

FIGS. 179 through 185 show a number of alternative embodiments of user terminals 28 and systems 48.

FIG. 179 shows a laptop computer 28A with the system 48 embodied in the form of a Personal Computer Memory Card International Association (PCMCIA) Card 48A, also known as a PC Card. The antenna embodiment 64A is attached to the PCMCIA card 48A by a cable 92.

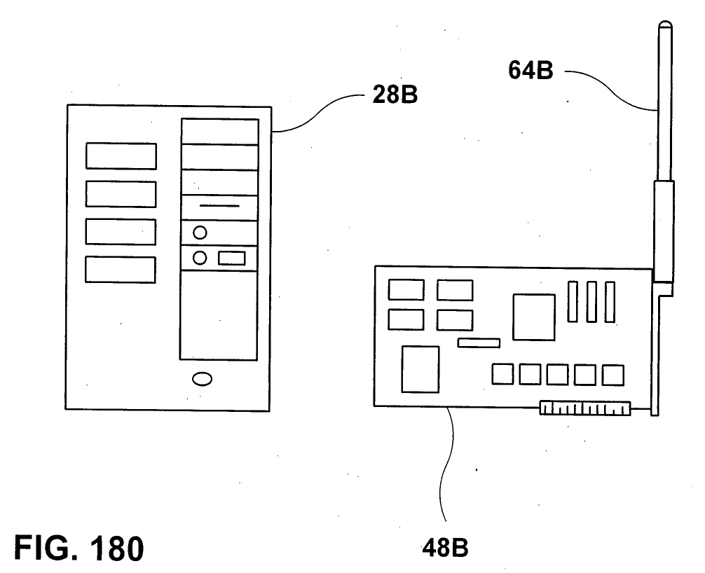

FIG. 180 shows a personal computer (PC) 28B with the system 48 embodied in the form of a Peripheral Component Interconnect Bus (PCI) card 48B. In this embodiment the antenna 64B is affixed directly to the PCI card 48B.

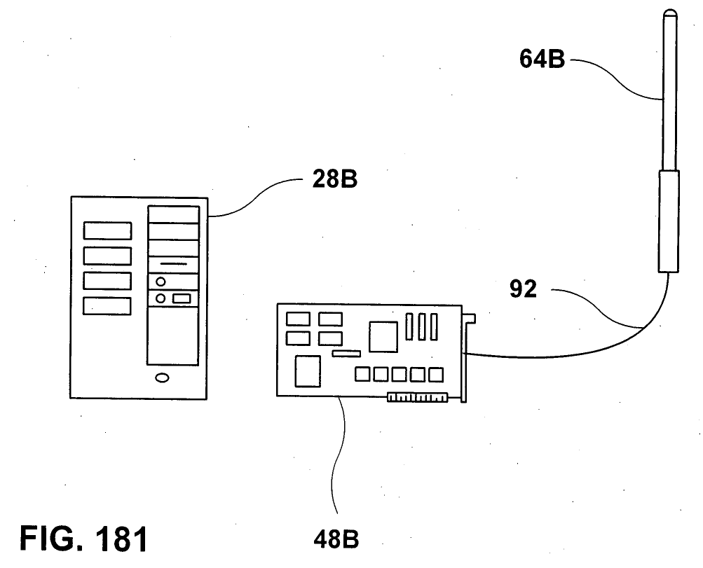

FIG. 181 shows a personal computer (PC) 28B with the system 48 embodied in the form of a Peripheral Component Interconnect Bus (PCI) card 48B. In this embodiment the antenna 64B is remotely deployed and connected to the PCI card 48B by an antenna cable 92.

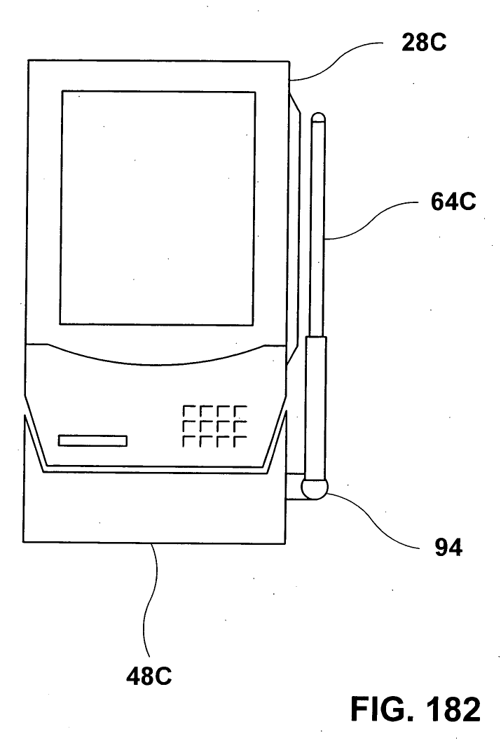

FIG. 182 shows a Personal Digital Assistant (PDA) 28C with the system 48 embodied in the form of a shoe 48C that connects to the bottom of the PDA. In this embodiment the antenna 64C is connected directly to the shoe 48C via a pivot 94.

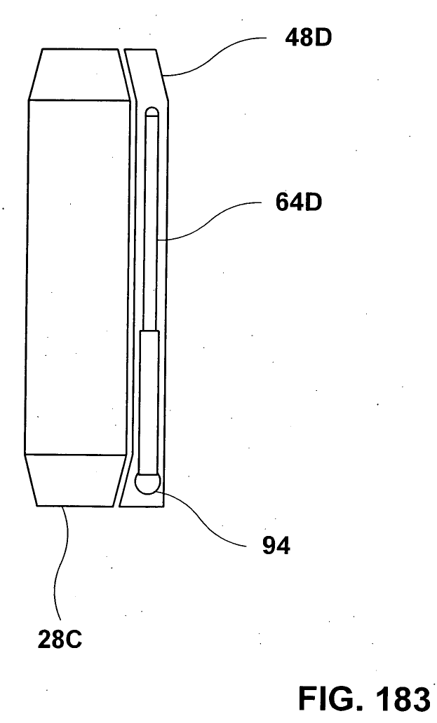

FIG. 183 shows a PDA 28C with the system 48 embodied in the form of a back plate 48C that connects to the back of the PDA. In this embodiment the antenna 64D is connected directly to the back plate 48D via a pivot 94.

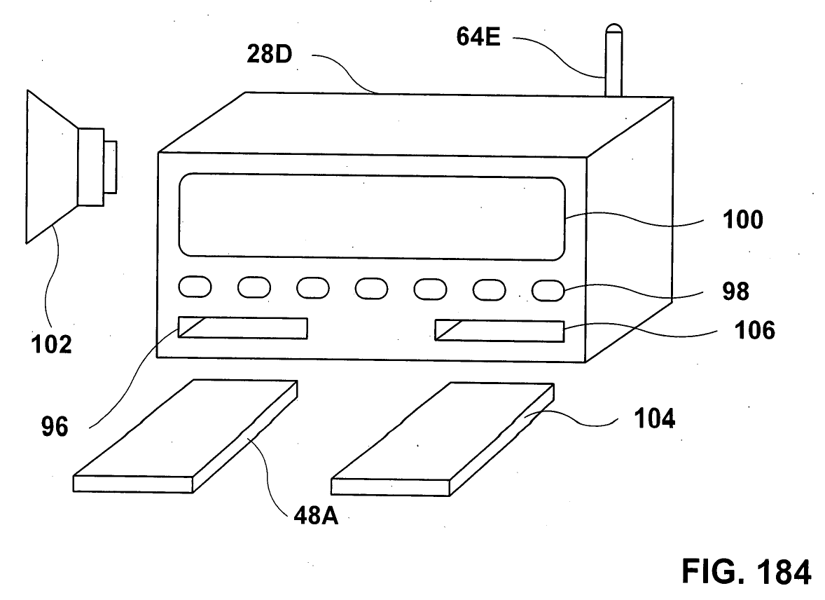

FIG. 184 shows an audio terminal 28D with the system 48 embodied in the form of a PCMCIA card 48A which is inserted into a PCMCIA slot 96. The antenna 64E is affixed directly to the audio terminal 28D. A user can tune a station using the buttons 98 and watching the display 100. A user's listening preferences are recorded in a Subscriber Identity Module (SIM) 104, which is placed into a SIM slot 106. The SIM 104 can take the form of any device and/or software and/or user input that can provide an equivalent means of performing the function of the SIM. The functionality of the SIM 104 may be embodied in a variety of form factors such as commercially available Universal Serial Bus (USB) Jump Drives, various forms of flash memory cards such Secure Digital (SD), CompactFlash (CF), SmartMedia (SM), Sony® Memory Stick (MS), MultiMediaCard (MMC) and xD-Picture Card (xD).

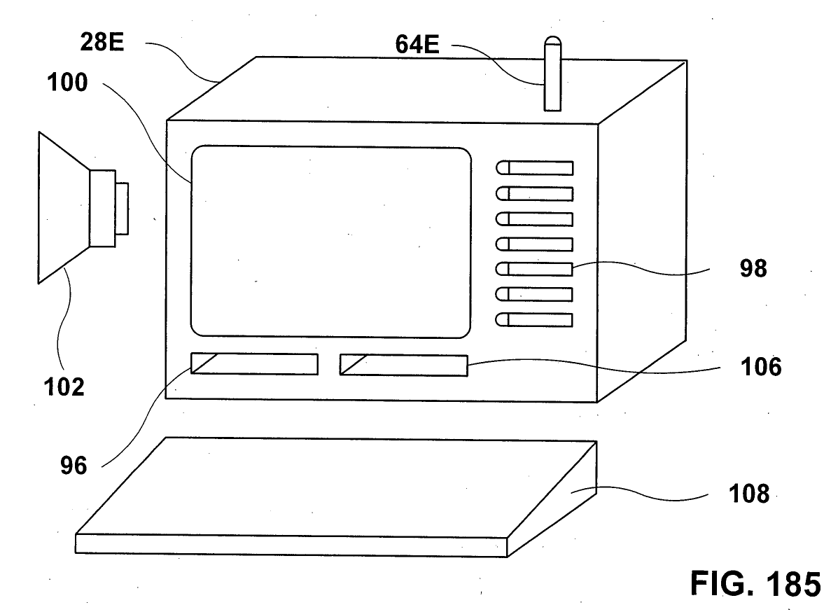

FIG. 185 shows an video terminal 28E with the system 48 embodied in the form of a PCMCIA card 48A which is inserted into a PCMCIA slot 96. The antenna 64E is affixed directly to the video terminal 28E. A user can tune a station using the buttons 98 and watching the display 100. The video terminal 28E also has a keyboard 108.

Another embodiment of the invention comprises a single chip or an Application Specific Integrated Circuit (ASIC) set that embodies the system 48.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives that have been disclosed above are intended to educate the reader about preferred embodiments of the invention, and are not intended to constrain the limits of the invention or the scope of Claims.

### LIST OF REFERENCE CHARACTERS

A Transmit or receive antenna
B Battery
C Carrier wave
D Music tones
DASH Dash in Morse Code
DOT Dot in Morse Code
E Amplifier
F Frequency
G Gap
H Car
I Singer
J Oscilloscope
K Telegraph key
L Demodulator
LO Local Oscillator
M Microphone
N Frequency modulated wave
O Operator
P Power supply
Q Amplitude modulated wave
R Modulator
S Static
T Period
U Modulation wave
UU Modulation envelope
V Quarter
W Wires
X Sound signal source
Y Prism
Z Speaker
AA Phase detector
AB Product detector
AC Terminal
AD Communications channel
AE Frequency band
AF Frequency offset
AG Base station
AH Coverage area
10 Chirp waveform
10A Alternate waveform
10D Down-chirp waveform
10E Redefined chirp waveform with a meaning of a symbol “zero”
10F Redefined chirp waveform with a meaning of a symbol “one”
10M1 Multiple line segment waveform
10M2 Multiple line segment waveform
10S1 Stacked line segment waveform
10S2 Stacked line segment waveform
10U Up-chirp waveform
12 Boundary
12S Start point
12E End point
14 Chirp train
16 Frequency difference, or deviation
18 Chirp waveform duration
18A Redefined chirp waveform duration or symbol duration
20 Chirp interval
22 Field strength
24 Chirp symbol
24A Chirp symbol with the meaning “zero”
24B Chirp symbol with the meaning “one”
24S Synchronization chirp symbol
26 Base station
28 User terminal
30 Chirp train from a base station to a user terminal; forward link; downlink
32 Chirp train from a user terminal to a base station; reverse link; uplink
34 Phase angle
36 Multi-frequency frequency band
38 Base station coverage area
40 Road
42 Location of a user
44 Frequency shift
46 Base station coverage area with sectorized antennas
48 Preferred embodiment of hardware and software system
50 Digital waveform
52 Digital input
54 Encoder
56 Transmitter system
58 Up converter
60 Transmitter
62 Amplifier
64 Antenna system
66 Radio frequency signal
68 Receiver system
70 Receiver
72 Down converter
74 Decoder
76 Digital output
78 Software control system
80 Hardware interface
82 Software interface
84 Network management layer
86 Telecommunications network
88 Network Management Center
90 Preferred embodiment of a network
92 Antenna cable
94 Antenna pivot
96 Personal Computer Memory Card International Association (PCMCIA) slot
98 Station selection buttons
100 Display
102 Speaker
104 Subscriber Identity Module (SIM)
106 Subscriber Identity Module (SIM) slot
108 Keyboard

What is claimed is:

1. An apparatus comprising:
a first transceiver;
a second transceiver;
said first and said second transceiver for transmitting and receiving a chirp waveform.

2. An apparatus as recited in claim 1, in which
baseband signal continuity is ensured by using said chirp waveform.

3. An apparatus as recited in claim 1, in which
using said chirp waveform reduces the spectral spread of energy into sidebands.

4. An apparatus as recited in claim 1, in which
the combination of even spectral spreading of signal energy from using said chirp waveforms and reduced sideband spreading from continuous baseband signaling allows said chirp waveform to achieve higher information density.

5. An apparatus as recited in claim 1, in which
using said chirp waveform provides a frequency distribution which is predetermined.

6. An apparatus as recited in claim 1, in which
using said chirp waveform provides a frequency distribution which is may be precisely controlled.

7. An apparatus as recited in claim 1, in which
using said chirp waveform provides a frequency distribution which is may be precisely controlled and which eliminates the need for an intermediate frequency filter.

8. An apparatus as recited in claim 1, in which
said first and said second transceivers utilize a plurality of chirp waveforms.

9. An apparatus as recited in claim 8, in which
no dead space is required between each of said plurality of chirp waveforms.

10. An apparatus as recited in claim 9, in which
the elimination of dead space between each of said plurality of chirp waveforms eliminates the multipath problem in urban environments.

11. An apparatus as recited in claim 9, in which
the elimination of dead space between each of said plurality of chirp waveforms makes the reception of weaker and noisier signals more reliable.

12. An apparatus as recited in claim 1, in which
said chirp waveform is conveyed in a sub-band.

13. An apparatus as recited in claim 1, in which
using said chirp waveform enables an uniform energy density distribution throughout a band.

14. An apparatus as recited in claim 8, in which
each of said plurality of chirp waveforms starts and stops at zero reference voltage.

15. An apparatus as recited in claim 1, in which
said chirp waveform is continuous in phase.

16. An apparatus as recited in claim 1, in which
said chirp waveform is continuous in frequency.

17. An apparatus as recited in claim 8, in which
said plurality of chirp waveforms are evenly spaced in time.

18. An apparatus as recited in claim 8, in which
said plurality of chirp waveforms are self-synchronizing.
